(19) United States
(12) Patent Application Publication
(10) Pub. No.: US 2013/0304655 A1
(43) Pub. Date: Nov. 14, 2013

(54) SYSTEM AND METHOD FOR ACCESS TO, MANAGEMENT OF, TRACKING OF, AND DISPLAY OF LEASE DATA

(71) Applicants: Frederick J. Johnston, Chicago, IL (US); Raphael Morozov, Sherman Oaks, CA (US)

(72) Inventors: Frederick J. Johnston, Chicago, IL (US); Raphael Morozov, Sherman Oaks, CA (US)

(73) Assignee: CREWIZARD, LLC, Chicago, IL (US)

(21) Appl. No.: 13/689,342

(22) Filed: Nov. 29, 2012

Related U.S. Application Data
(63) Continuation-in-part of application No. 13/470,876, filed on May 14, 2012.

(51) Int. Cl. G06Q 30/06; G06Q 50/16

(52) U.S. Cl. CPC G06Q 30/0645; G06Q 50/16
USPC 705/307

(57) ABSTRACT

A system for using real estate lease data has at least one property file stored on a data storage device and representing a property that has at least one leasable space, and a lease deal component operated by at least one processor and receiving data for a plurality of lease deals each with terms of a lease deal. At least one previously established lease deal has data for a lease deal, and is associated to at least one leasable space. This lease deal was established previously to at least one subsequent lease deal. The lease deal component links at least one subsequent lease deal to the at least one previously established lease deal to associate the at least one subsequent lease deal with an amount of leasable space linked to the previously established lease deal. A display displays lease terms or results of financial calculations or both of at least one linked lease deal.

### CROSS REFERENCE TO RELATED APPLICATION

This application is a continuation-in-part of application Ser. No. 13/470,876, filed May 14, 2012, which is incorporated herein by reference in its entirety and for all purposes.

### BACKGROUND

1. Field of the Invention

The subject matter herein relates to the use of commercial property lease data and, in particular, to a method and system that permits access to, management of, tracking of, and display of lease data used for the analysis and forecasting of financial, occupancy, and/or other values commonly used in real estate.

2. Description of Related Art

Some known commercial real estate analysis programs do not provide the ability to track inventory or tenant space in a building at all, and each potential lease deal may be entered into the program without any way for the program to track what part of previously established suite or suites a new potential tenant may occupy. For example, the program may permit a user to select a building and a section of the building (such as a floor) and enter a potential deal to occupy a portion of the section of the building, but no data is tracked to identify how the potential lease relates to previously executed leases within the building. Thus, if the section is 10,000 sf, and currently encumbered by several leases, and the potential tenant space is 5,000 sf, no way exists to identify how the 5,000 sf relates to the other leases that have encumbered the section. Therefore, the program user cannot track the metrics of a current or potential lease versus a prior lease for example.

Other conventional lease analysis and workflow computer programs that do provide suite tracking ability are primarily focused on customer relationship management (CRM), and most have been built on top of well known CRM software platforms such as Salesforce.com or Microsoft Dynamics CRM. For example, known programs can be used to track or monitor available inventory in a building (or buildings), such as currently vacant suites, suites that have leases expected to expire within a defined time period, or all suites in a building. Basic data about these suites, such as square footage, and the expiration date of the current lease, is stored, and the computer programs allow users to identify and track potential occupiers (tenants) of the space once the current leases expire. Keeping with the CRM software roots, the data that is entered and stored is primarily concerned with contact information for potential tenants, the status of the negotiations, and some basic information about the negotiations such as the rent currently under negotiation, the cost of improvements the landlord is willing to provide to improve the potential tenant's space (tenant improvements), leasing commissions to be paid to brokers for facilitating the lease transaction, and other common financial data associated with commercial real estate lease transactions. These systems, however, lack the ability to track and analyze data for advanced lease data analytics.

For instance, some of the known programs that track the inventory of suites within a building treat the inventory of suites much like any other inventory for any other type of business. For example a car dealer has an inventory of vehicles, and each vehicle may be tracked through software as individual units that cannot be divided or combined. However, for a commercial property such as an office, retail, or industrial property, inventory is not fixed on a unit-for-unit basis. Space can be sub-divided or combined over time, so that, unlike a car, or other typical units of inventory, units can be combined or split in an infinite number of ways. This creates problems for known programs which can only track inventory on a unit-for-unit basis. With these conventional programs, the spaces of a building cannot be easily combined or subdivided.

Specifically, while current programs may allow a user to identify a specific suite and then track leasing activity for that suite, this can be problematic when suites are reconfigured over time. For example, a floor of a building may have ten suites today, but can be easily reconfigured to accommodate a single floor user in the future. The current programs might (1) show the current ten suites and allow a user to separately enter data for each of them (i.e. rather than enter data once for the prospective tenant, so that a user must enter the same data ten times), or (2) let the user create a single new prospective lease. In either case, however, no way exists to maintain tracking of the consolidation of the space. Therefore, no ability exists to compare prior lease data to prospective lease data when the space changes.

Some known programs also have an ability to associate budgeted expectations with a specific single space (a budgeted suite). For example, if a tenant's lease is expiring within the next year, a user can enter an expectation as to whether the tenant will renew or vacate, as well as expected terms for the next lease such as rent, the length of the lease, tenant improvements, and leasing commissions. Since existing suites cannot be readily split or combined as mentioned above, often times it is not possible to split or combine the suites to match a space designed for a budgeted suite. Thus, budgeted suites cannot be readily combined or split into actual deals, and accurate financial analysis cannot be obtained on the program. Further, the budgeting systems are structured to only track a single budget at a time, so that whenever a new budget is created, new data is loaded into the software, and old data from prior budgets is no longer active or accessible.

Thus, it would be desirable to have a system that provides for comparisons between leases that are currently in-place and prospective leases, and comparisons between leases (both those in-place and prospective) against multiple budgets and forecasts and while considering changes in suite or floor space.

Some current software includes inputs for detailed lease financial data through an interface that mimics a spreadsheet. In this style of interface, lease data can be input in designated cells. For example, referring to FIG. 1, a known software detailed lease financial data input interface 100 includes data for each suite such as a cell 102 for rent, a cell for rent steps (periodic increases in rent) 104, a cell for tenant improvements 106, a cell for leasing commissions 108, and other basic data. However, for complex leases that require additional data for the rent or other lease components, some current software such as that providing interface 100 designates the cell as a “detailed” cell 110 and launches a separate interface or dropdown area 112 to enter detailed information. The area 112 for entering detailed information consists of date inputs 114 and value inputs 116 that, when combined, can provide additional detail necessary for some leases. Other cells such as the rent step 104, tenant improvement 106, and leasing commission 108 cells also allow the input of detailed entry. The current software, however, hides key data from the interface necessary for detailed financial analysis such as the detailed entries of rent illustrated in input area 112. Thus, it would be desirable to have a lease data system that provides for financial analysis and comparison of leases that permits a user to view all or most financial analysis factors that constitute the financial inputs and outputs of a commercial real estate lease.

### SUMMARY OF THE INVENTION

The deficiencies mentioned above are solved by the present system for access to, management of, tracking of, and display of lease data.

Specifically, a system for using real estate lease data comprises at least one property file stored on a data storage device and representing a property with at least one leasable space, and a lease deal component operated by at least one processor and receiving data for a plurality of lease deals, where each lease deal has data for terms of a lease deal. At least one previously established lease deal has data for a lease deal, and is associated with at least one area of the at least one leasable space by the lease deal component. This previously established lease deal is established previously to at least one subsequent lease deal of the plurality of lease deals.

The lease deal component is configured to link at least one subsequent lease deal of the plurality of lease deals to at least one of the previously established lease deals to associate the at least one subsequent lease deal with the leasable space associated to the previously established lease deal. A display may then show lease terms or results of financial calculations or both of at least one lease deal that is linked.

In another aspect, a method of using lease data comprises storing on a data storage device, at least one property file representing a property with at least one leasable space, and receiving data for a plurality of lease deals, where each lease deal has data for terms of a lease deal. This method also includes receiving data for at least one previously established lease deal comprising data for a lease deal. The previously established lease deal is established previously to at least one subsequent lease deal of the plurality of lease deals and being associated with the at least one leasable space. The method also includes linking, by at least one lease deal component operated by at least one processor, the at least one previously established lease deal to at least one subsequent lease deal to associate the at least one subsequent lease deal with the leasable space; and then displaying lease terms or results of financial calculations or both of at least one linked lease deal.

By a further approach, a system using real estate lease data comprises a property file stored on a data storage device and defining at least one leasable space, and at least one lease deal with data of an executed or in-progress lease deal in negotiations. At least one reference lease is provided to have data of a hypothetical lease deal. The system also has at least one component operated by at least one processor and linking the at least one reference lease to at least one lease deal, and a display for simultaneously displaying data of at least one reference lease and at least one lease deal linked to the at least one reference lease.

In similar fashion, a method using lease data comprises storing a property file on a data storage device, where the property file represents at least one leasable space, and providing at least one lease deal comprising data of an executed or in-progress lease deal in negotiations. This method also provides at least one reference lease with data of a hypothetical lease deal, linking, by at least one component operated by at least one processor, where the at least one reference lease to at least one lease deal, and simultaneously displaying data of at least one reference lease and at least one lease deal linked to the at least one reference lease.

Further, a system for using real estate lease data has a property file stored on a data storage device and defining at least one leasable space of a property, and a lease component operated by at least one processor and receiving lease data for the terms of a lease and which is associated with the at least one leasable space. This system also has at least one lease detail interface that displays the lease data comprising data related to financial lease elements, and arranged to permit a user to optionally add or remove at least one lease element to the display.

Likewise, a method for using lease data comprises storing a property file on a data storage device, where the property file represents at least one leasable space of a property, and receiving, by a lease component operated by at least one processor, lease data for the lease terms of a lease and which is associated with the at least one leasable space. This method also includes displaying, on a lease detail interface, the lease data comprising data related to financial lease elements, and permitting a user to optionally add or remove at least one lease element to the interface.

In a further aspect, a system of using real estate lease data comprises a property file stored on a data storage device and representing a property, and at least one lease deal associated with the property file. The lease deal has data values of the terms of the lease deal and a version status indicating the status of negotiations of the lease deal, where the version statuses form a hierarchy as the lease deal proceeds through negotiations and advances toward an executed version status of the lease deal.

The system also uses a plurality of approving users each having a ranking and a threshold version status, and a system approval component operated by at least one processor. The system approval component is configured to: (1) receive a request for approval for upgrading a version status of a lease deal, (2) consider the approving users in an order based on the rank, (3) compare a current version status of the lease deal to the threshold version status of the approving user, and (4) request approval from the approving user when the current version status satisfies a certain criteria related to the threshold version status.

By a similar aspect, a method of using lease data comprises storing a property file on a data storage device, where the property file represents a property, forming at least one lease deal associated with the property file and having data values of the terms of a lease deal, and assigning a version status to the at least one lease deal and indicating the status of negotiations of the lease deal. For this method, the version statuses form a hierarchy as the lease deal proceeds through negotiations and advances toward an executed version of the lease deal. The method also includes ranking a plurality of approving users, providing the threshold version status to the approving users, and approving, by an approval component operated by at least one processor, advancement of the version status of a lease deal toward execution. The steps for the approval include receiving a request for approval for upgrading a version status of a lease deal toward executed, considering the approving users in an order based on the rank, comparing a current version status of the lease deal to the threshold version status of the approving user, and requesting approval from the approving user when the current version status satisfies a certain criteria related to the threshold version status.

By yet a further aspect, a system for using real estate lease data comprises: at least one property file stored on a storage device, at least one lease deal associated with the at least one property file and that has lease data on terms of the lease, and a vendor component operated by at least one processor and configured for involving an outside vendor by submitting data to the outside vendor. The submission is based on at least one of: a status of the lease deal, and the value of at least one term of the lease deal.

Similarly, a method for using lease data comprises storing at least one property file on a data storage device, the property file representing a property, forming at least one lease deal associated with the at least one property file and having lease data on terms of the lease, and involving, by a vendor component operated by at least one processor, an outside vendor by submitting data to the outside vendor based on at least one of: a status of the lease deal, and the value of at least one term of a lease deal.

By yet a further approach, a system for forecasting of lease data comprises at least one property file stored on a data storage device and defining at least one leasable space, and at least one lease deal having data for terms of a lease deal and which is associated with the leasable space. The system also has a library with multiple layers of lease data related to the at least one property, where each layer has at least one assumption based on a type of leasable space, and a comparison component operated by at least one processor and configured to compare at least one lease deal to lease data on at least one layer.

Likewise, a method for forecasting of lease data comprises storing at least one property file on a data storage device, where the property file represents at least one leasable space, and receiving at least one lease deal with data for terms of a lease deal that is associated with the leasable space.

The method also includes forming multiple layers of lease data on a library and related to the at least one property, where each layer has at least one assumption based on a type of leasable space, and comparing at least one lease deal to lease data on at least one layer.

### BRIEF DESCRIPTION OF THE DRAWINGS

FIG. 1 is a known lease financial detail input interface;

FIG. 2 is a schematic diagram of a communications network including a system for access, management, and display of property data for financial analysis and forecasting;

FIG. 3 is a schematic diagram of the system for access, management, and display of property data for financial analysis and forecasting;

FIG. 4 is a schematic diagram of the modules and managers used by the system of FIG. 3;

FIG. 5 is a schematic diagram showing a network used by the system of FIG. 3;

FIG. 6 is a flow chart of one possible general operation of the system of FIG. 3

FIG. 7 is a schematic diagram of a property file and related functions used by the system of FIG. 3;

FIG. 8 is a section data interface for use with the system of FIG. 3;

FIG. 9 is a lease network with lease deals and reference leases for the system of FIG. 3;

FIG. 10 is a create lease interface for use with the system of FIG. 3;

FIG. 11 is a reference lease interface for use with the system of FIG. 3;

FIG. 12 is a lease deal interface for use with the system of FIG. 3;

FIG. 12A is a flow chart of one possible general linking procedure for the system of FIG. 3;

FIG. 13 is a lease deal version interface for use with the system of FIG. 3;

FIG. 14 is a graphical linking interface for use with the system of FIG. 3;

FIG. 15 is a library for the system of FIG. 3;

FIG. 16 is a library interface for use with the system of FIG. 3;

FIG. 17 is a forecast interface for use with the system of FIG. 3;

FIG. 18 is an alternative forecast interface for use with the system of FIG. 3;

FIGS. 19A-19B show a flow chart for processing approvals for the system of FIG. 3;

FIG. 20 is an approval administration interface for the system of FIG. 3;

FIG. 21 is an approval user interface for the system of FIG. 3;

FIG. 22 is an approval tracker interface for the system of FIG. 3;

FIG. 23 is an approval request interface for the system of FIG. 3;

FIG. 24A is a flow chart for executing a lease deal version for the system of FIG. 3;

FIG. 24B is an option and encumbrance entry interface for the system of FIG. 3;

FIG. 25 is a vendor administration interface for the system of FIG. 3;

FIG. 26 is a professional services interface for the system of FIG. 3;

FIG. 27 is a comparable lease administration interface for the system of FIG. 3;

FIG. 28 is a comparable lease interface for the system of FIG. 3;

FIG. 29 is a data sharing administration interface for the system of FIG. 3;

FIG. 30 is a workgroup administration interface for the system of FIG. 3;

FIG. 31 is a property administration interface for the system of FIG. 3;

FIGS. 32A-32C show a lease detail report for the system of FIG. 3.

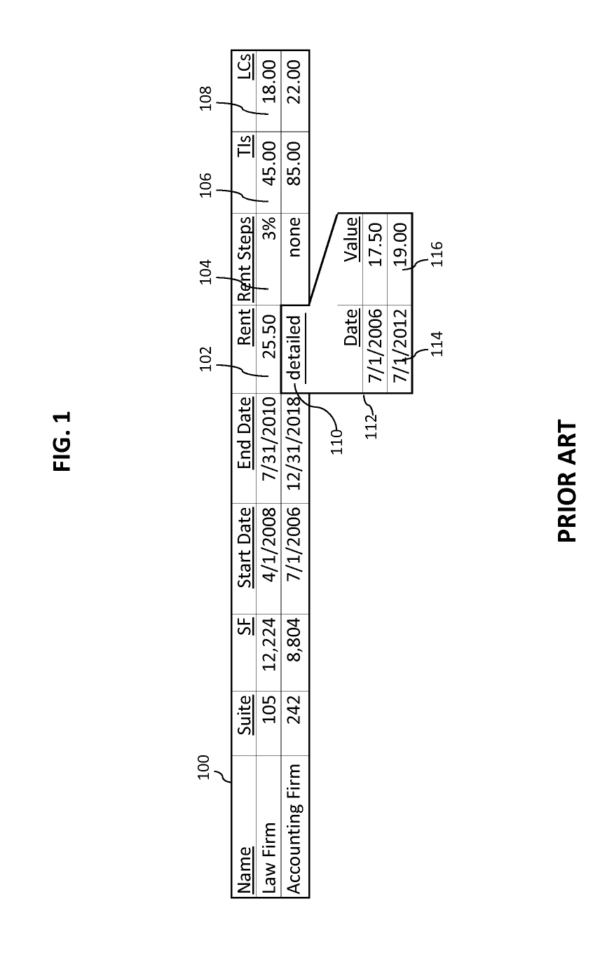

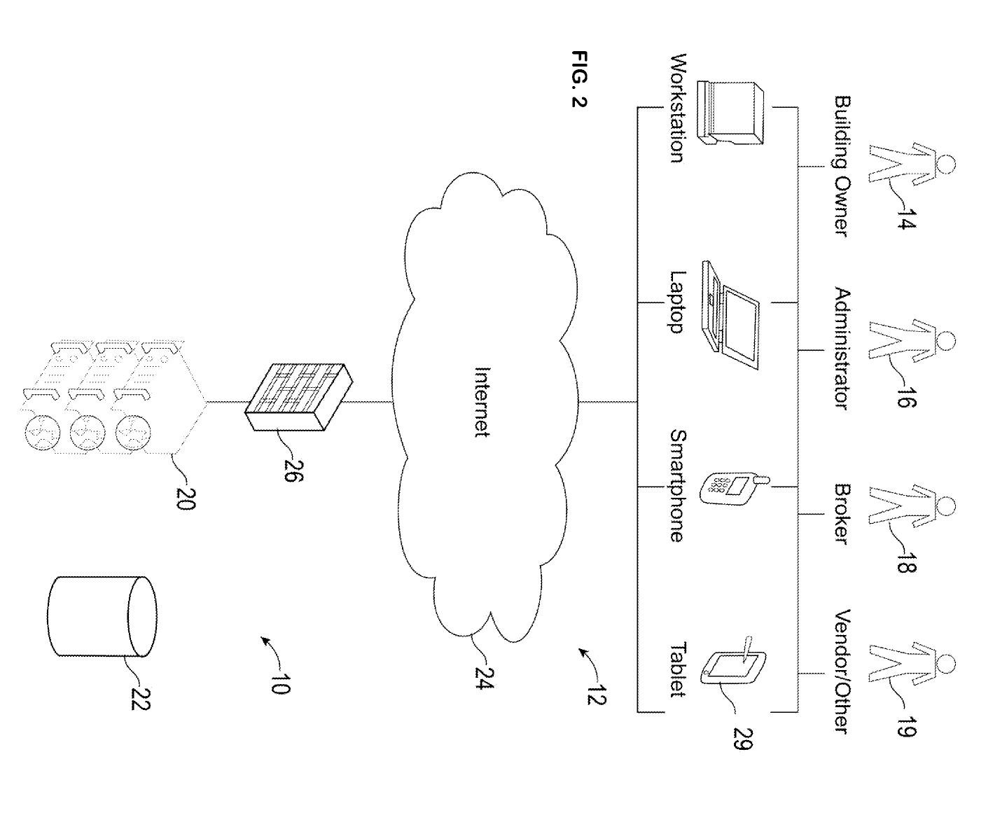

### DETAILED DESCRIPTION OF THE PREFERRED EMBODIMENTS

### I. General Aspects of the System

A system 10 for financial analysis of lease data described herein is an improvement over known systems in a number of different ways. The system 10 applies to properties such as real property like a building, land, and so forth that is divisible into one or more leasable spaces or units (also referred to herein as lease spaces or simply leases once data has been entered for a lease).

The system 10 comprises at least one property file, and when a building is represented by the one property file, the area of the property may be further divided into one or more sections such as floors for example. The at least one property file contains (or contains data for) at least one lease. A lease may be either a reference lease or lease deal. A lease deal represents a contractual lease deal or in-progress lease deal. An in-progress, also called pipeline, prospective, potential or proposed lease deal may be one in negotiations. Each lease deal may occupy space within a building. A reference lease represents a hypothetical lease that can be used for comparison purposes, but does not have the ability to occupy space in a building. A lease deal may also be closed, which means that it is neither in-progress, nor contractual. This occurs, for example, when negotiations for a lease deal are terminated. The deal remains in the system, including all links, so that it may be used for analysis and reporting. However, it may not claim space as explained below.

The system 10 makes it possible for owners and other parties involved with commercial real estate leasing to generate reports and view how the financial and other terms of leases (contractual lease deals, in-progress lease deals, and reference leases) compare to (1) leases currently in place within the building, (2) other leases (either within the building discussed or other buildings), (3) budgeted expectations for leasing, (4) expected performance of the broader market for leased space, and (5) a variety of other comparisons and analysis of leasing data.

In another aspect of the program operated by system 10, reference leases are grouped into reference groups which provide for the bundling of assumptions about the leasing of space. A common use for reference groups would be for budgeting where a reference group is created for each budget. Lease deals may be linked to multiple reference leases through multiple reference groups in a way that allows a lease deal to be compared to the expectations established for the leasing of space in each of the reference groups or a combination of the reference groups. Many other reasons for reference groups may be used.

A typical use of reference groups is to manage budget information. Reference groups are created and then reference leases can be added to the group. For example, separate reference groups may be created for the original underwriting, the 2012 budget, and the 2013 budget. Reference leases may then be added to each of the groups. For example, the original underwriting may have assumed that the tenth floor would lease-up to a full floor tenant for $18/sf, the 2012 budget may assume that it leases up to five different tenants at various rates, and the 2013 budget may have a different set of assumptions for the space. Contractual, and in-progress deals can be linked to theses reference leases, so that a user can compare either an in-progress or contractual deal or both to the assumptions in any of the reference groups.

Comparisons against multiple budgets are useful for two reasons. First, budgets are frequently updated, usually at least once per year, and lease negotiations can bridge the period between a prior budget and the latest budget. For example, the prior budget may have very different assumptions for the space, but now that the potential deal is in advanced stages of negotiation, it makes sense to include it in the more recent budget at the probable terms. The system 10 makes it possible to easily compare the terms of the lease under negotiation against both previous expectations, and the latest expectations. Second, comparisons against multiple budgets make it possible to track expectations over time. This can be extremely useful when tracking actual performance against underwriting (expectations at the time a property was purchased).

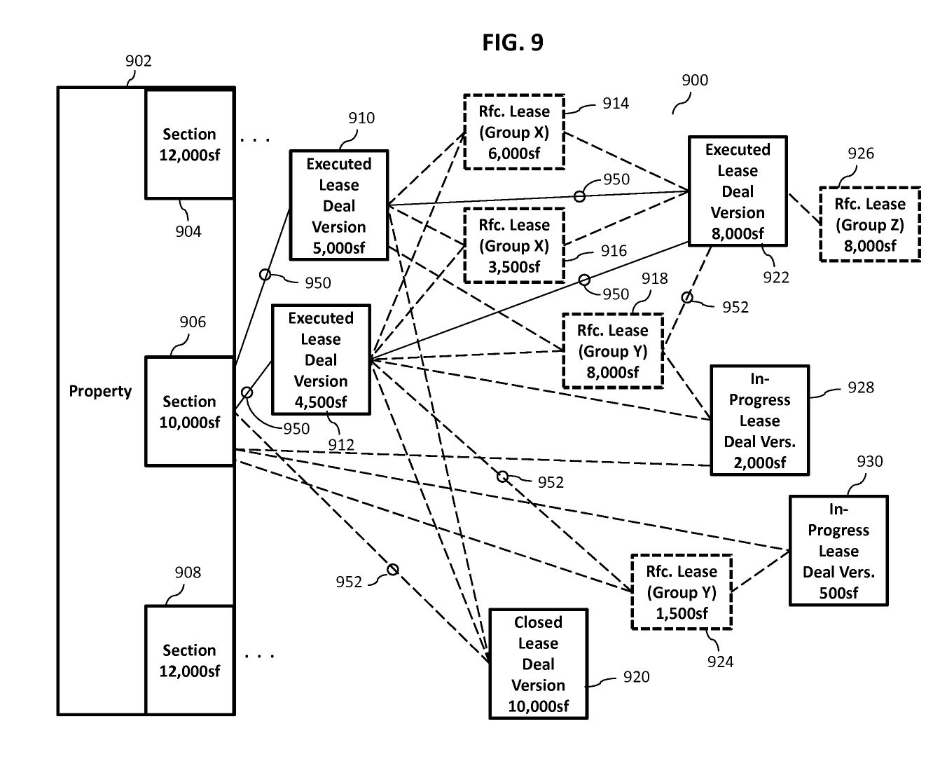

The leases, consisting of a combination of lease deals and reference leases, or just lease deals, or just reference leases may be arranged into, for one example, a network 900 (FIG. 9) through the use of interfaces and logic in the program that allow linking to space for data tracking, and claiming of space for occupying space in the building. Leases within a building may link to and claim space in a variety of ways and space may be divided or combined through the use of the provided interfaces.

Comparisons between leases that are currently in place and prospective leases are important because landlords like to be able to compare prior rents and other lease terms to what they are likely to get going forward. For example, if Law Firm tenant X is paying $22/sf in rent and expiring next year, it is useful to know that negotiations with other tenants for the space are in the $18-$20 range (in other words, the landlord's revenue for the space will decrease because market rents are lower than in-place rents). It is also useful to be able to compare leases to what was previously budgeted for the space (in other words, prior expectations for the financial and other terms that could be obtained in the market for the space at that time).

In another aspect of the system 10, lease deals can be divided into multiple versions, known as lease deal versions, so that common data to the lease version may be entered in one place, and versions may be created as financial and other terms change throughout the lease negotiation process. In one form, the versions represent the negotiating status of the lease deal (in-progress, executed, and so forth). In this form, a version may either be designated as the active version, or the system 10 may automatically select the most recent, or highest level status (such as “executed” for example) to represent the current financial and other terms of the lease deal. For example, if a lease deal interface establishes, through user input, that a lease deal is 5,000 square feet, each version will utilize the 5,000 square foot measurement. If one version has rent of $10, one version has rent of $15, and one version has rent of $20, when the system 10 needs to determine the rent of the lease deal, it will utilize the active version of the deal, which may be established through a user selection, or by the system 10 (based on the most recent version to be updated or the version with the highest level deal status such as advanced, for example).

Each lease, whether a lease deal or a reference lease allows for the input of detailed financial data associated with the lease that, when combined with the network of links and claims can be used to generate reports that compare reference leases to other reference leases, lease deals to other lease deals, lease deal versions to other lease deal versions, lease deal versions to reference leases, and any other combinations of comparison between lease deals and reference leases. The structure of the system makes many combinations possible such that every lease or combination of leases entered may be compared to another lease or leases throughout the program.

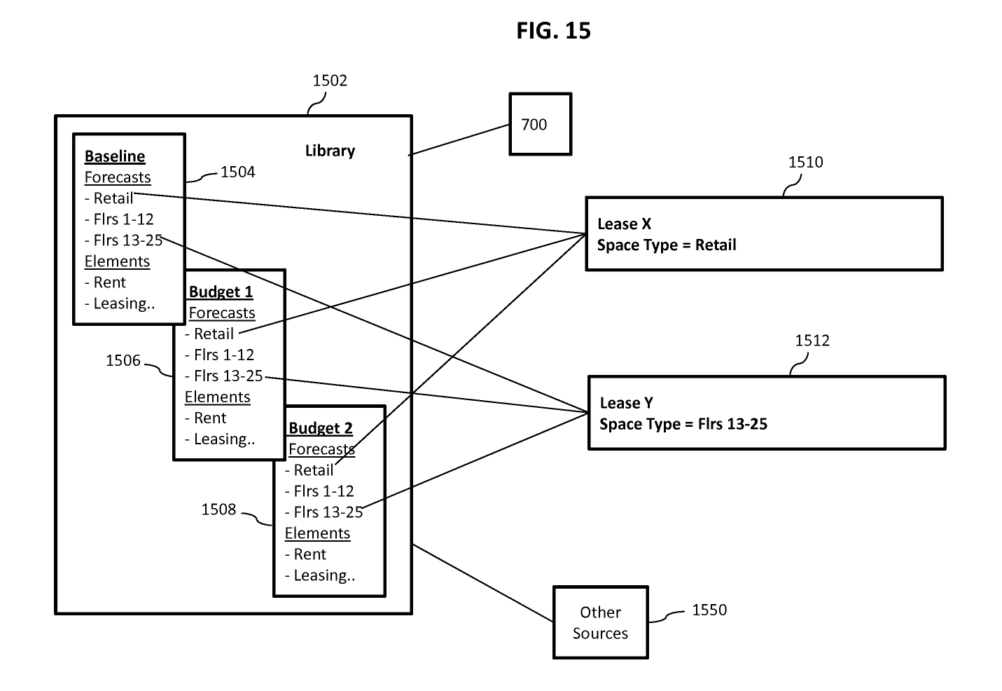

The system 10 also supports the input of library data that may be accessed by multiple leases throughout the system. For example, a complex leasing commission structure may be entered into a library, such as an example library 1502 (FIG. 15), and then accessed by leases so that the complex structure does not need to be entered for each lease. A library may also be used for comparative purposes. For example, an expected rent may be input in the library for a certain time period, and the expected rent may be compared to the rent entered in a lease to determine if the rent entered in the lease is above or below the expected rent input in the library. The library also supports the entry of market forecasts. Market forecasts contain enough data to generate comparison data for any lease at any point in time for which data is entered. Thus, a lease deal or a reference lease which refers to a space type established in market forecasts may be compared to the expectations established in a forecast. Further, each forecast may consist of multiple layers which enable periodic updates to the forecast without changing prior assumptions. This enables the system 10 to create a unique forecast layer that can be paired with a reference group so that a forecast and reference leases may both be part of a reference group. A reference group can alternatively contain just one or the other, and a forecast layer may not need to be part of a reference group. In one example form, each reference group is a budget where details are entered for certain leases (such as reference leases). Entering hundreds of reference leases for hundreds of suites in a building can be cumbersome, so users may enter reference leases for leasing activity expected in the next year rather than all suites. Then, if any unexpected leasing activity occurs, it can be compared against the forecast since no reference leases would have been entered for the space with unexpected activity.

The system 10 also includes approval data and features which use a unique combination of user ranking, a lease deal version's status, and lease metrics and constraints to determine when a lease deal version entered by one user requires approvals from one or more other users of the system 10 to reach a requested lease status.

Another aspect of the system 10 is a vendor selection feature for services associated with real estate leasing such as architects and attorneys, that is based on a lease deal version's status and other data associated with the lease deal version such as its size and financial metrics such that leases that meet certain criteria may be directed to one vendor while leases that meet other criteria may be directed to another vendor. The system may be configured to automatically transmit data to certain vendors once a lease deal version reaches a certain combination of status and other metrics. The system also has the ability to suggest vendors to users or use a list provided by an administrator to provide users with vendor options so that the list is restricted based on lease data, and then a user may utilize his or her judgment to make the final vendor selection.

The system 10 also includes the ability to specifically define comparable leases for a lease deal, and to view, and in some situations, apply the financial data from comparable leases to leases within the system. These leases may be obtained from within the system 10, or may be accessed through third-party databases.

The system 10 also supports the sharing of lease data with external databases based on administrative selections that determine when lease data is shared, and if approvals are required to release the lease data. A workgroup feature is also provided to facilitate the sharing of, and control access to, property files and to provide a common entry and storage point for properties that contain identical data such as approvals or vendor selection.

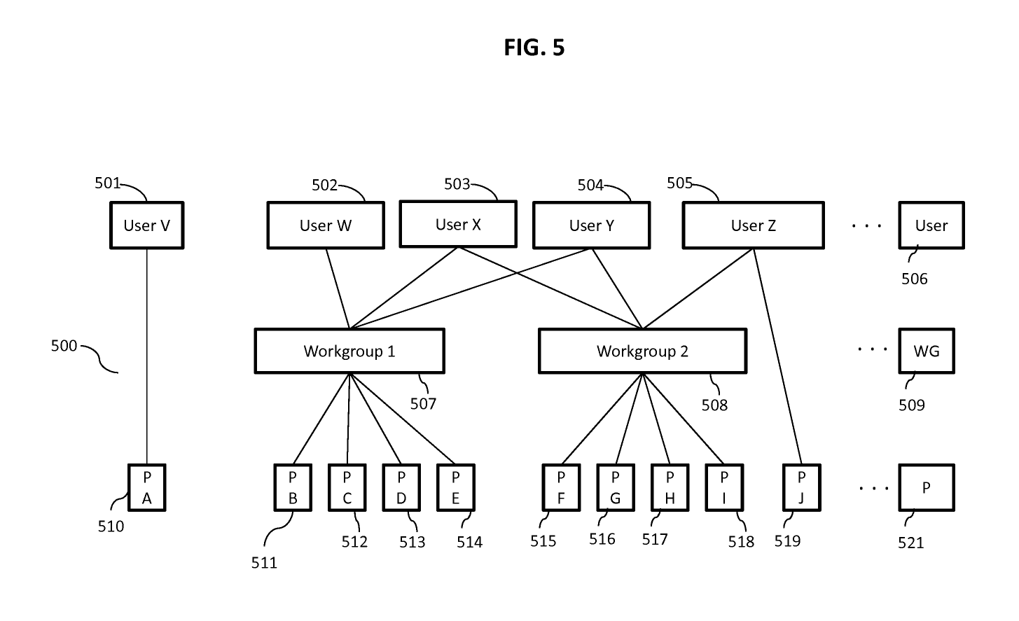

Specifically, the example network (FIG. 5) used by the system 10 also carefully controls which users may be allowed into, or barred from, the system by permitting membership into workgroups. Workgroups consist of a set of users which have access to a set of property files. For example, a workgroup may consist of users from the same company. If a need arises to share a sub-set of properties with a third-party such as a leasing broker, a new workgroup may be created which consists of the sub-set of properties, the users from the company, and the users associated with the leasing broker. Thus, members of the company will be able to access both the properties in their company workgroup, as well as the sub-set of properties in the workgroup that is shared with the leasing broker, while the leasing broker will only have access to the properties in the workgroup containing the sub-set of properties which they are permitted to have access to. The users within a workgroup are able to access each other's property files and different permissions may be established for each property.

Additionally, a Workgroup may be used to enter and store data that is common to multiple properties. For example, library data, forecast data, approval data, vendor selection features, comparable features and data sharing features, each of which may be input and stored within a property file as described below, may also be input and stored within a workgroup which a property file is associated with and then the property is able to reference, or link to the data. This configuration provides a tremendous advantage in organizing the network while permitting the users many options for data input and permissions.

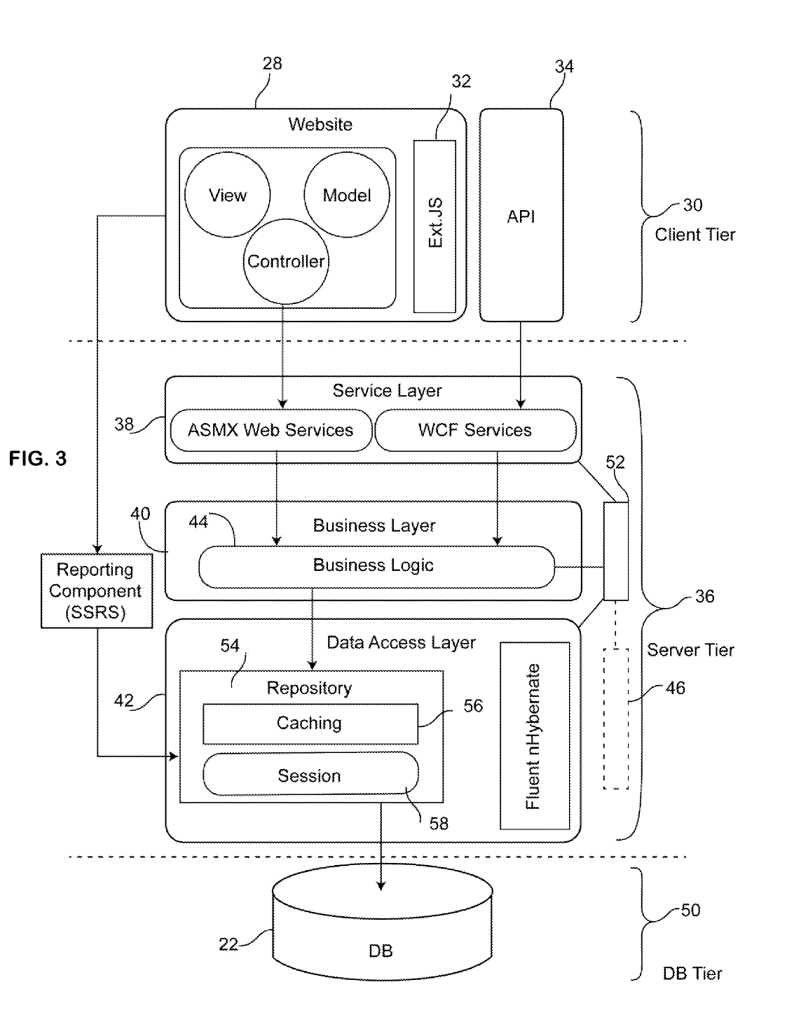

Referring now to FIGS. 2-3, the system 10, in one form, may operate on a communications or computer network 12 that connects users 14, 16, 18, 19 with a number of servers 20 and a database 22 through the internet 24, WAN, or LAN. A firewall 26 may be used to protect the system 10. Otherwise, the system 10 generally defines three tiers although other configurations are contemplated. On a client tier 30, users 14, 16, 18, 19 may log on to the system 10 through a website 28 or other similar portal that is provided on any computer network device 29 such as a computer workstation, laptop, cellular phone, smart phone, iPad, tablet, and so forth, as long as the device has a display for conveying information to the user and sufficient memory for downloading the information. In one form, the website 28 is implemented using Microsoft ASP.NET MVC 3.0 framework. A client-side library 32 based on Ext.JS may also be provided for interaction with the system 10 and for managing AJAX interactions. The client tier 30 may also include an API (application programming interface) 34 for providing secure structured interaction between third-party applications and a business layer 40.

On the server tier 36, in one form, three main layers are provided: a service layer 38, the business layer 40, and a data access layer 42. The service layer 38 provides the communication link for the client tier 30. In one form, the service layer 38 is the only way to communicate between the client tier 30 and the business layer 40. The service layer 38 has a series of web services, such as ASMX for example, communicating with a controller 44 providing the website 28 on the client-side. Services, such as Restful WCF for example, are used to communicate with the API. However, other similar forms and/or versions are contemplated. Data transmitted through the service layer 38 is sent to, or received from, the business layer or business object layer 40.

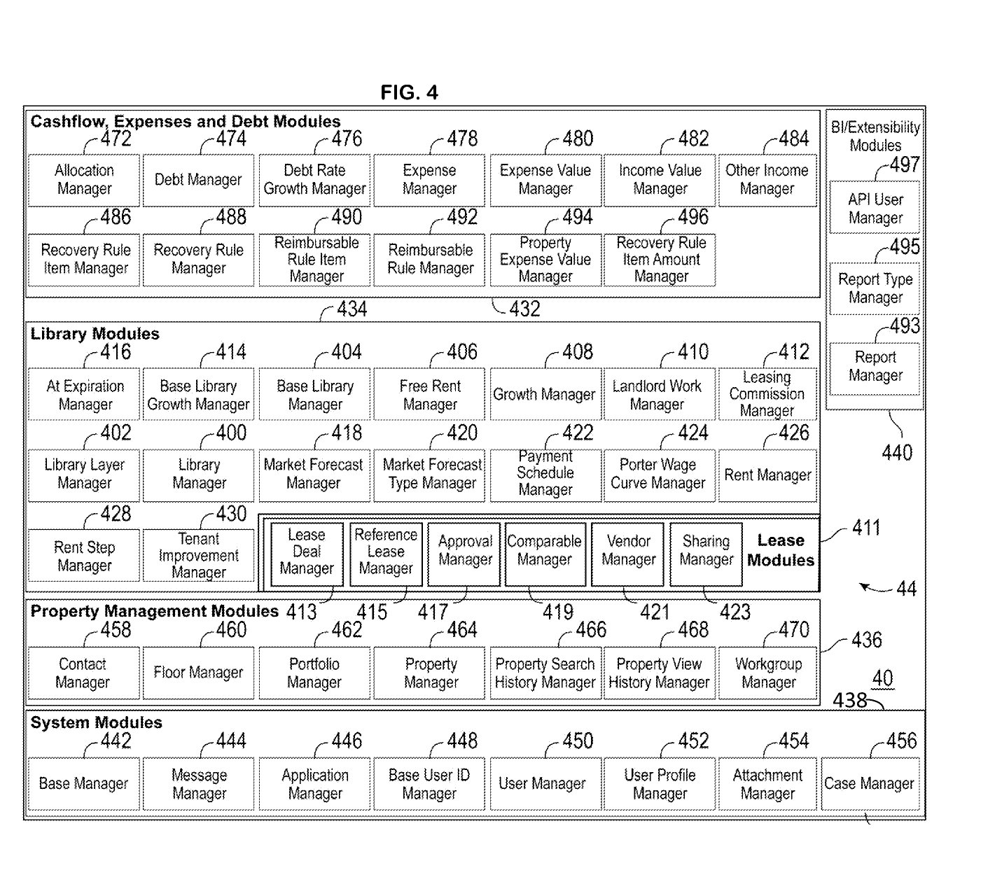

The business layer 40 forms the controller, business logic, program, or application 44 that operates the system 10, and more specifically, the modules or managers that form the application 44 (FIG. 4). The application 44 (including the actual program and its modules) are stored on a storage device 46 such as a memory on the servers 36. It will be understood the location for the storage of the application is not limited to a particular place and may be provided on a separate cloud server over the internet or other network, and/or at a location with or separate from the database 22 or may be divided among multiple locations, or may be in the form of any other non-transitory computer-readable storage medium such as one or more disks, flash drives, random access memory (RAM), read only memory (ROM), and so forth as long as a the device or medium is a tangible medium that can store a program for use by or in connection with an instruction execution system, apparatus or device such as one or more processors 52 also provided on the system 10 to operate the business logic 44. The application may be a Microsoft.Net web application written using .Net framework 4.0 or other versions.

The data access layer 42 is implemented using Fluent nHybernate ORM (Object Relational Mapping) with direct entity-to-table mapping. The data access layer 42 has a repository 54 with a cache 56 for application data and a session 58 for user-dependent data to hold and organize incoming or outgoing data from the database 22.

On the database tier 50, the database 22, in one form, is hosted by Microsoft Sql Windows Server 2008 R2 using IIS 7.5 with Sql Server reporting services as the reporting platform. Other similar hosts and/or versions are contemplated.

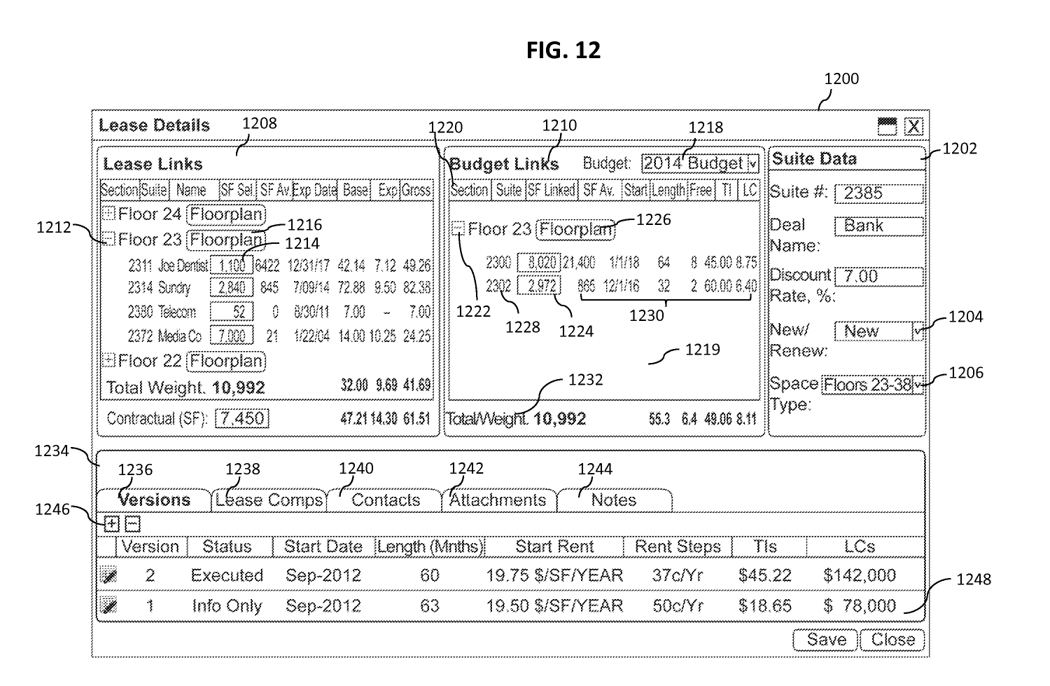

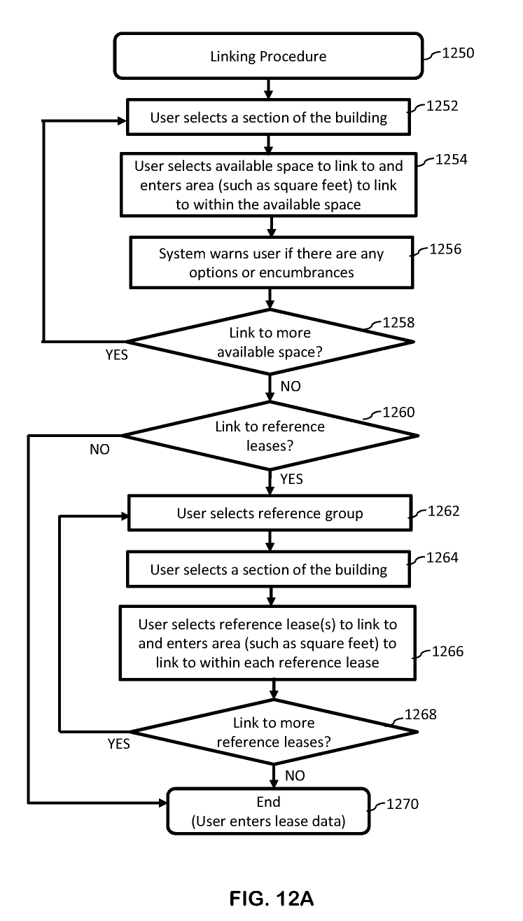

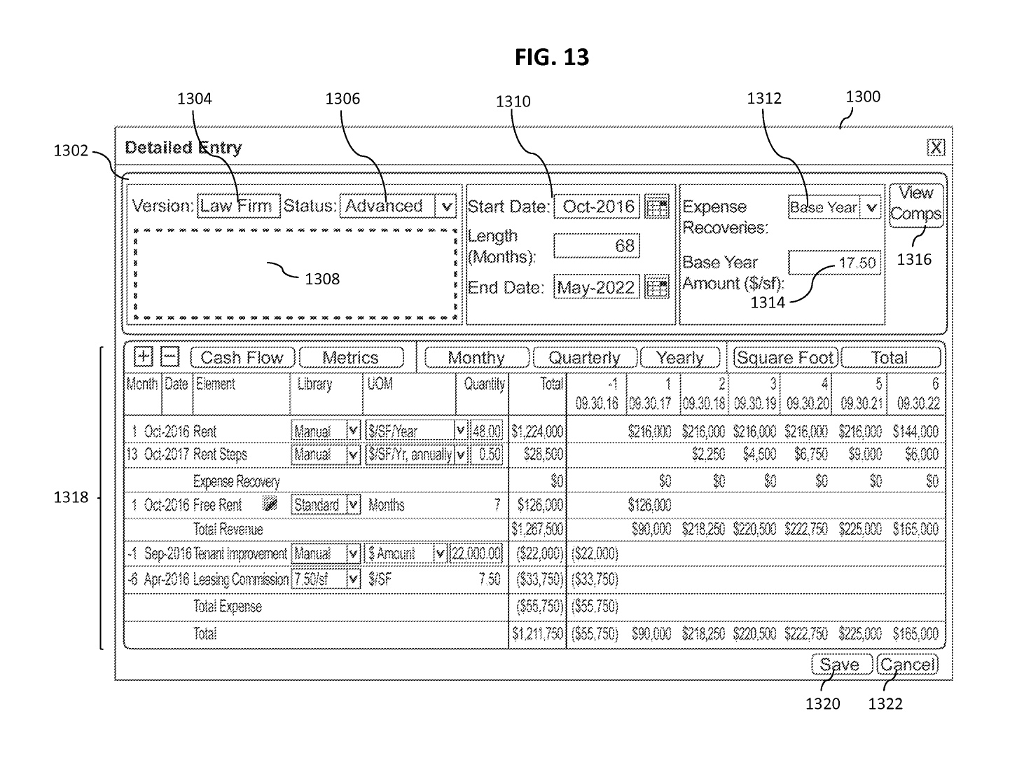

Referring to FIG. 4, the application 44 has a group 432 of cash flow, expense, and debt modules or managers 472-496 for property level financial analysis of the property data, a group 434 of library modules or managers 400-412, 414, 416, 418, 420, 422, 424-430 for managing the libraries, layers on the libraries, and the data for each property related element, category or parameter that is analyzed by the application. The application 44 also has a group 436 of property management modules or managers 458-470 to manage the property file intake and identification for example, a group 438 of system modules or managers 442-456, and a group 440 of BI/extensibility modules or managers 493, 495, 497 for orchestration of structured and ad-hoc access to application data. Each manager is appropriately titled to relate to the tasks managed by that manager (for example, the library layer manager manages the creation, modification, and access to the baseline and sensitivity layers on the libraries). The application 44 also has lease modules, managers or components 411 including a lease deal manager 413, a reference lease manager 415, approval manager 417, a comparison (or comparable lease) manager 419, a vendor manager 421, and a sharing manager 423. These components may also coordinate with at least the library managers 400, 402, 404, the forecast managers 418, 420, and the workgroup manager 470. These components may perform many of the operations described below. For example, the lease deal manager 413 operates the lease deal interfaces 1200 and 1300 (FIGS. 12-13), while the reference lease manager 415 operates the reference lease interface 1100. It will also be understood that the use of the term manager or module alone, herein, does not limit such manager or module to a separate or distinct part of a computer program or to the programming or performance of any particular tasks but merely means a computer, application, or program component that controls the indicated tasks in the system 10.

Referring to FIG. 5, the system 10 may be implemented in a number of different forms as exemplified by data flow or interaction network 500. Network 500 shows a number of possible different configurations for linking together or providing access to one or more property files 510-521, users 501-506, and workgroups 507-509 for the present system 10.

Generally, a workgroup 507-509 is a central place to provide access to a group of users 501-506 to access a property 510-521 and to enter read and write permissions for each user who has access to a property. Additionally, data that is used for multiple properties within a workgroup may be entered in the workgroup to limit the need for repetitive entry of data. For example, rather than selecting and inputting lease comparable features multiple times for properties 515-518, an authorized user may elect to enter the data once into a workgroup 508, and then allow the properties 515-518 to access the data.

In one example, the user 501 has a property 510 that is not included in a workgroup. An individual user may have multiple properties that are not included in a workgroup, and thus are not shared properties. With this configuration, only user 501 may access the property file 510.

In the illustrated example, user 502 has a membership in a workgroup 507 that contains properties 511-514. User 503 and user 504 also have access to workgroup 507. Thus properties 511-514 are shared properties which users 502-504 have access to. User 503 and user 504 also have access, along with user 505, to workgroup 508. Thus, users 503 and 504 can access property data for properties 511-518 through workgroups 507 and 508, while user 502 can only access properties 511-514 as part of workgroup 507, and user 505 can only access properties 515-518 through workgroup 508 and property 519, which is an unshared property, which only user 505 has access to. If the user 505 wished to share property 519, the user could add it to an existing workgroup, or the user could create a new workgroup and then add users to the workgroup.

While the network 500 shows a number of possible example configurations, it will be understood that many other configurations with users, workgroups, and properties exist, and no limit exists as to the number of these components that may be linked to each other, other than the limits of the communications network and computer equipment the system is provided upon (for example, memory space, bandwidth, and so forth).

In other alternatives, the network 500 may be configured very differently. For example, workgroups could be eliminated and all sharing features, permissions, and data entry would take place at the property level. For example, rather than adding a property to a workgroup and then allowing multiple users to access the workgroup, a property file could be configured to allow multiple users to access it directly without the use of a workgroup.

In another aspect of the system 10, some property transactions such as removing or assigning a property to a workgroup and either directly entering, or linking to a workgroup, certain aspects of property data such as library, forecast, approval, vendor selection, comparable, and data sharing features as described below are only available to a property administrator. Each property has a designated administrator (initially whoever created the property, or if the property is created by a system administrator, a user designated by the system administrator). Administrative privileges can be easily transferred between members of a workgroup. For example, user 502, if the current property administrator, could transfer administrative privileges for properties 512 and 514 to user 504. Property administrators may also designate some administrative features to other members of a workgroup without transferring full administrative features. For example, user 502, if still the property administrator for property 512, could allow user 504 to enter library data accessible by all properties in the workgroup. In yet another aspect of the system 10, each workgroup 507-509 has a workgroup administrator who has additional permissions such as admitting, inviting, and removing users. By default, the user who creates the workgroup is the workgroup administrator, but administrative privileges can be transferred to any other user of the workgroup.

### II. General Operation

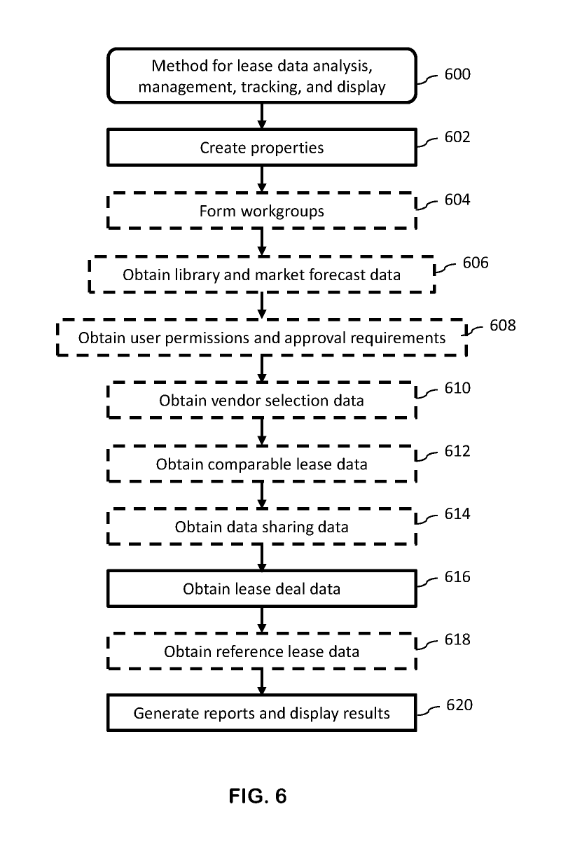

Referring to FIG. 6, the system 10 can be implemented in many different ways. One example method (600) includes first creating (602) properties 700, which in one form is performed by the system administrator who can create a new property file and then assign a user of the system as a property administrator. The user can then perform other steps in the method for operating the system 10. In other forms, users of the system 10 may be allowed to create property files. Once the property file 700 is established, which also includes the establishment of one or more sections of the building or property, lease deal data 706 may be obtained (616) by importing data or creating lease deal data on the interfaces described below. Likewise, reference lease data 704 may optionally be obtained (618) in a similar manner. These steps include forming links and claims to lease space or among lease deals and reference leases. This process of providing lease deal data and associating lease deals with lease space and with other lease deals is described in detail below.

Alternatively, after forming property files 700, workgroups may be formed (604) to provide a group of users access to property files as well as library, market forecast, approval, vendor, comparable lease, and data sharing data (for example, data related to the sharing of data) that may be stored and managed at the workgroup level in lieu of storing and managing it within property files. Then a library 1502 (FIG. 15) may be built (606) including, in one form, market forecasts. Also, then, approval data may be entered (608), vendor data can be obtained (610), comparable lease data settings may be established (612), and data sharing settings can be obtained (614). In one form, after one or more of these settings are established, then lease deal 706 and reference lease data 704 may be created and/or obtained (616, 618), and reports or displays of the results of the workflow and analysis may be generated (620). The process for operating the system 10 is provided in detail below.

This is just one method of many that may be utilized to implement the system 10. For example, a user may create a workgroup before property files are created, or a user may choose to build libraries, market forecasts, and enter approval data within a workgroup before properties are created that will be part of the workgroup. A user may also choose to enter or obtain some data while excluding other data. For example, a user may enter (616) lease deal data 706 after obtaining access to a property file 700 and still be able to use many of the features of the program. Thus, it will be appreciated that there are many different ways to order the steps 602-620, and all possibilities are included herein unless otherwise noted.

### III. Property File and Lease Deal Network

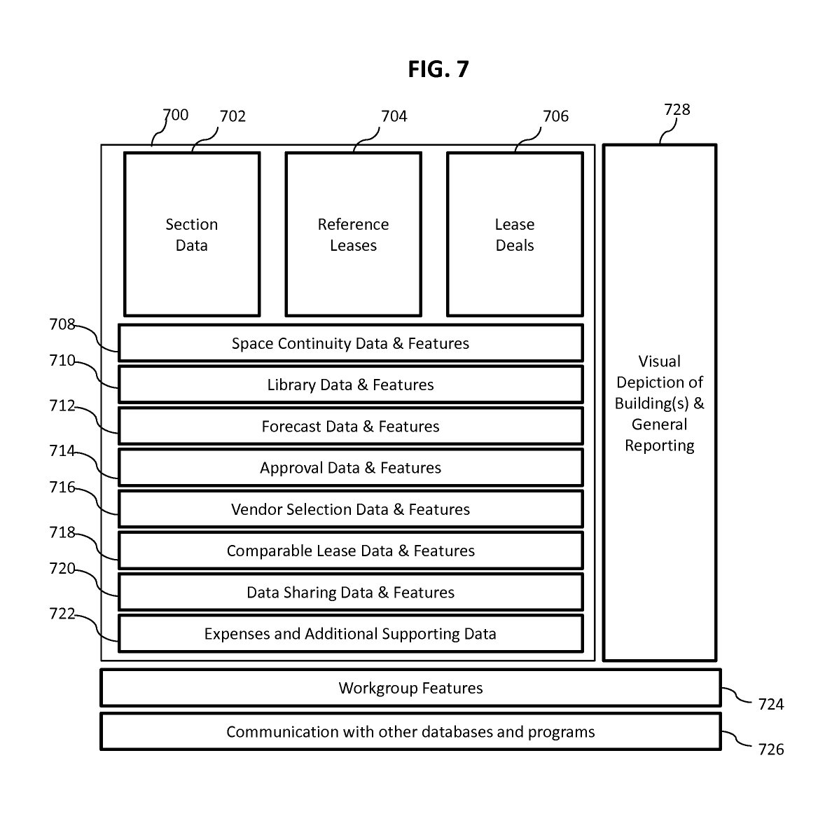

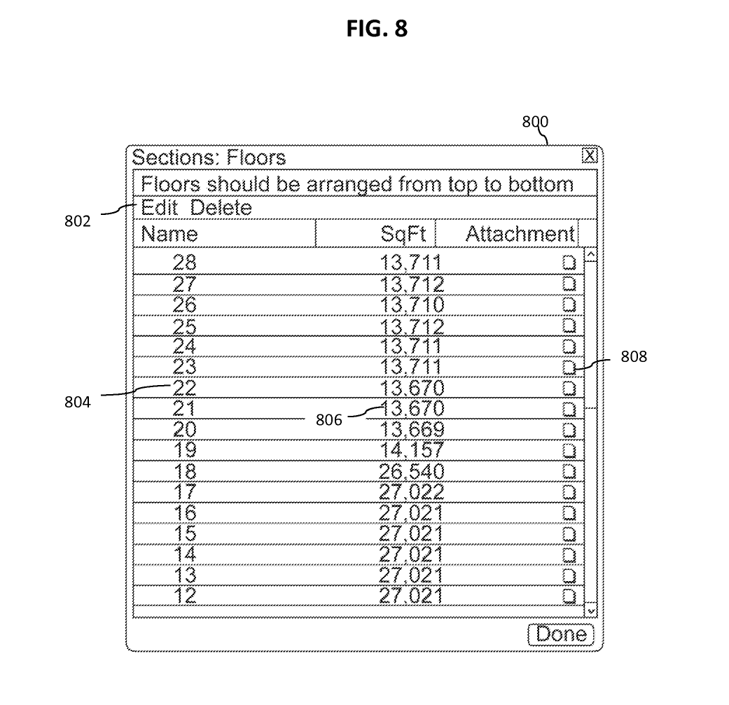

Referring to FIGS. 7-8, a property file 700, represented as any of property files 510-521 (FIG. 5), may contain data directly in the property file, or may contain links to data sources outside of the property file. Such external data may include library data, forecast data, approval settings, or comparable lease data and settings for example, contained in separate files within the program such as files associated with a workgroup or a specific user, or in files outside of the program that are accessed through the API and other communication features 726. In one form, a property file 700 has section data 702. The section data 702 is provided by, for example, data entry in a section interface 800 (FIG. 8). Section data 702 is used to enter and allocate a property's area between sections, such as floors, or different types of space such as in-line retail space, anchor retail space, and so forth. While the illustrated section interface 800 allows for multiple sections, in other forms, the section data 702 could be restricted to a single entry such that the single entry represents the entire area of the building. The ability to add multiple sections for division of the space of a building is provided for convenience and to enhance the organization of lease data, but is not always necessary for the operation of the system. The section interface 800 also includes an area for adding sections (not shown), as well as an area 802 for editing and deleting sections, an area 804 for naming sections, an area 806 for assigning an area measurement to each section, and an area 808 for attaching a floor plan for each section. While not illustrated here, in some forms, the section interface 800 may be customized for a particular user or group of users in various ways. For example, if a user's preference for defining sections is different than “Floors” as shown in the example, the default value can be changed to another form of defining sections such as clusters of space in a shopping mall (for example, anchor tenants, in-line tenants, and so forth). Similarly, if a user's desired area measurement is known, measurement area 806, which shows square feet (“SqFt”) in this example, can be changed to reflect any unit of area measurement.

Referring to FIGS. 7 and 9, property file 700 contains section data 702, reference lease data 704 (or simply referred to herein as a reference lease), lease deal data 706, and space continuity features 708 that are used to form a network 900 of lease data. In one alternative form, the network 900 presents lease deals in chronological order, horizontally across the page from left to right. Thus, for each lease deal and reference lease represented by a rectangle, links or claims represented by lines leading to the left of the rectangle extend to objects with lease durations ending previously to that of the present lease deal or reference lease, and the lines extending to the right of the rectangle lead to objects with a lease duration beginning after the present lease deal or reference lease. In this case, if a lease deal with an early lease period (Jan. 1, 2012 through Jun. 30, 2013 for example) is added to the network 900 after an already existing lease deal that covers a later lease period (such as calendar year 2014 for example), both claiming to the same or overlapping leasable space, then the administrator may be provided with controls to rearrange the network and place links in chronological order.

In another form, however, the system does not enforce a time limitation. In this case, no chronological requirement exists for the system to operate. In practice, lease deals often will be added in chronological order anyway, but the continuity is enforced by claims rather than time. For example, there are a variety of ways to slice up a section, but once a slice is removed by a claim, no other lease may claim the slice. It is then possible to claim part or all of the newly created configuration (simply: each executed lease deal is a pie, and other executed lease deals may claim a slice of the pie—once the pie is gone, no other lease deals may link to or claim space from it). As explained below, reference leases may link to any executed lease deal (or sections) regardless of claims by other leases (i.e. even after a section is entirely claimed, a reference lease may still link to it).

In one form, a property file 902, has one or more sections 904, 906, and 908, and the property file 902 may have less or more sections, and each section may have additional information. For simplicity, only one possible configuration for section 906 is shown. Many configurations are possible, and both lease deals and reference leases may create links to multiple sections. This occurs, for example, if a lease occupies multiple sections of a building.

Lease deals may have one or more deal versions, and each version has a status such as closed (when a deal is no longer active for example), inquiry (a first offer for example), in-negotiation, advanced (when the lease is almost ready for signature, for example), or executed. The closed (or closed deal version) and executed (contractual or executed deal version) statuses are defined in the software (though the status can be displayed under different names in the user interface). All other statuses (inquiry, advanced, in-negotiation) can be defined at either the property or workgroup level and are known as in-progress (or in-progress deal version) statuses. The status of a lease deal version may also be referred to as a lease deal status. For example, an executed lease deal version may simply be referred to as an executed lease deal (typically this will refer to the active, or the most advanced, lease deal version). The in-progress lease deals may also be referred to herein as potential, perspective, in-negotiation, or proposed lease deals. Generally, a lease deal is one that is or has been discussed or offered to another party, such as a tenant or potential tenant. This is in contrast to a hypothetical or reference lease primarily used for calculation and analysis purposes. It should be understood that the system is able to fully function with a single version for each lease deal. In other words, a user simply enters all data for a lease deal, including the data typically associated with a version, through a lease deal interface such that the concept of versions no longer exists. The ability to maintain multiple versions of the same lease deal is provided for convenience and to reduce repetitive data entry. Note that deal version statuses are distinct from approval statuses which are discussed later.

The illustrated network 900 consists of lease deal versions 910, 912, 920, 922, 928, and 930 which may be created through a lease deal input interface 1200 (FIG. 12) and a lease deal version input interface 1300 (FIG. 13). Each lease deal includes at least one version in the illustrated form. In at least one form, multiple lease deal versions may be created to track the progress of a deal over time, and the status of each lease deal version dictates the way it interacts with the network 900. For example, an executed lease deal version may claim space, while an in-progress or closed lease deal version may only be linked to space. In an alternative form, only one version is permitted per lease deal, and in this alternative form, the same structure for the network 900 applies (except only one version is permitted per lease deal).

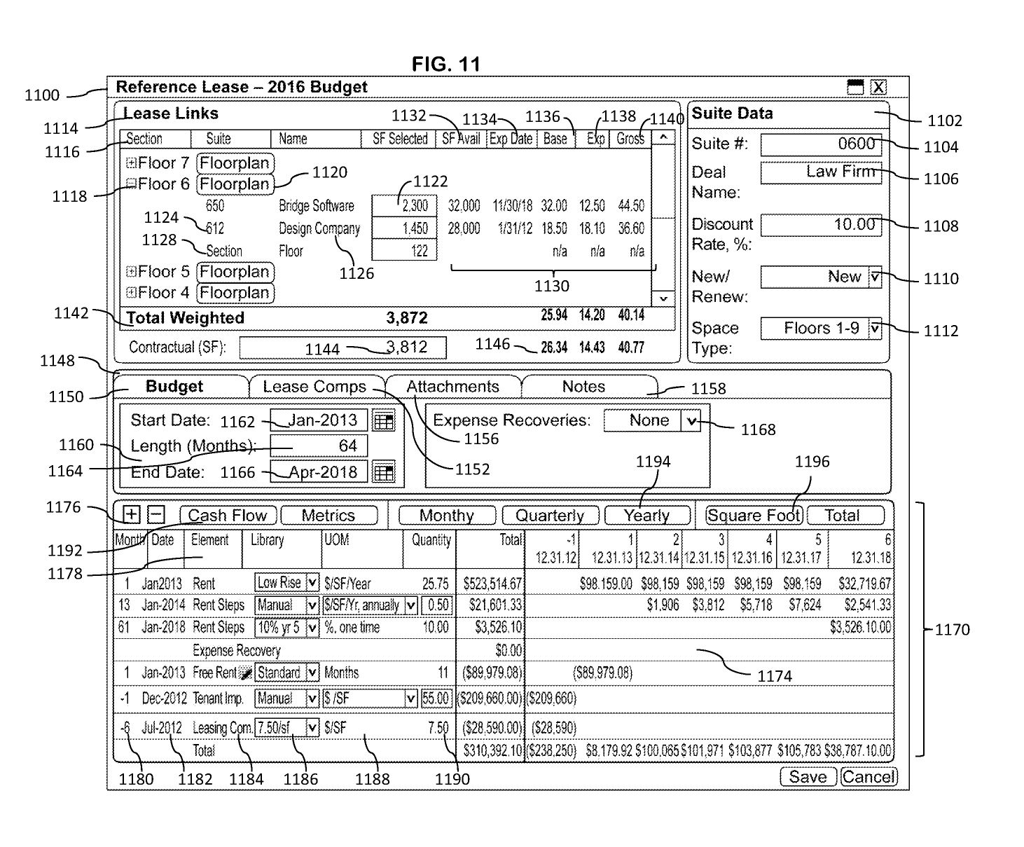

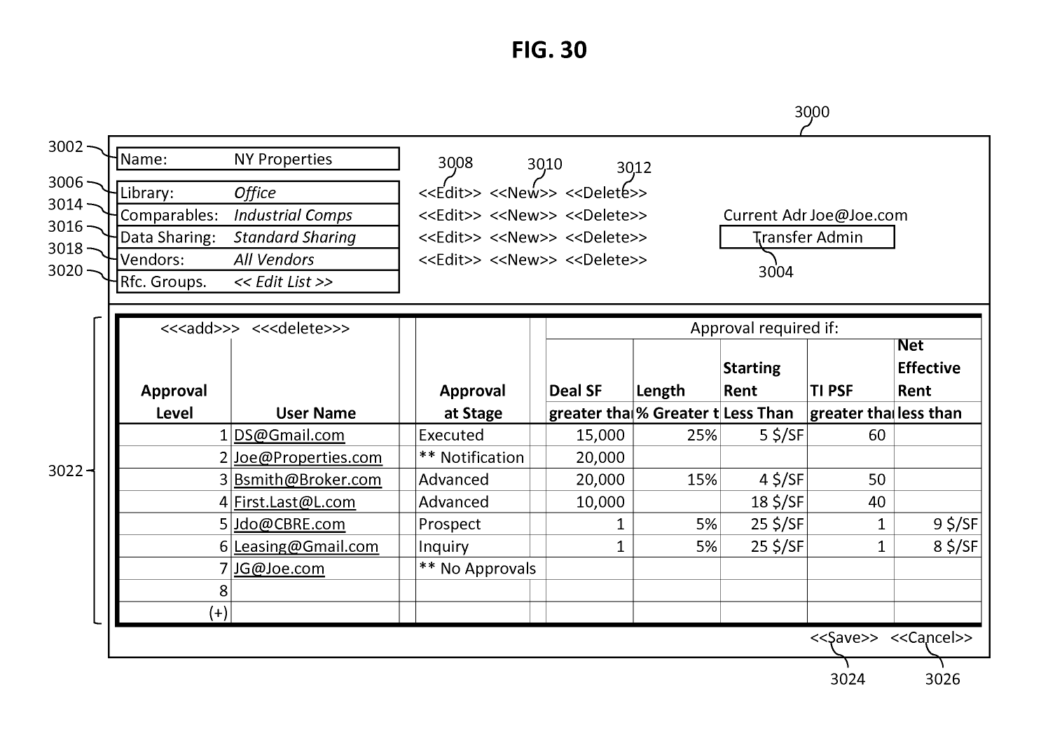

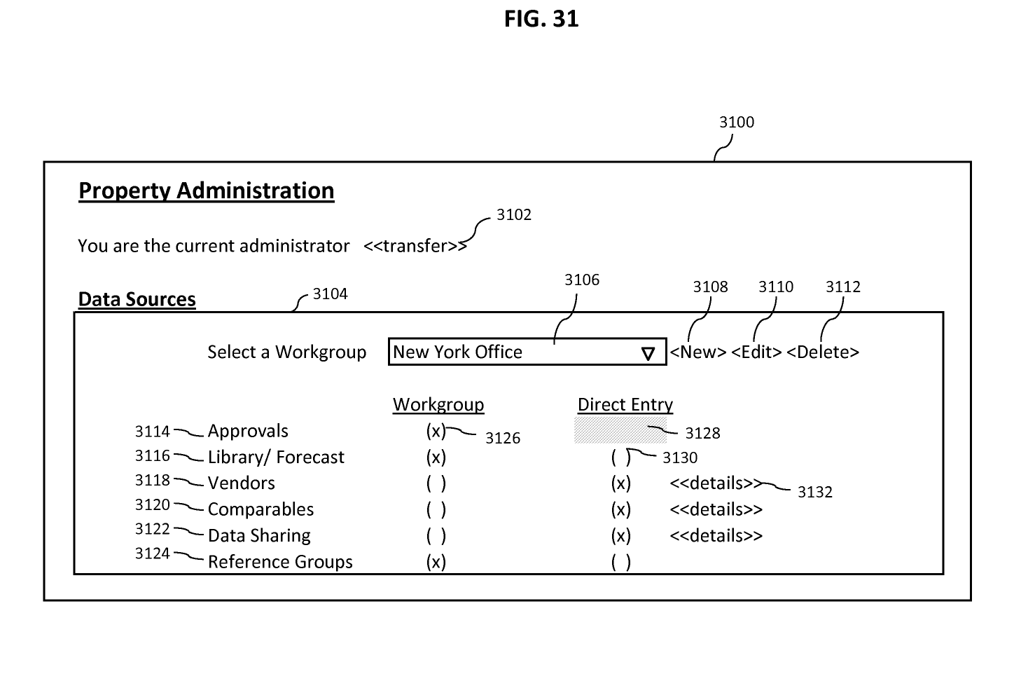

The illustrated network 900 also includes reference leases (also known as reference lease deals, or budget leases) 914, 916, 918, 924, and 926, which may be created through a reference lease input interface 1100 (FIG. 11). Reference leases in the illustrated network are grouped into reference groups X, Y, or Z (of which, there may be just a single group). In one form, a reference lease can only belong to a single reference group. Reference groups are created in the property administration interface 3100 (FIG. 31) by simply selecting a button that creates a new reference group and providing a name for the reference group. Reference groups can also be created in the workgroup interface 3000 as shown in FIG. 30. In one form, one reference group for each property must be designated as the current reference group, which can be used for approval metrics (where a lease deal version is compared to terms of reference leases) and some reports which refer to only the current reference group. In one form, this does not restrict the availability of other reference groups, and is simply a way of designating a current reference group for reports and calculations which must refer to a single reference group.

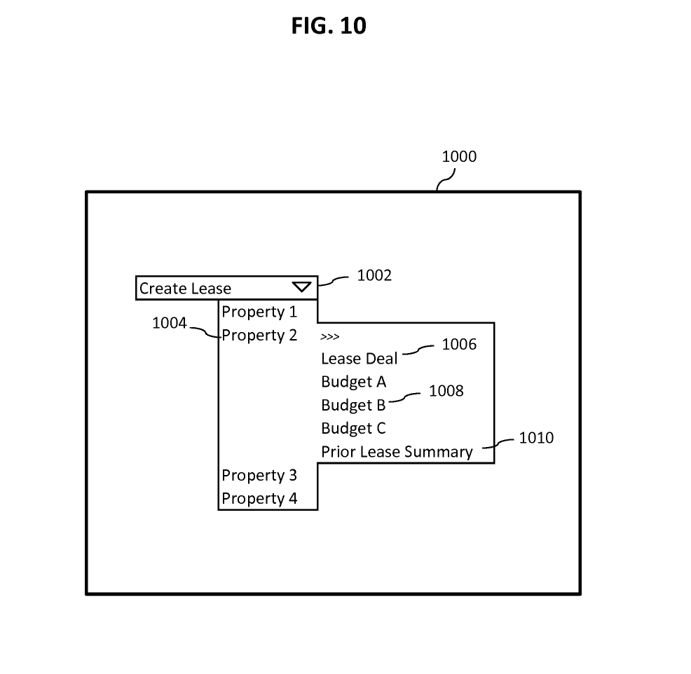

After a new reference group is created, reference leases can be added to a reference group through the create lease interface 1000 (FIG. 10). Space continuity features 708 are shown by solid lines 950 which represent claims on space and dashed lines 952 which represent links to space. Claims on space are made by executed deal versions to establish the continuity of space in a building. For example, executed deal version 910 has claimed 5,000 sf from section 906 which means that executed deal version 910 will occupy, or claim, space that is part of section 906 for a period of time. Links are used to create space references used for calculations and reporting, and in the case of lease deals and lease deal versions, to establish a possible future claim on space. For example, a link from an in-progress deal version to an executed deal version can be used to establish the increase or decrease in rent per square foot that an in-progress deal version would obtain versus the rent that is earned by the executed deal version to which it is linked.

Reference leases may not claim space since they represent hypothetical deals and therefore will never actually occupy space. Reference leases have the ability to link to sections and executed deal versions and may also accept links from lease deals. These links serve a similar purpose in that it makes it possible to compare a reference lease to a lease deal and its version(s). For example, if the reference lease represents a lease in a budget, then it is possible to compare the terms of a budgeted (reference) lease to a lease deal version. The links from lease deals to reference leases make it possible to compare the terms of the lease deal versions, which may be executed, closed, or in-progress, to the reference leases. In this case, the links can be used to compare the actual or contemplated lease deal version terms to one or more reference leases to measure performance against budget.

Each reference group is independent of other reference groups such that inputs, calculations, and links to space within one reference group does not restrict or impact the inputs, calculations, or links of another reference group. The ability to have multiple reference groups, and the ability to link to reference leases within the reference groups has not been accomplished before and provides many benefits, such as the ability to track expectations over time (compare recent budgets to expectations that were established when the property was purchased for example), and the ability to add a new reference group (budget) without the need to disrupt, re-import, or otherwise alter data from deals that are in-progress. In other words, links to reference leases within a reference group for an existing budget can remain in place, and then a new reference group representing a new budget may be added to the system without impacting the data associated with any prior reference groups.

In one minimal form, the illustrated network 900 can operate with only a property, a section (which may represent the entire area of the property), and a lease deal with a single lease deal version. Reference leases provide additional information, but are not necessary in all cases for the functioning of the network. Lease deal version 910 is an executed deal version that was set up by using a space allocation or selection area 1208 in the lease deal input interface 1200 (FIG. 12) to claim 5,000 square feet (sf) from section 906 (FIG. 12, currently shows a different lease deal example). Lease deal version 912 is also an executed deal and it has claimed 4,500 sf from section 906. Since section 906 consists of 10,000 sf, of which lease deal version 910 has claimed 5,000 sf, and lease deal version 912 has claimed 4,500 sf, the section only has 500 sf remaining for other lease deals to link to. For example, if a user is creating a lease deal version after lease deal versions 910 and 912 have been executed, when the user allocates space in the space selection area 1208 (FIG. 12), the user will only see 500 sf that is still available from section 906, as well as 5,000 sf of available space from lease deal version 910 and 4,500 sf of available space from lease deal version 912. Here, as mentioned above, the system does not enforce this chronologically, but rather based on claims, such that after all of the space is claimed from a section, no other leases may claim the space (except links by reference leases may still be allowed). This is effectively chronologically in many cases, but there are some exceptions. For example a lease deal version X may link to or claim space from a lease deal version Y for a lease deal version X that commences or starts before version Y expires. This happens when there is an early termination where (Y goes out of business, or X offers a better deal for the landlord for example, so the landlord buys Y out of its lease. Thus, links and claims are not necessarily made to ‘prior leases’ but rather ‘previously executed leases’.

Note also, the terms lease deal version and lease deal may be used interchangeably to illustrate that they can be used synonymously. Basically, it is the deal that links or claims, and versions are a subset of the deal, so technically a lease version may not link directly to, or claim, available space, but rather a lease version may link to, or claim, space through a lease deal. As mentioned previously, a lease deal may also be limited to a single lease deal version such that the concept of multiple versions is not apparent to a user.

Reference lease 914 for 6,000 sf, which is part of reference group X is linked to both executed lease deal 910, and executed lease deal 912. This illustrates a situation where a user expects the spaces encumbered by the executed lease deal versions 910, 912 to be combined in a configuration other than the configuration they are in for the executed lease deals. For example, the user who established reference lease 914 may expect that 4,000 sf associated with executed deal 910 and 2,000 sf associated with executed deal 912 will be combined into a new 6,000 sf suite as represented by reference lease deal 914. The same logic follows for reference lease 916, also a part of reference group X. This reference lease 916 may include a link to the remaining 1,000 sf of executed deal 910, and 2,500 sf of executed deal 912. In summary, the user who established reference group X believes or proposes that the space occupied by executed lease deal 910, and the space occupied by executed lease deal 912 may be reconfigured into two new suites represented by reference leases 914 and 916. Reference leases in FIG. 9 are shown in a dashed line to differentiate them from the actual or proposed lease deals.

The illustrated network 900 also includes reference leases 918, and 924, both a part of reference group Y. Reference lease 918 contains links to executed lease deal 910 and executed lease deal 912. Though the square footage linked is not shown in the current example, reference lease 918 may be linked to 5,000 sf of executed lease deal 910 and 3,000 sf of executed lease deal 912. Reference lease 924 contains links of 1,000 sf to executed lease deal 912, and 500 sf to section 906. Thus, the user who entered data for reference group Y, who may be the same user who entered data for reference group X, expects that 5,000 sf currently occupied by executed lease deal 910 will be combined with 3,000 sf from executed lease deal 912 to form a differently configured suite represented by reference lease deal 918, and that 1,000 sf from executed lease deal 912 will be combined with 500 sf from section 906 to create a different suite represented by reference lease 924. Reference leases may be linked in a variety of ways.

Just as with a floor in an office building, section areas may be configured and reconfigured in multiple ways at multiple times. Lease deal versions may track the economics and space to be occupied by actual and potential deals, while reference leases and reference groups may be used to track expectations about economics and the occupancy of space within a building.

Executed lease deal version 922, which, as with other lease deal versions, may have started with a different status other than executed, is linked to reference leases 914 and 916 of reference group X. This means that the user who entered linking data for the lease deal which version 922 is a part of identified the areas of the building associated with reference lease 914 and reference lease 916 as the areas that would be occupied under the lease deal version 922. A user also linked lease deal 922 to reference lease 918, part of group Y, which indicates that the user expects lease deal 922 to occupy the full 8,000 sf identified in reference lease 918. In other words, the space configuration of lease deal 922 is different than what was contemplated with reference group X (which had a 6,000 sf suite and a 3,500 sf suite), but may be identical to what was contemplated in reference group Y (the same 8,000 sf suite).

The links make it possible to compare the financial and other lease metrics established in the reference leases to the lease deal 922. For example, the terms of lease deal version 922 can be compared to either one or a combination of reference leases 914 and 916 when comparing the deal to the expectations established in reference group X, where typically the comparison will be made between the terms of lease deal version 922 and the weighted average terms of reference leases 914 and 916. Other comparisons, however, may be made as well such as comparing lease deal version 922 to either reference lease 914 or reference lease 916 individually. Lease deal version 922 can also be compared to the expectations established in reference group Y through the link to reference lease 918.

Though calculations are the most accurate when links are for the exact same area measure, and users will be warned of such, the program does not require the links to sum to the same amount. For example, lease deal version 922 can still be compared to reference lease 916 using per square foot metrics even though the total square footage of lease deal version 922 is greater than the linked square footage of reference lease 916.

Generally, then, once a lease deal version is associated with a property file and at least one leasable space (such as a suite), multiple other lease deal versions of the same or different lease deal that are associated with the property file and leaseable space may be compared to the present lease deal version as described below. Further, any number of reference leases that are associated with the property file and leasable space may also be used for comparison to the present lease deal version. These comparisons all may be made without replacing the stored terms, values, or financial calculation results that are already saved for any of the lease deals and reference leases or their comparisons so that no data is lost while the network 900 and the database of leases grow. The interfaces for these comparisons are explained below.

For another example, executed lease deal version 922 also has claimed space from executed lease deals 910 and 912. This claim may have started as a link while the lease deal version was in-progress, and then changed to a claim once the lease deal version was executed. The claim reduces the amount of area available to other lease deals from executed deal versions 910 and 912. For example, if executed lease deal version 922 claims the full 5,000 sf of executed lease deal 910, then other in-progress lease deal versions, will no longer be able to link to or claim space from lease deal version 910 since all of the space has been claimed by executed lease deal version 922. Further, executed lease deal version 922 claimed an additional 3,000 sf from executed lease deal version 912 in order to claim the full 8,000 sf necessary to configure the space under the lease. Thus, only 1,500 sf remains for other lease deals to link to and claim from lease deal version 912 (4,500 sf less 3,000 sf).

In-progress lease deal version 928, which may be currently linked to the remaining 1,500 sf of executed lease deal 912, and 500 sf of section 906 represents a possible future claim on this space. In-progress lease deal version 930, which has a link to 500 sf of section 906 also has a possible claim on space. In other words, both in-progress lease deal versions 928 and 930 are linked to the same 500 sf of section 906. In-progress lease deal version 930 is also linked to 500 sf of reference lease 924, which is part of reference group Y. If in-progress deal version 930 were to advance to executed status prior to execution of in-progress deal version 928 thereby claiming the 500 sf from section 906, then in-progress deal 928 would need to be closed, reduced in size (to the remaining 1,500 sf linked to in executed lease deal 912), or for example, reconfigured such that its links are to space that is unclaimed. Such possibilities include a combination of the 1,500 sf remaining from lease deal 912, or 8,000 sf available from the executed lease deal 922, and 500 sf from the now-executed lease deal 930.

In the current form, when a lease deal version is changed to “executed” status, the user is prompted to update the lease links for other affected lease deals. This includes the ability to create a link to the soon-to-be executed lease deal. In other forms, the links may be updated manually without prompting, or they may be updated automatically such that links are shifted to reference the now-executed lease deal instead of the lease deals to which they were linked previously.

When all space associated with a previously executed lease deal or section has been claimed, the space is no longer visible in the space selection area 1208 (FIG. 12), and no other lease deals may link to it or make a claim on it. For example, if lease deal version 930 is executed, and therefore all space in section 906 is claimed, section 906 will no longer appear in the space selection area 1208. The space represented by the section is still available for selection for linking by lease deals. However, the section may no longer be linked to directly. Since all space within the section has been claimed by executed leases, these links, in one form, must be made to the executed leases. For example, after lease deal 930 is executed, then any other lease deal which may occupy the same 500 sf of space, must be linked to lease deal 930 now that section 906 is no longer available (since all space has been claimed). The cycle continues once executed leases claim all of the space of lease deal 930, then lease deal 930 will no longer be available for linking or claims by lease deals, and to occupy the same 500 sf, users may then link to or claim space from the executed leases which have claimed the space from lease deal 930.

In one form, reference leases are able to link to any executed lease regardless of claims on it by other lease deals. Closed lease deal version 920 is able to retain its links for comparison, but since it is a closed lease deal, it is unable to claim space and does not impact other links or claims. Reference lease 926 of yet another reference group Z illustrates that links still can be formed to executed lease deals by reference leases. Thus, the network 900 continues perpetually, and there is no limit to the time period or number of leases that may be part of the network.

By another minimal alternative, the system 10 may have lease deals linked to each other but where the first lease deal, such as an executed lease deal, does not claim leasable space in a property. It may be linked to space or otherwise assigned or associated with a space (such as an entire building where the space is assumed), but the system 10 does not show the section for claiming space on interface 1200 for example. In other words, the network could begin with the entry of lease deals 910, 912, without any links or claims on section 906, and additional lease deals such as lease deal 930 (also without any links or claims on section 906) could be added without restriction. Subsequent lease deals such as lease deal 922, and reference leases such as reference leases 914, 916, 918 could then be added to the network of leases.

### III. Detailed Operation

Referring to FIGS. 7 and 10, after a property file is created, a lease deal may be created and added to the property file. Property file 700 accepts lease deal data 706 and reference lease data 704, which may be added to the property file through a variety of interfaces and connections with external databases and programs. The create lease interface 1000 has a drop menu 1002 where a user may select a property 1004 and then select the type of lease to create, including a lease deal 1006 (which launches the lease deal interface (FIG. 12)), or reference lease which can be created by first selecting the listed reference group name (also referred to as budget) 1008. This launches the reference lease interface 1100 (FIG. 11). A user may also create a prior lease summary 1010 which is an abbreviated method of entering lease deal data for historical leases.

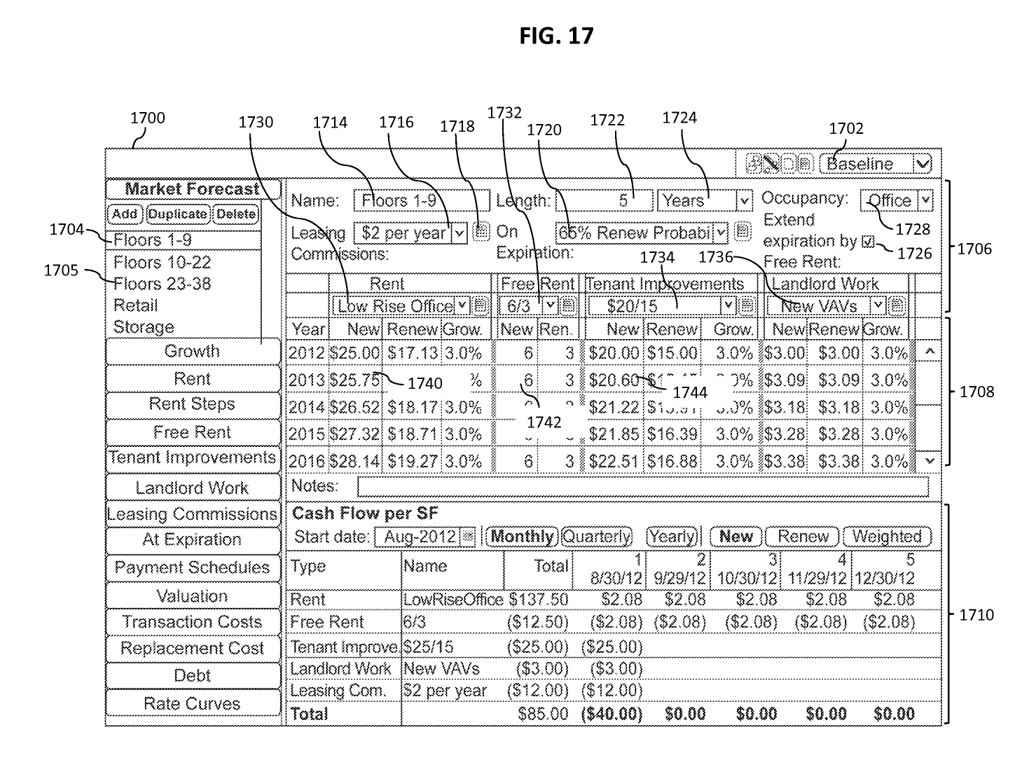

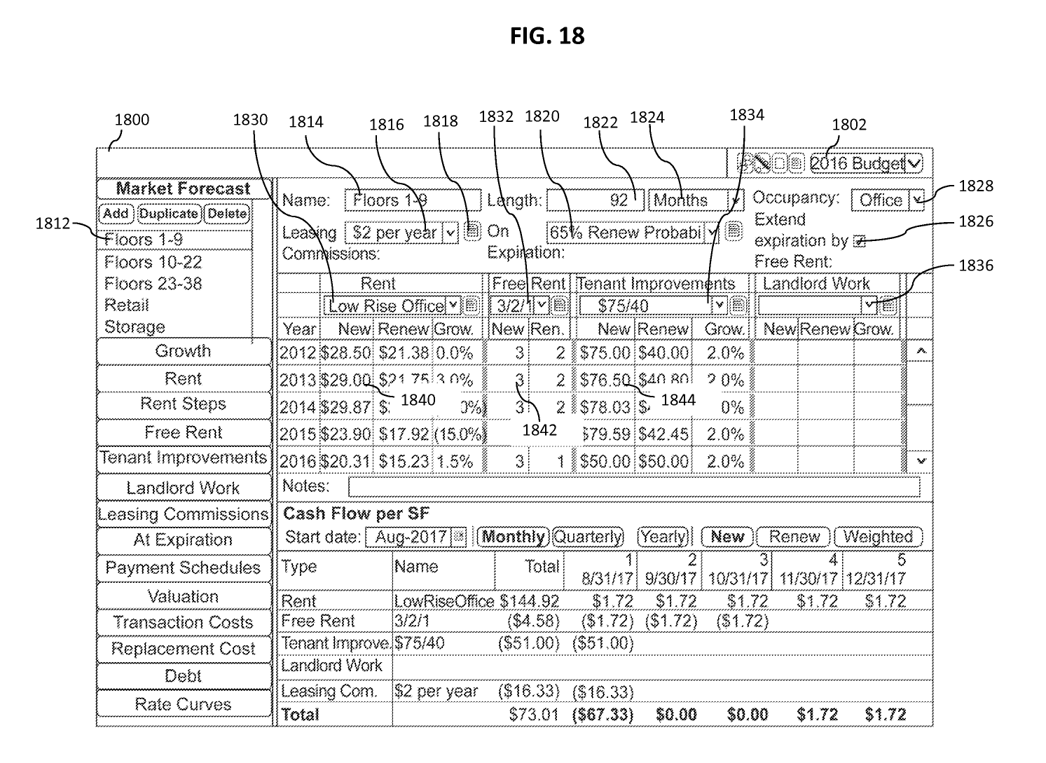

Referring to FIGS. 7 and 11, the illustrated property file 700 may also have reference lease data 704 input by a user through the reference lease interface 1100 to input data about a reference lease in a property such as a building. Alternatively, reference lease data 704 may be generated by either an internal or external application such as an accounting system, a budgeting system, or a comparable lease data database. The reference lease interface 1100 includes a lease identification section 1102 that includes various user input controls 1104-1112 for specifying general information about the lease. A user input control 1104 may specify a suite identifier (an alphanumeric identifier to identify a location in the building), a user input control 1106 to specify a reference lease's common name, a user input control 1108 to specify a discount rate used in certain calculations (for example, the net present value of a lease), a user input control 1110 to specify the type of lease (for example, a new lease, a renewal lease, a relocation lease, an expansion lease, an extension lease, or an option lease), a user input control 1112 to specify a space type which is defined by market forecast inputs explained below (FIG. 17 and FIG. 18). In other forms, a greater or lesser number of identifying elements may be specified.

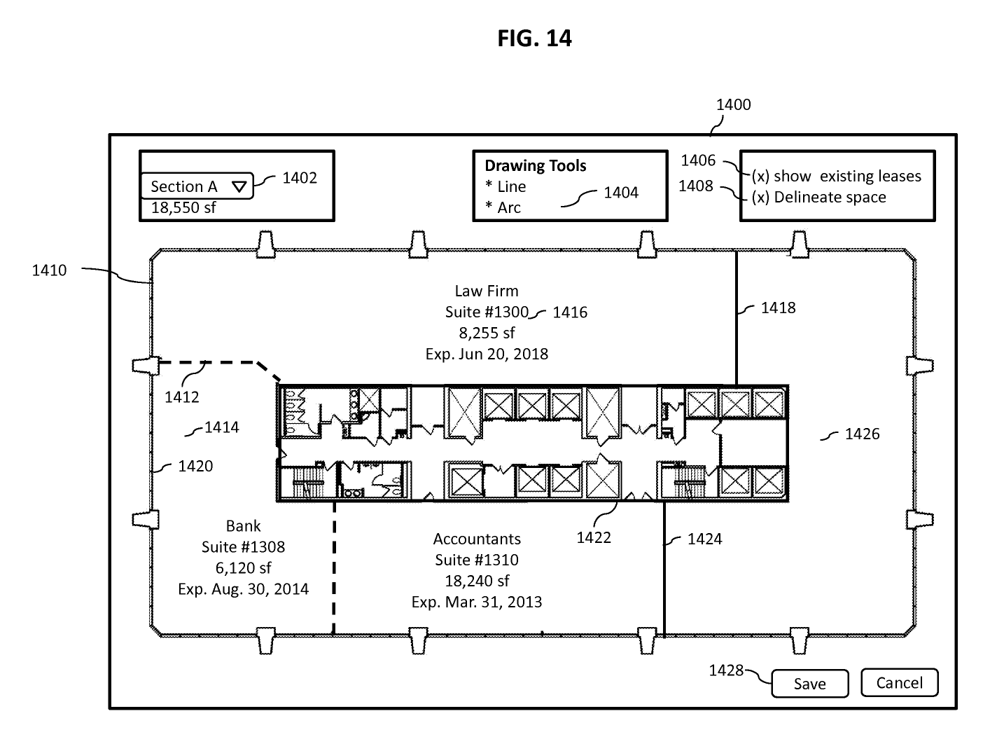

The reference lease interface 1100 also includes a space selection area (or lease linking area) 1114 that includes various user input controls 1116, 1122 used for linking a reference lease to space in the building. The illustrated user input controls include an expandable list 1116 of sections in the building, where each section contains a user selectable expansion control 1118 to view the available space within each section (which may include lease deals within the section as well as space within the section itself), a button 1120 to launch the visual linking interface (FIG. 14) described below, and a user input control 1122 that permits a user to select, allocate, or link a specific amount of space (in sf for example) to the lease. The expandable list of available space within each section, operated by the expansion control 1118 may include the suite number 1124 for a suite containing available space and the deal name 1126 for the suite containing available space. When the section itself contains available space, the program includes the space in the list and identifies it as section space 1128.

In other forms, an expandable list of all available space in the building may not be made available, and instead, a user can select from a list of sections in the building, and then select from available space from within the selected section, or all available space in the building may be listed without regard to sections. In one form, the available space displayed in the selection area 1114 of a reference lease interface 1100 is limited to space that has not been claimed by lease deals. In other forms, all space from all previously executed deals (regardless of claims made by other executed deals), and all space of the section itself may be made available.

Data about the linked space is shown in a display area 1130. This includes the space available 1132 from lease deals or within the section, which may be adjusted for the space selected in user control 1122, and the expiration date 1134 of the lease deals or space within the section. Display area 1130 may also include base rent 1136, expense reimbursements or recoveries 1138 (amounts paid by a tenant to the landlord to reimburse for the costs of operating the building), and the gross rent 1140 (base rent plus any additional rents such as recoveries) of the lease deal at its expiration. More or less parameters may be shown here. A total/average display 1142 is provided to summarize the selections from user controls 1116-1122, and a user input control 1144 is provided to specify, if necessary, a contractual area that is different than the space allocated to the lease. This occurs if a landlord agrees to financial terms of a lease that are based on a stipulated amount of space that is different than the actual space of the lease. An additional total/average display 1146 is provided which takes into account the contractual measurement entered in control 1144. The contractual measurement user input 1144 is automatically populated with the same value as the calculated total value of links above, but can be overridden with a different entry at a user's discretion.

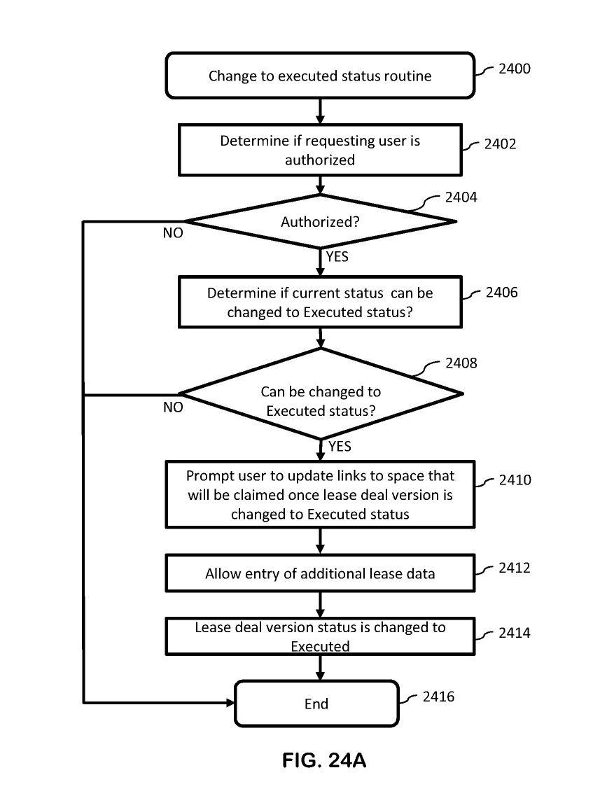

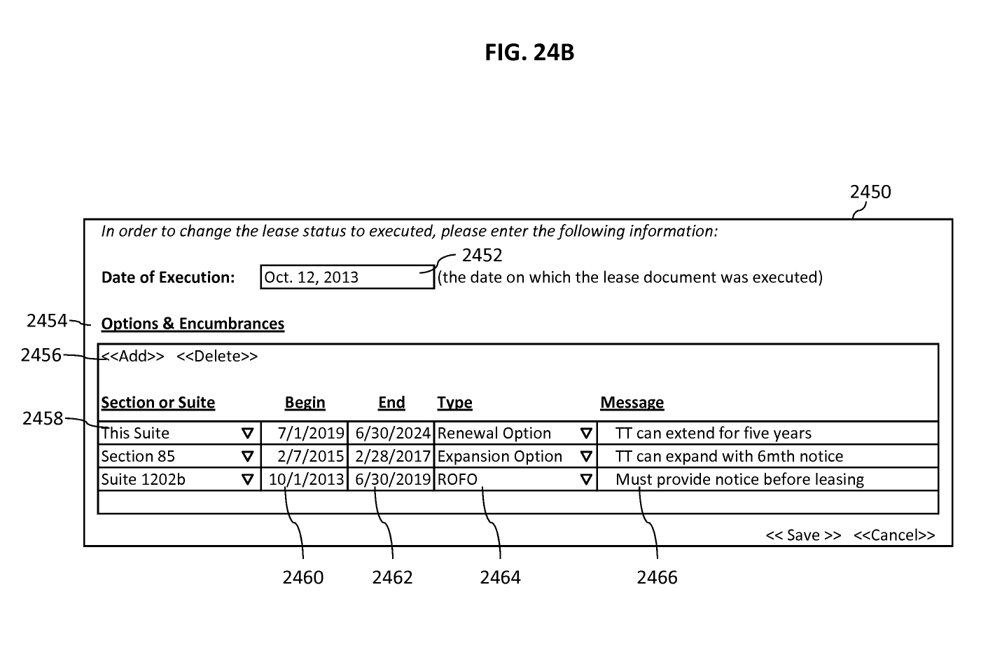

An additional feature of the space selection area 1114 is that after a lease deal is executed, additional information such as encumbrances and options included in the final lease may be added to the executed lease deal. Encumbrances can include items such as rights of first offer (ROFO) for any space within the section, or other sections as defined in the lease. Options can include such items as an option to renew the lease at expiration, or an option to lease additional space within the building at certain points in time. When these encumbrances and options are added to an executed lease, any reference lease or lease deal that then links to it will be warned of the encumbrance or option. For example, if an executed lease deal has an option to lease additional space within a section within a specified time range, whenever a user links a reference lease or a lease deal to the space within the section and the dates of the reference lease or lease deal overlap with the option dates from the executed lease, the user will be warned of the option and must acknowledge the conflict before completing the link. This helps avoid leasing conflicts within a building since space is often subject to encumbrances or options, and mistakes can be extremely costly if, for example, a tenant must be relocated to accommodate an option in another tenant's lease that was overlooked. This feature is described in greater detail below (FIG. 24B).

The reference lease interface 1100 also includes a detailed lease (or lease details) area 1148 to enter details of a reference lease (also known as a budget lease). The detailed lease area 1148 has a financial data input area 1150, and a date area 1160 for specifying the dates of the lease. For this date area, a user input control 1162 is provided to enter a start date, a control 1164 permits entry for the length of the lease in months, and a control 1166 allows for an end date. In this form, the user can enter data in any combination of two of the user input controls 1162, 1164, 1166, and the third variable is calculated automatically. In other forms, there may be different ways to establish the start and end dates of a lease.

Further, in this form, a user may select space allocation without restriction based on dates. If a user selects a start date that occurs before the latest expiration date of the space selected in the space selection area 1114, the user will be warned of the conflict, but will still be able to leave the conflicting dates in place for use in calculations. This may happen, for example, if a lease is terminated prior to its original expiration date, and a new lease is created to take over the space prior to the original expiration date. In other forms, this logic may be enforced in different ways, or not enforced at all. For example, the interface may only allow the input of a lease start date that occurs after the latest expiration date of the space selected in the space selection area 1114, or if dates are chosen first through controls similar to 1162, 1164, 1166, then the space selection area 1114 may restrict the available space to those that are available on or before the start date of the lease. The financial data input area 1150 also includes a user input control 1168 for specifying an expense reimbursement, also known as expense recovery, method for the lease. Most commercial leases have provisions where the tenant reimburses costs such as electricity and property tax in addition to the rent agreed to in the lease and this is captured through this input.

The financial data input area 1150 also includes a financial detail area 1170 where detailed financial information about a lease may be entered. Within this detail area 1170, a user input control 1176 is provided to allow the user to add and delete lease characteristics or elements 1178 such as rent, rent steps, free rent, tenant improvements, landlord work, and leasing commissions, for example, to the grid on financial detail area 1170. Lease elements are defined by the system administrator, and lease elements may easily be added or removed from the system. Some, or all of the lease elements defined for the financial data input controls may also be present in the library, as described below in FIG. 15. The detail area 1170 accepts multiple inputs of each type of lease element.

For each lease element 1178 included in financial detail area 1170 where detailed financial information is input, a user input control 1180 is provided to enter a start month for the cash flow relative to the lease start month (as entered or calculated in date input control 1162), and a control 1182 allows the entry of an absolute date for the cash flows to take effect. In this form, the user can enter data in either of the user input controls 1180 or 1182, and the other variable is calculated. In other forms, only the relative start month column 1180 or the absolute start date 1182 may be provided, or an additional column may be added to establish the end date for the cash flows associated with a lease element.

A lease element identifier 1184 also may be provided in the financial detail area 1170. In this aspect, lease elements may be selected and added through the use of the add lease elements control 1176. In other forms, lease elements may be selected in-place through a control such as a drop down menu. A control 1186 permits the user to specify either a direct (also known as manual) entry, or select corresponding data from the library 1502 (FIG. 15). For example, if an authorized user has established the leasing commissions “standard 10-yr,” “Dallas retail,” and “Temporary Incentive,” in the library 1502, a user entering a leasing commission data into area 1170 may, through control 1186, select to enter information directly or choose one of the leasing commissions that have been established in the library 1502. If a library sub-element is chosen, then the unit of measure (UOM) 1188, Quantity 1190, and other fields in the row are automatically populated with data from the library 1502 and are no longer editable. If however, a user chooses direct entry in control 1186, then the user may also utilize control 1188 to specify a UOM which corresponds with the lease element. For example, a rent element may have UOMs such as $ amount, $/sf/yr, or $/sf/mo, and a rent steps element may have UOMs such as % annually, % one time, or $/sf/yr annually. The user then uses control 1190 to enter a value for the lease element. In other forms, the control for selecting a library element 1186 may not be present, and it may be possible to select a library element through another control such as the UOM control 1188 which could easily be configured to contain both UOMs and library elements. Control 1176 may also provide the option to remove elements from the financial detail area 1170. The financial detail area 1170 also includes a cash flow and metric display area (also referred to as calculation results area) 1174 where the results of the inputs entered throughout the lease interface can be viewed. The cash flow and metric display area includes a user control 1192 to select cash flow, metrics or both for display. Such metrics may include net present value, net effective rent, total deal cost, and other common leasing metrics. A user control 1194 is used to designate the frequency of the periods displayed, while a user control 1196 is used to designate whether to present total values or values based on square area (for example, $1,000 of total rent would be shown as $10/sf for a 100 square foot lease).

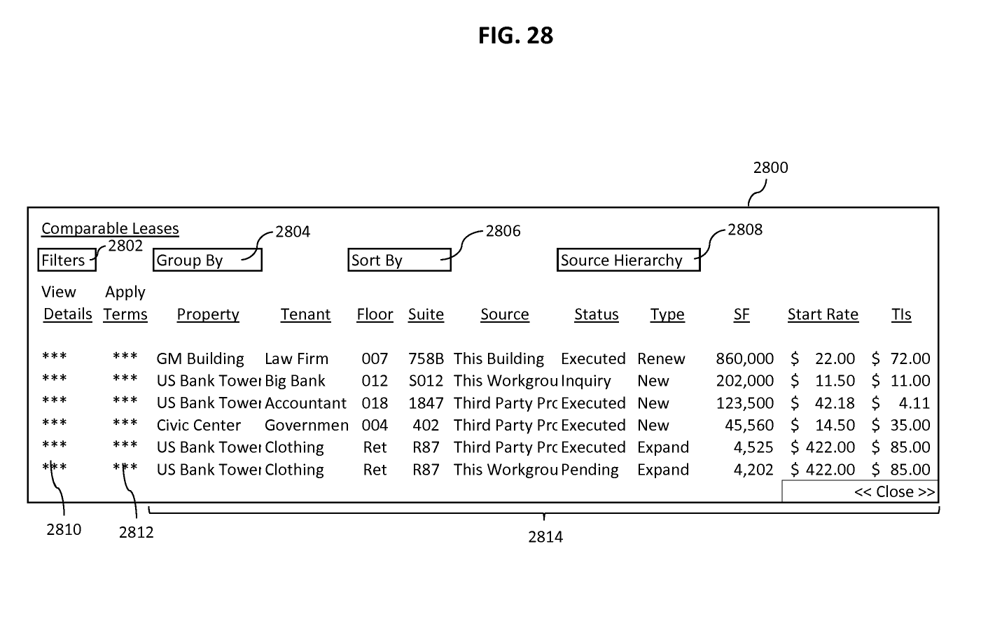

The detailed lease input area 1148 for financial and other data also contains a navigation tab 1152 so that the user may view comparable lease information in a format that lists or groups data of comparable leases by similar elements, parameters, or characteristics (or results of similar financial calculations) the same or similar to the comparison interface 2800 (FIG. 28). This permits the system 10 to apply comparable lease data to the reference lease displayed on interface 1100. A navigation tab 1156 permits the user to add and view attachments associated with the reference lease, while a navigation tab 1158 allows the user to enter and view notes associated with the reference lease.

Referring to FIGS. 11 and 14, the lease linking area 1114 contains a button 1120 to launch the visual linking interface 1400. The visual linking interface 1400 is an alternative input interface that can be used to populate fields on interface 1100 with data that would otherwise be input through controls 1116-1122 of the lease linking or selection area 1114. As data is input through the visual linking interface 1400, fields (or controls) in the space selection area 1114 are automatically updated with data resulting from a user's selection in the visual linking interface 1400. The visual linking interface 1400 includes an area 1402 where a user may select a section of property to view in the interface 1400 (which may be initially set to the section from which a user selected the visual interface button 1120, but can be changed to view other sections of the building), an area 1404 where a user may access drawing tools for use in the interface, a user selectable control 1408 which is activated when a user is delineating the boundaries of the floor plan, and a user control 1406 where the user can select whether to permit leases with available space to be visible. The visual linking interface 1400 also contains a floor plan 1410 of a property section, which is attached to the corresponding section listing at attachment control 808 on section interface 800 (FIG. 8) such that when a section is chosen by control 1402, the corresponding floor plan 1410 appears in interface 1400.

When a floor plan is attached through attachment control 808 (FIG. 8) and used in the visual linking interface, a user must first establish the boundaries of the floor plan. When a user opens the visual linking interface 1400 for the first time for a given section, a prompt 1408 is displayed to prompt the user to delineate the rentable space by first establishing boundaries on the floor plan. This is accomplished by using the drawing tools 1404 to draw lines and create a closed shape around the perimeter, and then identifying anything within the interior of the perimeter which does not count toward the lease space or area 806 (FIG. 8) entered in the section interface 800 (FIG. 8). The program automatically recognizes the drawing of the perimeter of the floor plan, and any closed object such as a rectangle within the boundaries of the perimeter is recognized as outside of rentable space. For example, if a user utilizes the drawing tools 1404 to establish the perimeter 1420 of the floor plan 1410, and also uses the drawing tools 1404 to identify that the core area 1422 is not part of the rentable space, then the delineated rentable area is the area inside of the perimeter 1420, excluding the core area 1422. The program then combines the area value 806 entered in the section interface 800 (FIG. 8) with the delineated area on the floor plan to determine the amount of area represented by each unit of area within the delineated space. For example, if the area value 806 entered in the section interface (FIG. 8) is 10,000 sf, this area is applied to the delineated rentable area that has been defined by the user for the section on interface 1400.

The combination of the area value and the delineated rentable area allows the program to determine any amount of area drawn within the floor plan 1410. When the delineate space control 1408 is disabled, the drawing tools 1404 can only be used within the delineated space. For example, if a user uses drawing tools 1404 to draw a line 1418 between the perimeter 1420 and the core 1422 and another line 1424 between the core 1422 and the perimeter 1420, the user creates a defined space 1426 within the section floor plan 1410 which represents a selection of space that is used for linking. A defined space is any closed object created with the drawing tools within the spaces delineated within the floor plan. In this case, the area of defined space 1426 can be calculated by the program based on the fraction of area the defined space covers as compared to the total delineated space of the floor plan 1410. For example, if the defined space 1426 is one fifth of the total delineated area of the floor plan 1410, then the defined space equals one fifth of 10,000 square feet or 2,000 square feet.

The visual linking interface 1400 remains visible while the primary lease selection area 1114 is also visible such that as a user uses the drawing tools 1404 to establish a defined space, the data for control 1122 is automatically input and data 1132-1146 are also calculated based on the selection in the visual linking interface 1400. For example, if the defined space included space from two executed leases and the section, the physical space (in square feet for example) may be selected for the two leases and the section by drawing lines on the visual linking input interface 1400. The defined spaces are then automatically populated at sf selected control 1122. In other forms, a visual linking interface 1400 may be provided on a standalone basis to fully replace the inputs in the space selection area 1114 (FIG. 11).

The visual linking input interface 1400 also includes a user input control 1406 which when selected shows the most recent executed leases with available space within the section. The area occupied by the executed leases, which also would have been entered through a visual linking interface 1400 associated with those leases, is shown with dashed lines 1412 which identify the defined spaces such as 1414 associated with previously executed lease deals that have occupied, or currently occupy the section. Information 1416 about the previously executed lease deals may also be displayed. If line 1424 were drawn such that it covered area of the defined space of lease 1414, then the portion of previously executed lease deal 1414 included within the defined space 1426 would populate the sf selected control 1122 for the row within the space selection area 1114 containing information about lease 1414. Even though the visual linking interface 1400 is used to input space selection data, the space selection area 1114 of the reference lease interface 1100 can still be used to enter data, and lease calculations may be made based off of the input data. Entering data through the space selection area 1114 alone, however, may not always provide sufficient information to update the visual linking interface 1400, for example, such as when the location of walls is necessary to define or understand the exact space.

Referring to FIGS. 7 and 12, the property file 700 may also contain lease deals 706. Lease deals are actual or possible deals for a property. For example, an actual lease deal is a contractual lease in place at a property where the tenant has or will occupy space within the property. Each constitutes a lease deal 706. Repeating from above, a possible lease deal may be one in negotiations with a potential tenant (also called a perspective, proposed, potential, or in-progress lease deal). The lease deal 706 may consist of a single version representing a single negotiation status for the lease deal. In one alternative form, a new lease deal may be created each time the status changes, and the current system 10 may be operated in this manner if a user so desires. Instead, however, additional versions may be added to the same lease deal (or for the same lease deal data). Each version may have an identifier that is unique within the deal. For example a deal may have versions 1, 2, and Law Firm, and another deal may have versions Law Firm, Bank, Accounting Firm, and Bank2. The lease deal input interface 1200 includes a lease identification area 1202 which is identical or similar to the lease identification area 1102 shown in FIG. 11, including controls such as an input or field 1204 to select the lease type and an input or field 1206 to select the space type. The lease deal interface 1200 also includes a space selection area 1208 which is also identical or similar to the space selection area 1114 (FIG. 11), including an expandable list of sections within the building with the ability to expand sections of the building through an expansion control 1212, an area selection control 1214, and a button 1216 to launch the visual linking interface (FIG. 14) which can be used to populate the fields in the space selection area 1208 as described above for reference interface 1100.

In addition to the lease identification area 1202, and the space selection area 1208, the lease deal input interface 1200 also includes a reference selection area 1210 (also known as budget, links, reference allocation, reference space identification, reference lease selection, or reference selection) input interface. The reference selection area 1210 consists of a user control 1218, where a user may select a reference group for display and data entry in area 1219. Area 1219 consists of a list of sections 1220 that is based on the sections a user has selected space for through the space allocation control 1214 in space allocation area 1208. For example, if a user has input data for sections “Floor 6” and “Floor 22” through space allocation input control 1214, then sections “Floor 6” and “Floor 22” will appear in the list of sections 1220 for reference linking. For each of these sections, reference leases associated with these sections and the reference group selected through the reference group display user control 1218 will be displayed. In one example, if a user creates a reference lease by selecting reference group “Q” through the new lease interface (FIG. 10), and the user enters “2248x” as the suite identifier for the new reference lease through suite identifier control 1104 (FIG. 11), and then the user allocates space to the reference lease from within section “Floor 22” through a space allocation user control 1122 (FIG. 11), then when a user selects a reference group “Q” through user control 1218, and has selected space from section “Floor 22” with user control 1214 such that it causes section “Floor 22” to be displayed in area 1219, the reference lease with suite identifier “2248x” will appear within the expandable list provided in area 1219.

If a user changes the reference group selection 1218, then reference leases associated with the newly selected reference group will be displayed along with any previously entered data for the reference leases associated with the lease deal. Similarly, if the selections of space change through the use of the space selection control 1214, then only leases associated with the specific combination of the sections and reference group will be displayed in data entry and review area 1219. Lease deals may be easily linked to multiple reference leases that are part of multiple reference groups. Changes that remove allocations of space within a section through control 1214, while allowable, will be discouraged through a warning message due to the need to remove and update the corresponding reference links.

As illustrated in the network 900 (FIG. 9), one aspect of the program is that lease deals may be linked to reference leases within multiple reference groups. This linking facilitates comparative reporting and analysis, for example, a lease deal and its versions can be compared to the assumptions in multiple reference groups. Multiple reference groups may be selected through the reference group selection control 1218 and data previously input for the lease deal will automatically be populated in area 1219. The reference selection area 1210 maximizes the use of screen space. If more space is available, the menu configuration can be changed easily to show multiple reference groups and associated reference leases in the same place at the same time. For example, rather than choosing a reference group through user control 1218, after selecting space within a section using control 1214 in space selection area 1208, a user can view a list of all reference leases associated with the chosen sections in reference selection area 1210 with, for example, headings such as “Reference Group 1” and “Reference Group 2.”

The reference selection area 1210 contains a list of sections 1220 that is populated based on the sections with space selected in the space selection area 1208. For example, if space is selected in sections “Floor A” and “Floor M” through the area selection control 1214 in the space allocation area 1208, then sections “Floor A” and “Floor M” will appear in the reference linking section list 1220. Each of these sections may be expanded through the expansion control 1222 to view a list of reference leases which each contain a suite identifier 1228, established in the suite identifier input 1104 (FIG. 11). A user may enter the amount of space within the suite the user wishes to link to through user input control 1224. Area 1230 displays summary data associated with the reference leases and area 1232 displays total, average, and weighted average metrics based on the selections made in controls 1218, 1222, and 1224. Alternatively, this information may be entered through a visual linking interface (FIG. 14), launched through button 1226.

The lease deal input interface 1200 also contains lease deal detail area 1234, which contains a versions tab 1236 which, when selected, displays a summary of lease deal versions in area 1248, and allows a user to select a lease deal version for viewing and editing in a lease deal version input interface 1300 (FIG. 13). The versions tab 1236 also contains buttons 1246 for creating and deleting versions. These buttons 1246 are enabled if the approval system described below is not enabled. When approvals are enabled, additional versions may only be added through the approval interface instead. The lease deal detail area 1234 also contains a lease comps tab 1238 which displays comparable lease deals in a format the same or similar to that shown in comparable lease interface 2800 (FIG. 28) based on inputs in the space selection area 1208. A contacts tab 1240 is provided for managing contacts associated with the lease deal, an attachments tab 1242 provides for managing attachments associated with the lease deal, and a notes tab 1244 provides for editing and storing notes associated with the lease deal. Lease deal versions created through the lease deal input interface 1200 each utilize data such as the data input in suite data area 1202, the lease links input in space selection area 1208, and the budget or reference links input in reference selection area 1210.

Each version can contain a different set of assumptions for what will happen to the space identified through input areas 1202, 1208, and 1210. For example, a lease deal may be created for tenant “Law Firm” and then lease deal versions are created for each set of assumptions created throughout the negotiation process with, for example, one for initial negotiations, one after a tenant requests changes to the initially negotiated terms, an additional version as negotiations progress, and so on. Lease deals typically require one or more financial terms to change over the course of negotiation, and versions can be created to track these changes throughout the negotiation. Versions may also be created for any other purpose as a user sees fit. For example, if negotiations were ongoing with two tenants for the same exact space, a user could simply create a deal representing the space and then create a version for each potential tenant (rather than create a different deal for each tenant). In an alternative form where only one lease deal version is permitted, the version area 1248 will provide for inputs as shown in the deal version input interface 1300 (FIG. 13) as described below, so that there is no longer an ability to select a version of the lease deal and that the single financial and other details contained in the lease deal version input interface 1300 (FIG. 13) are available when tab 1236 (which would be renamed as “details”) is selected. Thus, the concept of lease deal versions would be invisible to the user, and the one version would simply be part of the lease deal. Otherwise, all features of the current system are able to function when only a single lease deal version is allowed as described above. In one form, the only change required to implement a restriction of a single deal version per lease deal would be the user interface update described above.

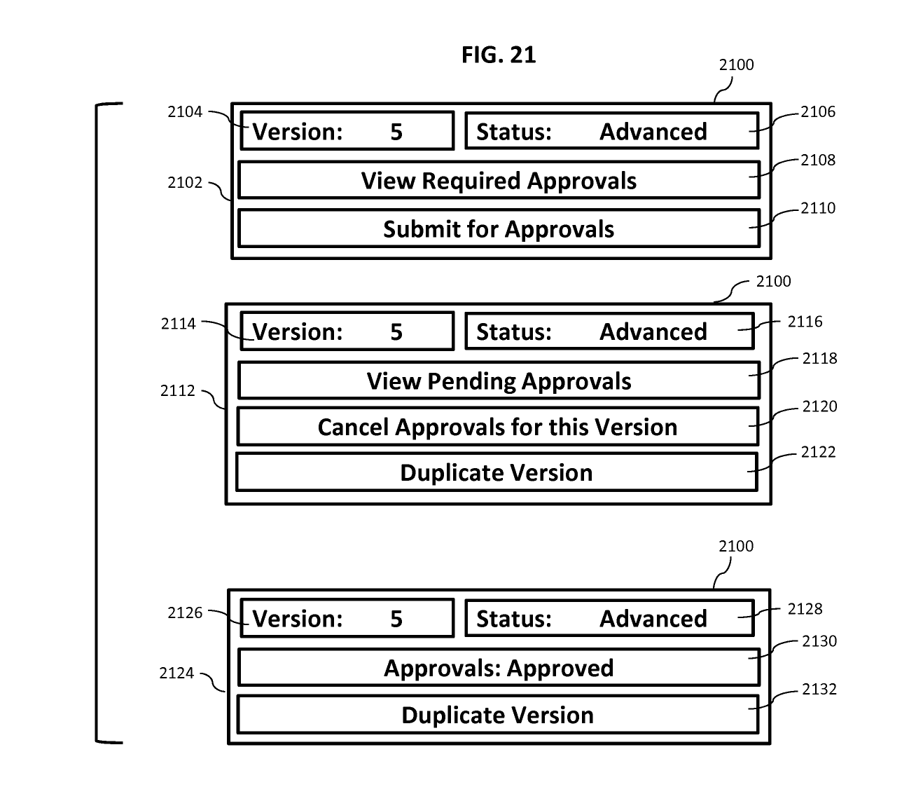

Referring to FIGS. 12 and 13, the lease deal version input interface 1300 may be launched through the selection of a lease deal version in the lease deal version summary area 1248 of the lease deal input interface 1200 (FIG. 12). The lease deal version input interface (FIG. 13) consists of a version/status/approval area 1302, which consists of a user input 1304 for accepting a version identifier which is used to identify the version within the lease deal, and a user input 1306 for selecting a lease deal version status. The illustrated button configuration for the version/status/approval area 1302 is as a user would see it if approval features are not enabled for a property. When approval features are enabled, the configuration and function of the buttons in the version/status/approval area 1302 changes and additional buttons are added in area 1308, as illustrated in FIG. 21. The lease deal version input interface 1300 also has a date input area 1310 with identical or similar functionality to the date inputs 1162, 1164, and 1166 (FIG. 11), and expense reimbursement input 1312, which is identical or similar to input 1168 (FIG. 11). However, here, the expense reimbursement input illustrates a different style of input known as “Base Year” which requires an additional input 1314 to establish the base year value. A base year is a common expense style reimbursement where a tenant only reimburses expenses over the expenses of a base year, such as the year in which they took occupancy of a leased space. As an example, if the base year amount is $10.00 per square foot, and the actual expenses of operating the building for a year are $12.50, then the tenant reimburses the landlord $2.50 per square foot for expense reimbursement.

The lease deal version input interface 1300 also contains a button 1316 to launch a comparable lease interface (FIG. 28), where comparable leases can be displayed based on property, lease deal, and lease deal version characteristics, and a financial detail input area 1318, which is functionally identical or similar to the detailed financial input and display interface 1170 (FIG. 11). Buttons 1320 and 1322 are also provided for respectively saving and canceling the data input through the lease deal version interface 1300. These buttons 1320 and 1322 are provided whenever the interface contains unsaved data. In some instances, when approvals are enabled, data within a version is saved and locked to prevent future editing, when this is the case, buttons 1320 and 1322 are replaced by a single “close” button. Inputs and displays on the lease deal interface 1200 (FIG. 12) and the lease deal version interface 1300 (FIG. 13) are interchangeable such that a system administrator may configure the interfaces in a variety of ways where data common to multiple versions is contained in the lease deal interface 1200 (FIG. 12) and data specific to a lease deal version is contained in the lease deal version interface 1300 (FIG. 13). For example, a system administrator may move inputs contained in the lease identification area 1202 (FIG. 12) to the lease deal version interface 1300 (FIG. 13), or may move the date inputs 1310 (FIG. 13) to the lease deal interface 1200 (FIG. 12). There are many possible configurations.

To summarize the linking of lease deals and reference leases, a general linking process 1250 is described (FIG. 12A). Referring to FIGS. 12 and 12A, in order to benefit from space continuity features 708 (FIG. 7), lease deals must be linked to available space provided by previously executed lease deals or by unclaimed space of a property (such as a section with unclaimed space). The expectation is that the lease deal will eventually claim the space once executed. In this case, the lease deals cannot link to space already claimed by another executed lease deal. An override option may be provided on interface 1200 for example to permit a lease deal to link to any space or previous lease deal if it is only for reference similar to forming a separate reference lease. Reference leases have no such limitation and can link to any previously executed lease deal, or unclaimed space. In one form, the interface limits the space that a reference lease can be linked to using the same rules as a lease deal, where only unclaimed space may be linked to. This restriction is solely to improve the appearance of the user interface, and is not a requirement to operate the program. A user uses the lease deal input interface 1200 (FIG. 12) to input information about a lease deal and to enter linking information. First, a user selects 1252 a section of the building through, for example, the expansion control 1212 in space selection area 1208. Next, the user selects 1254 available space through the use of the linking controls in space selection area 1208 and selects space through the space selection input control 1214. If the user selects a lease (or section of the building) to link to that has options or encumbrances (such as those entered through an option and encumbrance interface (FIG. 24B), the user is warned 1256 of the options or encumbrances attached to the lease or section of the building. If the user wants to link to more available space 1258, then the user returns to step 1252 to select other sections of the building if desired.

Once the user determines 1258 that no additional available spaces should to be linked to, then the user determines 1260 if any reference leases should be linked to. If the user determines 1260 that reference leases should be linked to, then the user first selects 1262 a reference group, through, for example, a reference group selection user control 1218. The user may then select a section of the building 1264 by using the expansion control 1222 and then enter 1266 an amount of space or area to link to through the area input user control 1224 for each reference lease listed. If the user determines 1268 that additional reference leases should be linked to, the user can return to step 1262 where the user may select a different reference group, or leave the reference group selection unchanged. If the user determines 1268 that no further reference leases should be linked to for the subject lease deal, or if the user determines 1268 that no reference leases should be linked to, then the linking procedure ends 1270 and the user may enter lease data through, for example lease detail area 1234. Users may also utilize a visual linking interface (FIG. 14) for both links to available space and/or links to reference leases.

### Library and Forecast Data

Referring to FIGS. 7, 15 and 16, in an alternative aspect, a property file 700 may also contain library data 710 and forecast data 712 directly in the property file, or indirectly through a reference or link to library data associated with a workgroup or user. A property file can function without library data and without forecast data except that directly associated features such as being able to compare a lease to a forecast lease will not be available. Generally, a library 1502 (FIG. 15) serves at least two purposes. First, it may be a central place to enter property data that is used multiple times throughout the system 10 to limit the need for repetitive entry of data. For example, rather than directly inputting data for a leasing commission for each lease into a property file, the user can elect to enter the data once into library 1502. Then, users with access to the library 1502 through a property file 700 linked to the library 1502 may point lease inputs such as the library selection control 1186 in the reference lease input interface 1100 (FIG. 11), or the corresponding control in the lease deal version input 1300 (FIG. 13) to the library data. Both lease deals and reference leases can access library data. Second, the library 1502 may be used to create market forecasts, also known as space types, which can be used to compare lease deals and reference leases to a set of assumptions which comprise market terms for leases. Library data may also be used for simplified comparisons to a single element such as rent (so that the rent in a lease may be compared to the rent in the library). The input of data may be performed by the property administrator, workgroup administrator, or any authorized user with access to the property file 700.

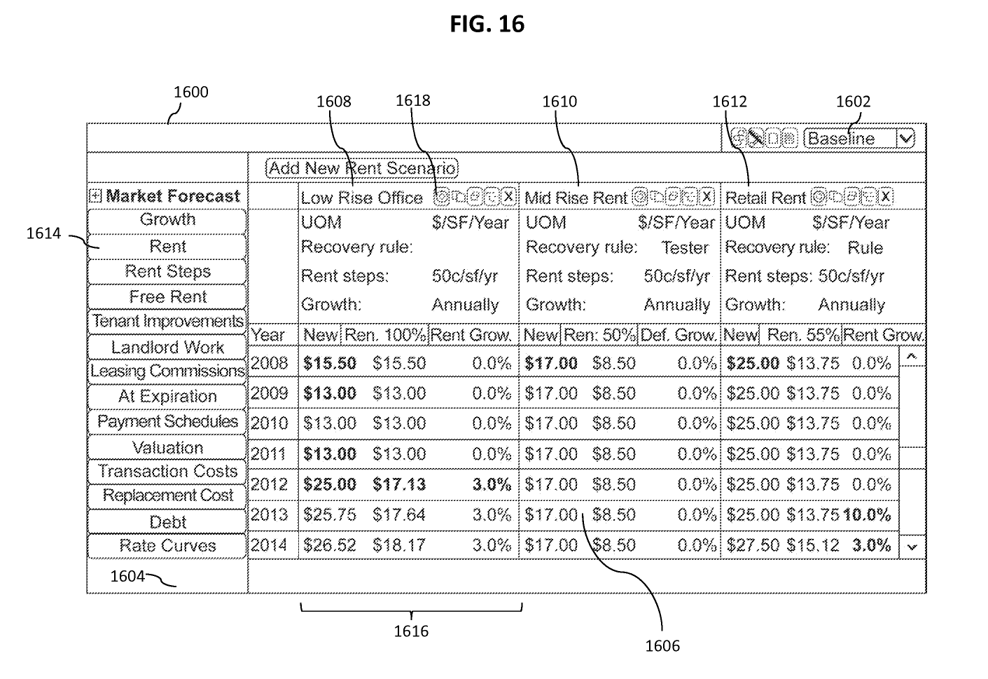

To accomplish this, each library 1502 controlled by library manager 400 (FIG. 4), has one or more library layers controlled by a library layer manager 402. The library layers include at least one base or baseline layer 1504 (also referred to as the baseline) managed by a baseline library manager 404 (FIG. 4). The baseline layer defines the default values for each separate library element (or main categories of property data) 1614. These elements 1614 may include, for example, rent, rent steps, tenant improvements, lease commission paid for obtaining tenants, free rent periods provided to tenants, landlord work, payment schedules, growth assumptions, and next lease which contains assumptions about the probability of a tenant renewing its lease. These elements 1614 are provided as options to the user from a list on a user library interface 1600 (FIG. 16) described in greater detail below. Each of these elements 1614 may have its own library module or manager 406-412, 414, 416, 418, 420, 422, 424-430. The library elements 1614 are defined by the program, may be consistent across one library or multiple libraries managed by the system 10, and may be updated by the system administrator so that there are a greater or lesser number of elements available in libraries throughout the system.

Each of the elements 1614 may also have sub-elements 1608-1612. For example, under rent, there may be sub-elements of storage rent, low rise rent, high rise rent, and retail rent, to name a few examples. These sub-elements may be user defined.

Each sub-element 1608-1612 consists of a set of assumptions. For example, if a sub-element lists rents by the year such as a rent value for each of year 1, year 2, year 3, and so forth, each year accepts data (which may be directly entered, imported, or may be calculated by the system). Sub-elements may also accept data for a single time period, such as next month, and may also accept values for a different parameter than time. Sub-elements may also accept a combination of data. For example, a rent sub-element may accept periodic rent data, periodic rent growth data, rent step data (increases under an actual or projected lease), and multiple other data that collectively provide inputs for rent and other aspects of a lease calculations. Many other examples exist.

An example of three different rent sub-elements is shown on area 1606 of FIG. 16. Thus, each library element can have multiple sub-elements so that each baseline layer 1504 may have multiple elements, each of which may contain multiple sub-elements for example.

In the illustrated form, when a reference group is created, a corresponding library layer known as a reference layer, or budget layer (also known as a forecast layer or reference forecast when forecast data is present) 1506, 1508, is created in the library, which allows variations versus the baseline. For this reason, the library data is typically associated with the same data level (property, workgroup, or user) as the reference groups. For example, if reference groups are defined at the property level, then the library and corresponding layers are typically associated at the same level since a corresponding library layer is created for each reference group. In other words, the property level means that the data of the baseline layer and reference layers are available for comparison to reference leases within that property. Layers at the workgroup level would be available for multiple properties linked to the workgroup, and so forth.

Values can vary between each of the library layers 1504, 1506, and 1508. For example, a user may enter $10 as the 2014 rent in the baseline layer for the sub-element “high-rise rent” compared to $8 in a reference layer corresponding to a reference group for “2012 budget” and $12 in a reference layer corresponding to a reference group for “Original Underwriting.”

In the current form, a reference layer is associated with the creation of a reference group. In other forms, additional library layers, such as reference layers can be added through other ways such as simply adding a control to the library that allows the creation of additional layers which can still be associated with lease deals and reference leases through the use of the space type identifier (control 1112 on interface 1100 (FIG. 11 for example)). Further, though the association of reference leases and reference layers with a reference group can be beneficial, there is no requirement that both reference leases and reference layers be part of a reference group. In one alternative, the application 44 is able to fully function without reference leases and without reference layers. For example, the property file 700 may contain (1) reference leases 704 and forecast data and features 712, (2) just reference leases 704, (3) just forecast data and features 712, or (4) neither reference leases 704 nor forecast data and features 712. It is understood, omitting or limiting the entry of data for either reference leases 704 or forecast data and features 712 disables the associated interface features and reporting features.

A reference layer such as 1506 or 1508 is any library layer other than the baseline layer 1504. The reference layer such as 1506 or 1508 appears to the user as a duplicate of the baseline library layer 1504, where different assumptions may be entered, imported, or calculated. An illustration of a forecast on a baseline layer 1504 is shown in FIG. 17 and an illustration of a corresponding forecast on a reference layer such as 1506 or 1508 is shown in FIG. 18. There is no limitation on the number of reference groups or reference layers that may be created within the program. Reference layers make it possible to perform lease and property calculations based on different sets of assumptions for elements and sub-elements entered in the library. These layers can also be toggled in and out of, or compared side-by-side in, reports and displays so that the user can view the impact on cash flow, occupancy, and other key variables. For example, a user can, at the same time, and in the same place, compare reference leases and lease deals to inputs and calculations from a reference group named “2011 reforecast” as well as another reference group named “2014 budget.”

In one form, all sub-elements are defined in the baseline layer in order to maintain consistent naming of sub-elements, limit or eliminate the need to duplicate data entry, and to limit the probability of mistakes. In other forms, it may be possible to add new sub-elements to reference layers first which are then copied directly to other reference layers and/or to a base layer.

In one form, only the baseline library data 1504 can be accessed for lease deal and reference lease calculations, through the detailed input interface 1200 and 1300 for lease deals FIGS. 12-13 and interface 1100 for reference leases (FIG. 11), while other layers are used primarily for the generation of forecast comparison data. For example, if a user uses a library sub-element selection control 1186 in the reference lease input interface 1100 (FIG. 11), the data provided will be from the baseline layer, regardless of any other available reference layers. In other forms, an authorized user may designate a library layer (baseline or a reference layer) as the source for lease level data for lease deals or reference leases and accessed through the detailed input interfaces 1100, 1200, 1300 (FIGS. 11-13). For example, if an authorized user designates the reference layer “2018 Budget” as the source for lease level data, and if a user uses a library sub-element selection control 1186 in the reference lease input interface 1100 (FIG. 11), the data provided will be from the “2018 Budget” layer.

It should be appreciated that generally the set of data within a baseline or reference layer may not necessarily be limited to a single particular element or sub-element unless otherwise stated. Thus, layers with the same library may provide values for different elements or sub-elements. For example, a particular layer may provide a set of assumptions including some values for rent, some values for tenant improvements, and some values for leasing commissions, and this particular situation created by this set of assumptions may be used to create a reference forecast.

Each lease deal, through the space type selection control 1206 (FIG. 12) or reference lease through a space type selection control 1112 (FIG. 11) can be designated as a specific space type, which is selected from a list of market forecasts present in the library. For example, the lease identification area 1202 on the lease deal input interface 1200 (FIG. 12) may designate the leased space type under the deal as “Retail” through the use of the space type selection control 1206 (FIG. 12). This retail lease is represented by lease 1510 (FIG. 15). The space type designation allows the program to compare lease deal 1510 data to the “Retail” forecast assumptions on various layers of the library. For example, the inputs and calculations associated with lease deal 1510 can quickly be compared to the “Retail” forecast across multiple layers of the library, making it possible, for example, to compare a lease deal 1510 input through the lease deal interface (FIG. 12) and lease deal version interface (FIG. 13) to (1) the baseline 1504 which might represent the original underwriting of the property, (2) a reference layer 1506, which might represent the 2012 budget for the property, and (3) a reference layer 1508, which might represent the 2018 budget for the property. A separate lease deal 1512 is also illustrated. Lease deal 1512 has been designated as space type “Flrs 13-25” by use of a space type selection control such as the control 1112 (FIG. 11) or the control 1206 (FIG. 12), which makes it possible to compare the lease 1512 to the corresponding forecasts within reference layers for this space type.

Libraries are also a gateway for external data. Through API 34, library 1502 can be used to import/export data (including real time updates from external sources of market data). For example, a user can import data from third party data providers to update library data, including layers and forecasts explained herein. Other programs in the system 10 or external data providers or outside sources 1550 (FIG. 15) also can be given authorization to access the system and download property data to the library as well as download property data from the library. This data may then, for example, be aggregated, to calculate expected rents for a given property type or market. It will also be understood, that the library layer structure is designed to save space within the database. In other forms, library data may be duplicated multiple times. For example, data on the baseline 1504 may be duplicated for each library layer 1506 and 1508 rather than creating library layers, effectively providing the same data that may be accessed through the use of multiple layers. It will also be understood that a comparison does not need to be made against an entire forecast lease and that the library contains enough data for a lease deal or reference lease to be compared against a variety of data for the elements of the library (such as leasing commissions, tenant improvements, rent, and free rent)

Referring to FIG. 15 and FIG. 16, a user may use the library interface 1600 to create, delete, enter and view library element, sub-element, and assumption data, such as that contained within the library 1502. The library interface 1600 may include a layer area, control, or menu 1602 for a user to select and edit a library layer, such as the baseline layer 1504 or reference layer 1506, 1508, and a side menu or other area 1604 that lists library elements 1614 that can be selected by a user. A screen area 1606 may be used for creating and displaying sub-elements, and here example sub-elements 1608, 1610, and 1612, for a selected library element 1614.

In the illustrated example, the main element or category is rent which is consistent across all libraries, and the sub-element of low rise, mid-rise, or retail rent are user defined within the library. Each sub-element also has a list of entries or a set of assumptions 1616 that are either populated automatically, for example from a third party data provider, or manually entered by a user. In this example, the sub-element user interface 1608, 1610, 1612 includes a button 1618 which enables editing of sub-element and assumption data, and additional buttons for common functions such as deleting or changing the order of the sub-elements. The sub-elements 1608, 1610, 1612 edited in this example interface 1600 may be made available for calculations to: the forecast interface 1700 (FIG. 17) and other layers of the forecast interface 1800 (FIG. 18), both of which are also part of the library, the lease deal version interface 1300 (FIG. 13), and/or the reference lease interface 1100 (FIG. 11), as well as a variety of calculations throughout the program. In other forms, there may also be additional elements (such as percentage rent or ancillary revenue), or fewer elements.

Referring now to FIG. 17, the system 10 provides for the creation of a forecast lease by using a forecast interface 1700 and operated by a market forecast manager or other program component 418. The forecast lease, forecast file, or simply forecast is part of a library, but are somewhat different than library elements and sub-elements. A forecast includes a collection of the library sub-elements, and a few directly entered items where, in one form, the values are based on at least one or more assumptions about a type of lease space, rather than a single specific lease space. For example, a user may create a forecast for “office floors 10-18”. To do this, the user selects a rent sub-element, a tenant improvement sub-element, a leasing commission sub-element, and so forth. Sub-elements may also be created and edited within the forecast interface 1700. This collection of data is used to forecast lease cash flows, occupancy, and other metrics, or in other words to generate “forecast leases”. Forecast leases can be used for comparison against lease deal versions, reference leases, and other forecast leases.

Forecast leases can also be used to generate hypothetical leases for lease deal versions and reference leases. For example, rather than enter a reference lease starting in the year 2020, a user may simply choose to have a lease generated by a forecast lease based on information input through the forecast interface 1700. Since forecasts are part of the library, all of the features such as reference layers also work for the forecast. For example, a user may create a “Baseline” layer for “office floors 10-18” and may also create additional reference layers, each of which may contain different sub-elements and other data for forecast “office floors 10-18.”

A user may enter and view market forecast data on the forecast interface 1700. This may be accomplished by the user entering specific values (such as rent values), a certain growth % so that the resulting values are calculated for example, or automatic population of these items by an internal or external program that has financial data for creating a prediction of values in light of actual and predicted market conditions.

The forecast is largely a compilation of other library sub-elements, which, when combined, provide sufficient data to generate a hypothetical lease. In the present form, users can create and edit library sub-elements through the forecast interface 1700. Users may also access library elements and sub-elements independently of the market forecast. For example, users may create and edit rent sub-elements outside of the market forecast. This is not a requirement, and the program can be easily modified to hide direct access to elements such as rent, rent steps, and free rent. Instead, users may create and edit element and sub-element data directly through the market forecast interface 1700 such that, from a user's perspective, there is a market forecast interface, complete with the ability to select different layers, but no other library data is visible.

The example market forecast interface 1700 includes a section, control, or menu 1702 for a user to select and edit a library layer, a section, control, or menu 1704 for a user to add, delete, and select market forecasts, and a sub-element selection area 1706 for a user to select library sub-elements, such as rent 1730, leasing commissions 1716, free rent 1732, next lease (which may also be referred to as on expiration) 1720, tenant improvements 1734, and landlord work 1736, to use in the forecast. In each location where sub-element data can be selected in section 1706, a control, such as control 1718 is also provided to edit sub-elements in place. Sub-elements may also be created, or deleted through their individual controls 1730, 1716, 1732, 1720, 1734, and 1736 by, for example, selecting a “create new” option within the list that appears when the control is activated. Sub-elements may also be deleted by selecting them from the list when the control is activated and then selecting a “delete” icon that appears near the sub-element. The ability to create, edit, and delete sub-elements from within the forecast interface makes it possible for the forecast interface to offer full forecast functionality without a separate library interface 1600 (FIG. 16)

Sub-element selection area 1706 may also be used to enter additional information such as the name 1714 of the forecast, the length of the leases generated in the forecast 1722, 1724, and the ability to select an option through control 1726 to extend forecast leases by the length of free rent provided under the forecast lease, and the occupancy 1728 of the space (office, retail, industrial, mixed-use, for example). A summary area 1708 on the forecast interface 1700 displays summarized results of the selections and entries made in sub-element selection area 1706 including the calculated assumptions and financial data for forecast leases. Though the summary area 1708 displays annual data, some data may change on a monthly basis. For example rents may grow at one time over the course of a year, or they may grow periodically throughout the year, and the user inputs in the library interface support these detailed entries. The forecast interface 1700 also has an area 1710 where the user can select a specific date and view detailed results of the selections and entries made in area 1706.

Once a forecast or forecast lease is formed, it can be selected as a space type in the lease deal interface 1200 through the use of the space type selection control 1206 (FIG. 12) or as a space type in the reference lease interface 1100 through the use of the space type selection control 1112 (FIG. 11) and used for reference calculations and metrics. For example, if a lease deal version is entered in the lease deal interface 1200 (FIG. 12), and the space is identified as market forecast “Floors 23-38” through the space type selector 1206 (FIG. 12), and the “Lease Type” control 1204 (FIG. 12) is set to “New” then all versions of the lease deal can be compared to the new lease data of the “Floors 23-38” forecast 1705 throughout different layers of the library. Comparisons are typically made based on the start date of the lease. For example, if a lease deal version commences on Aug. 1, 2018, then it can be compared to a lease generated by the forecast that begins on the same date that corresponds the lease type selected (ex: new, renew, extend, expand, option). New and renew leases have inputs within the library 1600 and forecast 1700 interfaces. Extension and option lease types are also considered renewals and use the renew data. The expand lease type uses data for new leases. In other forms, the library and forecast may be configured to accept data for the extension, option, and expand lease types. The same logic can be applied both to lease deals and reference leases. The forecast interface contains sufficient information to generate leases for any start date, and contains sufficient data to generate leases for perpetuity (the last hardcoded value is repeated perpetually, so that, for example, if the last hardcoded rent growth value is 3%, rent will grow at a 3% annual rate for perpetuity). For example, a forecast lease ending after five years as a result of entries in controls 1722 and 1724 contains information about what will happen to the forecast lease upon expiration through control 1720, which may include the generation of a new forecast lease based upon using forecast data at the time of expiration. Referring now to FIGS. 15-18, FIG. 18 illustrates the same forecast interface 1800 as FIG. 17 with forecast “Floors 1-9” 1812 selected. However, a reference layer 1506, 1508 from the same library 1502 is selected instead of baseline layer 1504 as shown in FIG. 17, through the use of the library layer selection control 1802. As discussed previously, the name 1814 of the forecast remains the same to enable the space type selection 1206 (FIG. 12), and 1112 (FIG. 11) in the lease deal and reference lease input interfaces to identify the same forecast name for comparison throughout different library layers.

With library reference layers, inputs for the forecast other than the name may be changed. In the illustrated example, many assumptions are different between the baseline (shown on FIG. 17), and reference layer (shown on FIG. 18), including, different free rent selections 1732, 1832, different lease lengths 1722, 1724, 1822, 1824, different tenant improvements 1734, 1834, and different landlord work 1736, 1836. Selections of library sub-elements for rent 1730, 1830, leasing commissions 1716, 1816, on expiration 1720, 1820, extension of expiration by free rent 1726, 1826 and occupancy 1728, 1828 are identical between the baseline 1505 and reference layer 1506 or 1508. The rent selection 1730 contains a sub-element with an identical name “Low Rise Office”, but since the sub element data is also on a different layer of the library (the same as the forecast), the values may be different. In the illustrated example, “Low Rise Office” rent 1730 on the baseline layer 1702 has different values than the “Low Rise Rent” rent 1830 on the “2016 budget” layer 1802. Control 1818, and others like it, is provided to allow in-place editing of sub-element data for the currently selected library layer 1802.

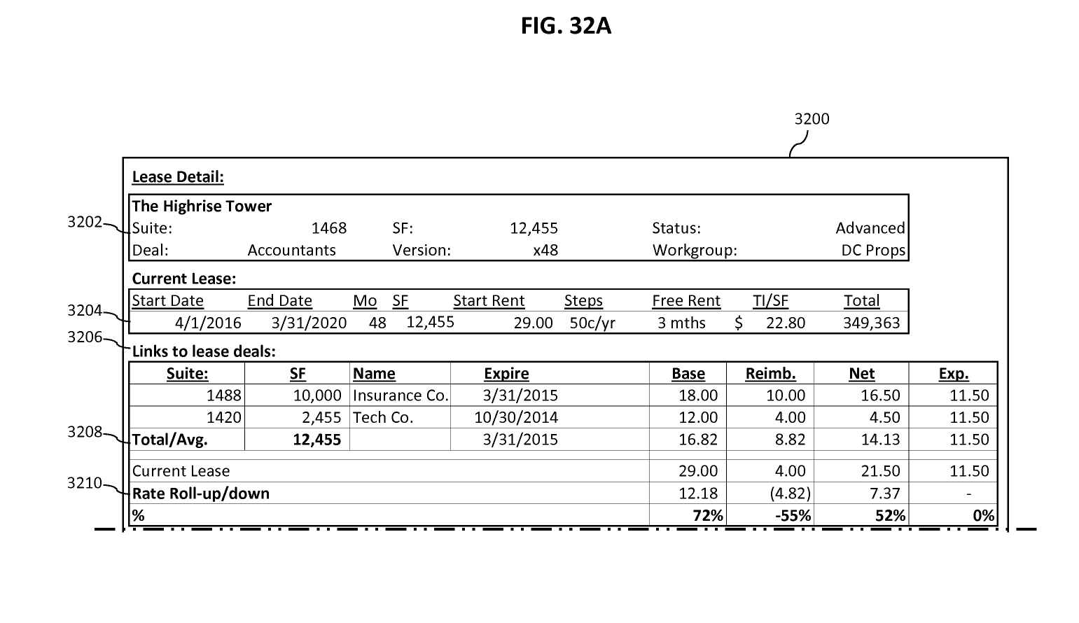

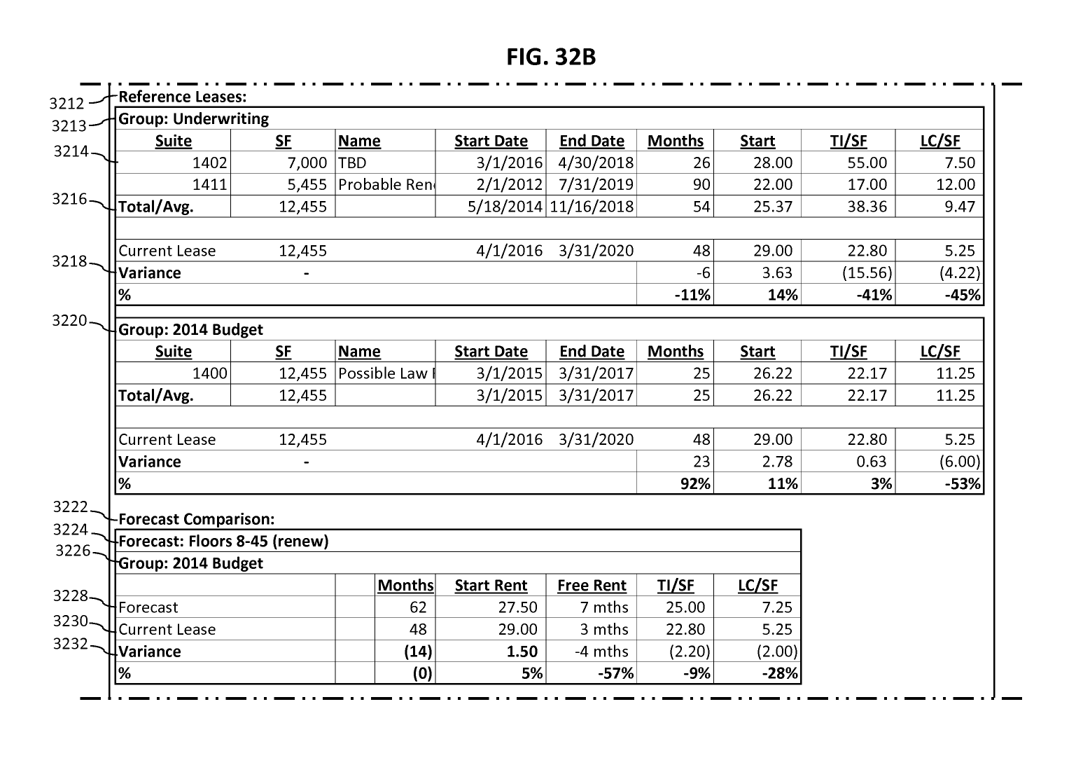

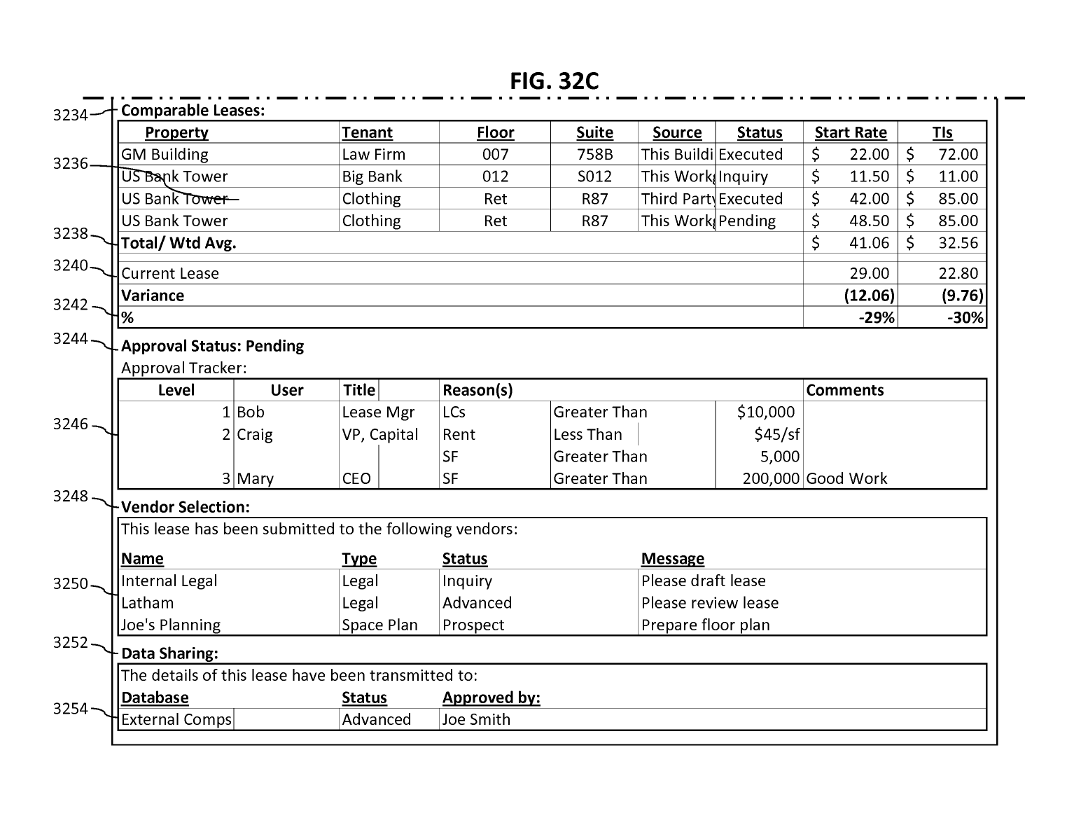

By way of example, if a reference lease with a start date of January 2013 as entered through control 1162 (FIG. 11) were identified as space type “Office Floors 1-9” through the space type selection control 1112 (FIG. 11) and also identified as a new lease in the lease type selection control 1110 (FIG. 11). Then, when comparing the reference lease to the baseline 1702 forecast for space type of floors 1-9 1714, a user can view a forecast lease on market forecast interface 1700 with a length of five years 1722, 1724, a rent of $25.75 1740, six months of free rent 1742, $20.60 in tenant improvements 1744, as well as other lease terms entered, imported, or calculated into the baseline layer. If the user then wanted to compare the same reference lease to the layer identified as “2016 Budget” 1802 as shown in market forecast at interface 1800 (FIG. 18), then the user would see a forecast lease with a length of 92 months 1822, 1824, rent of $29.00 1840, three months of free rent 1842, and tenant improvements of $76.50 1844 as well other lease terms associated with the library layer illustrated in FIG. 18. Otherwise, the user may view the forecast lease data on the reports 3200 (FIGS. 32A-32C).

It will be understood that the library layers, reference groups, and forecasts may be provided with different configurations, and one example is described above. Thus, it will be appreciated, for example, that the layers may be set up alternatively such that each layer represents a different space type and market forecast, and each layer may represent one or more reference groups or budgets. For display on the market forecast interface 1700, in this case, instead of selecting space type on menu 1705, the user would select the reference group or budget, while the layer menu or control 1702 would be used to select the space type of a particular layer. Many other variations are possible.

From the above, it is understood that a lease deal may be compared to a variety of data sources and types. It may be linked to reference leases through reference groups, it may be compared to forecast leases, and it may be compared to comparable leases (explained below). There is no limit to the number of reference groups that can be created, and each reference group represents different expectations for what may happen with the spaces, leases, and sections of a building. Reference groups may, for example, represent expectations for the property and leases at a specific point in time such as the initial underwriting, a financial reforecast, or a budget. Reference leases within a reference group may sub-divide a building into different potential leased areas. For example, a reference group may contain seven reference leases covering all of the space in a section of a building. As lease deals are negotiated, they may, or may not, correspond with the seven reference leases. For example, if a tenant approached a landlord with a prospective lease deal to occupy the entire section of the building, then it is necessary to link the corresponding lease deal (entered to represent the prospective tenant) to all seven reference leases. Alternatively, a potential lease deal may not occupy all of the space in one of the seven reference leases, so the potential lease deal would only link to a portion of the area covered by the reference lease. There also may be situations where several full reference leases will be linked to, and a portion of others will be linked to. There are many possibilities.

The innovation of reference groups, reference leases, and links jointly solves the problems with conventional lease tracking systems. With the combination of reference groups, reference leases, and reference links, it becomes possible to allow lease deal data, which may include the division and combination of the leaseable space of a building in a variety of ways, to continue unaffected by multiple budgets. Now lease deal data is able to reference multiple budgets, so that it can be linked to a 2012 budget, and when a 2013 budget is created, the program is updated with a new reference group and populated with corresponding reference leases for the 2013 budget, the lease deals can then be linked to the new 2013 budget reference leases without impacting the lease deals, which may be in-progress. Previously, it was necessary to maintain data for the lease deal versus both the 2012 budget and the 2013 budget independently and it was difficult to divide and combine leaseable spaces while tracking financial and other metrics. Now, it can be done seamlessly, and a history of reference groups may be created, so an authorized user may be able to view how leasing at the property has performed over time versus the initial property underwriting at purchase, which may be one reference group, as well as against periodic budgets, forecasts, or other changes in leasing expectations, each of which can be entered as a series of leases for a different reference group.

To add another dimension to the innovations above, the market forecasts based on varying space types can be used on multiple layers (which may be associated with reference groups) of the library, substantially expanding the amount and types of comparisons that can be made with lease deals and reference leases linked to any of the layers. This provides a large variety of alternative forecast comparisons from layer to layer. This potentially large amount of data providing forecast comparisons on multiple layers may be provided within the library-layer structure so that duplication of data may be reduced.

### Process Approval Routine

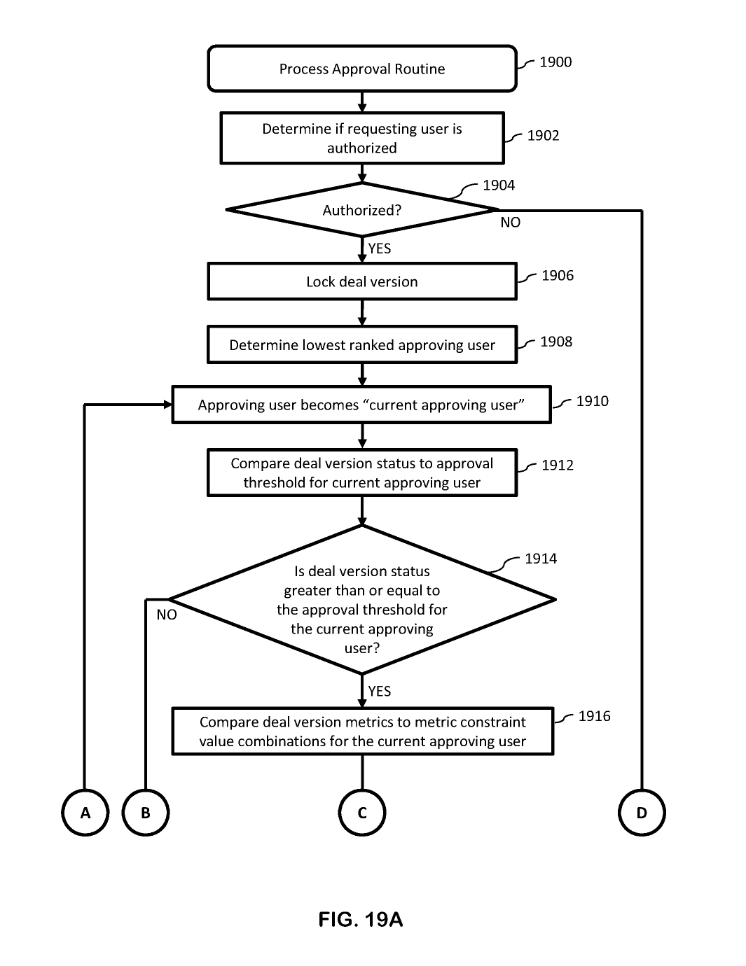

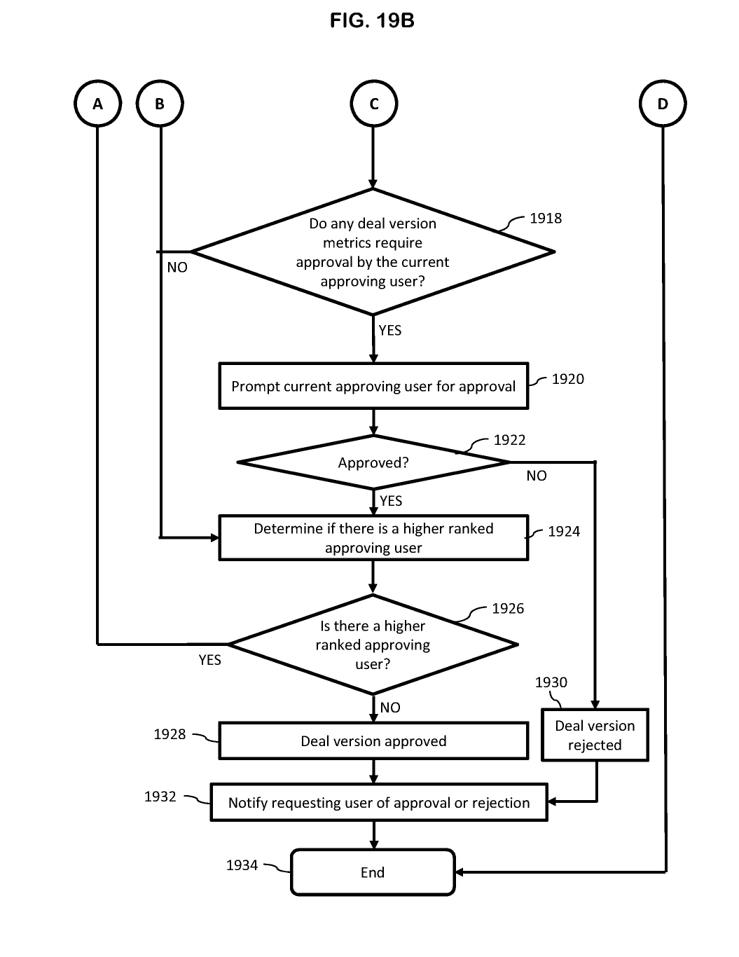

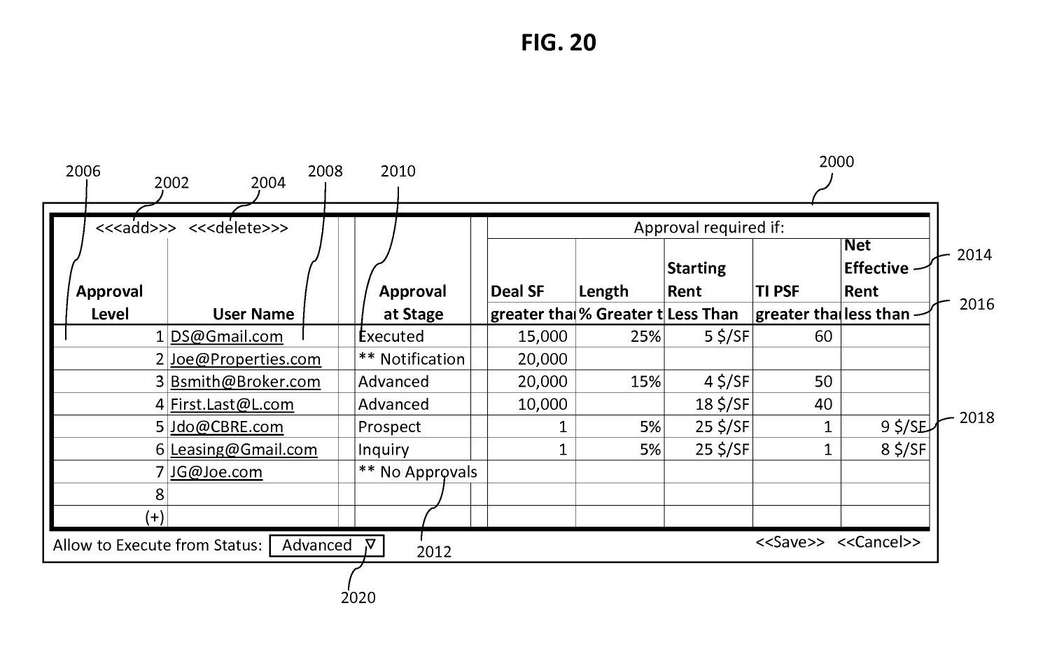

Referring to FIG. 13 and FIGS. 19A-19B, in one alternative form, the system 10 may provide a routine 1900 for process approval to confirm or obtain proper authorizations to permit a user to perform certain functions. For instance, one or more approvals may be required when a user attempts to obtain a certain status for a lease deal version, such as approval to enter into preliminary negotiations at certain deal terms (and thereby show the status as “in-negotiations” or “prospective”) or to execute a lease deal for example. As explained previously, the program can be configured with a feature that allows multiple versions of each lease deal. This feature is provided for convenience and to reduce repetitive data entry, but the program may also be configured such that only one version is allowed per lease deal such that multiple versions are not visible or available to a user. The approval features are still able to function when the program is configured to only allow a single version of each lease deal so that, for example, instead of submitting a lease deal version for approval, from a user's perspective, they are able to submit a lease deal for approval (which is effectively submitting the single lease deal version for approval, but the concept of versions is invisible to the user). When the program is configured to allow only a single version of each deal, a user may create multiple lease deals for a given deal. For example, if negotiations are in-progress with a potential tenant, a user may create one lease deal to represent the initial terms of the negotiation, another lease deal to represent the terms after further negotiation, and another lease deal to represent the final deal terms. Each of these deals (which only have a single lease deal version available) may progress through the approvals process independently, in the same manner as a lease deal version would progress through the process approvals process. Approvals may also be required for other functions as discussed below. In more detail, a user requests approval for a lease deal version from, for example, a “submit for approval” button accessed in the approval interface area 1308 (FIG. 13, fully illustrated in FIG. 21) of the lease deal version input interface 1300. This initiates process approval routine 1900. First, the routine 1900 determines 1902 if a requesting user is authorized to request approval. This may be performed by confirming identification of a user by login, password, and so forth and finding the user's identification on a stored authorization list. Many other examples are contemplated. If the requesting user is authorized 1904, the deal version is locked 1906 to prevent any further edits during the approval process. After the deal version is locked, the routine determines 1908 the lowest ranked approving user based on inputs in an approval administration interface 2000 such as the one illustrated in FIG. 20. Once the lowest ranked approving user is determined (here ranked 6 on interface 2000), the user becomes 1910 the “current approving user.”

After determining 1910 the current approving user, the routine compares 1912, 1914 the lease deal version status for the deal for which approvals are being sought to the approval threshold for the current approving user. For this step, the lease deal version status is given a hierarchy where the closer the lease deal is to being executed, the “greater” the version status. Thus, lease deals advance or are upgraded toward execution. For example, reviewing one possible version status hierarchy from least to greatest would be inquiry (such as an initial offer), in-progress (in-negotiations), advanced (negotiations closer to execution), approved for execution, and executed. Many other orders and status indicators may be used as long as there is a way to define a threshold for an approving user.

Also, for the exemplary routine 1900, a minimum threshold is being applied. Thus, if one approving user has a threshold of prospect and the current lease deal version is advanced, according to the example hierarchy, the approving user's approval is required since advanced is greater than prospect. If the lease deal version's status is greater than or equal to the approval threshold for the current approving user, then the routine compares 1916 the lease deal version's metrics to metric constraint values for the current approving user.

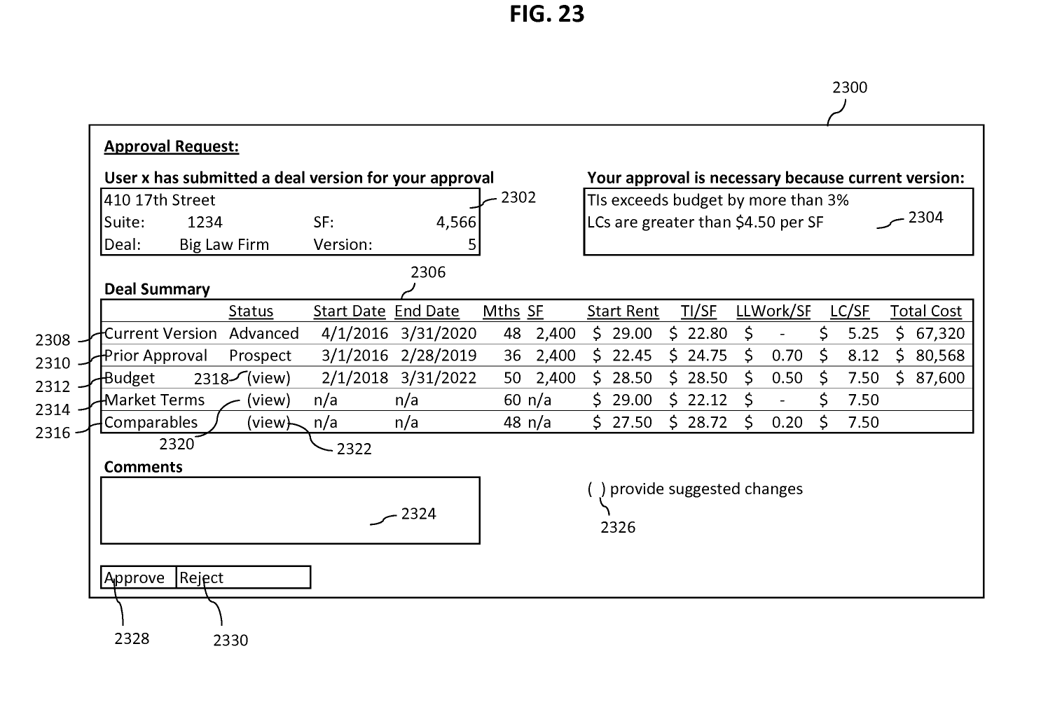

If any of the lease deal metrics require approval by the current approving user 1918, the current approving user is prompted 1920 to approve the lease deal version through, for example, an approval request interface 2300 (FIG. 23). If either the deal status is not greater than or equal to the approval threshold for the current approving user 1914 or the deal metrics do not require approval by the current approving user 1918, the routine proceeds to step 1924. If the current approving user does not approve the deal version 1922, the deal version is rejected 1930, and the requesting user is notified of the rejection 1932. If the current approving user approves the deal 1922, then the routine determines 1924 if there is a higher ranked approving user. If there is a higher ranked approving user 1924, that user then becomes the current approving user 1910, and the routine returns to step 1912. If there is not a higher ranked approving user 1926, the deal version is approved 1928 and the requesting user is notified 1932 that the deal version has been approved.

After the requesting user is notified of the approval or rejection of the deal 1932, the routine ends 1934. Note that routine may occur rapidly or take time. For example, an approving user may take days, months, or even years to approve a deal version, thus delaying the completion of the routine. In other forms, approvals may take places in batches if, for example, deal version data is entered for multiple lease deal versions, and then once a week, it is submitted in bulk for approvals. The process approvals exist to process approvals such as those entered in the approval administration interface 2000 (FIG. 20), so that, for example, if the administration interface 2000 is updated to require approvals if a lease deal version is less than a status level, rather than greater than a value 1914, the process approval routine will still be able to execute it so long as the underlying logic of processing both deal version status and metric/constraint/value combinations remains the same.

### Approval Administration Interface

Referring to FIGS. 7 and 20, the illustrated property file 700 also has approval data 714 which can be input by an approval administrator onto the approval administration interface 2000 and managed by an approval manager 417. The illustrated approval administration interface 2000 accepts data about users and data about when approval is required by a specific user. As mentioned, it provides data for use in the routine 1900 (FIG. 19) to process approvals. Users identified in this interface are referred to as approving users since they are involved in the approval process. Note that even though users selected in this interface are referred to as approving users, depending on the data input by the approval administrator, approvals may not be required from them. This is because the approval interface 2000 may also determine which other users have access to the property file 700. In one form, the approval interface 2000 is integrated into the workgroup interface 3000 (FIG. 30), which can alternatively be used to determine which users have access to properties within a workgroup. Though it is not shown in the illustration, different permissions may also be included for each user so that, for example, features such as the ability to edit reference leases, view reference leases, create new lease deals, and many other controllable features may be enabled or disabled on a user-by-user basis for approving users. As an example of an approving user without approval rights, through this interface 2000, an approving user may be designated with a designation 2012 such as no approvals as a user who does not have approval rights. Any user with access to property data may be designated as an approving user. Users may be added through the use of the add button 2002 or deleted through the use of the delete button 2004. A user may be both the requesting user and an approving user for the same process approval routine.

The approval administration interface 2000 has approval levels 2006 used to establish a user's ranking in the approval process (used in steps 1908, 1924, and 1926 of the process approval routine 1900 (FIG. 19)), an input control 2008 where approval administrators can designate approving users, and an input control 2010 where approval administrators select lease deal version status threshold levels based on a hierarchy as explained above and to establish when approvals are required by an approving user (utilized in steps 1912 and 1914 of the process approval routine 1900 (FIG. 19)). User input controls 2014 are provided to select approval metrics which require approval, user input controls 2016 to select constraints for a threshold value for each metric, and user inputs 2018 for the threshold values. When a metric 2014, constraint 2016, and value 2018 are combined, it provides sufficient data to establish a formula that determines when an approval is required under steps 1916 and 1918 of the process approval routine 1900 (FIG. 19). For example, the combination of metric “TI PSF” (tenant improvement per square foot), constraint “greater than” and value “$60” would trigger an approval requirement under step 1918 of the process routine 1900 (FIG. 19) if the lease deal version for which approvals are being sought has tenant improvements per square foot of over $60. The approval administration interface 2000 allows the addition of multiple columns for metric 2014 and constraint 2016 combinations, and the number of columns is only limited by the number of metric/constraint combinations that can be generated by the metrics and corresponding constraints established by the system administrator. Metrics are defined within the program and have types of lease data such as data that can be input through the lease deal interface (FIG. 12) and the lease deal version input interface (FIG. 13).

Metrics may also consist of variances versus reference leases or the market forecast. For example a metric may consist of “TI variance versus reference leases” which will then compare the tenant improvements of the lease deal version to the tenant improvements of the reference leases it is linked to through reference linking area 1210 (FIG. 12), and approvals may then be required based on the constraint 2016 and value 2018 associated with the metric. Metrics may also be based on other data entered elsewhere in the program, such as the option and encumbrance interface (FIG. 24B) if, for example, the approval administrator selects a metric 2014 such as “Space is encumbered” a constraint 2016 such as “during lease term”, and a value 2018 of “true” for an approving user, then that approving user must approve the lease deal version if the space of the lease deal version is encumbered during the time the lease deal version is to occupy the space. Constraints are also defined within the program and correspond to the selected metric. A control 2020 is also provided where the user may select the deal status level that may proceed to executed without further approvals under the changed to executed status routine 2400 (FIG. 24) explained below.

Approval data may be entered and stored at the property, workgroup, or user level. When data is not stored at the property level, the property file can reference the data that are stored at the workgroup or user level and the property file may be pointed to the appropriate data as illustrated in the property administration interface 3100 (FIG. 31).

By default, the property administrator is also the approval administrator. The property administrator can also assign approval administration rights to other users with access to the property. In other forms, it may not be necessary to follow a sequential order. Several users may be at the same ranking, or all approvals may be requested at once. Metrics, constraints, and values may also be structured in multiple ways. For example, rather than using a metric and constraint to define what requires approval, a metric and constraint may also be structured to define what does not require approval.

### Approval User Interface

Referring to FIG. 21, various states 2102, 2112, 2124 of the approval user interface 2100, which can be a stand alone interface or pop-up or for this example, embedded in the lease deal version input interface 1300 (FIG. 13) at a reserved area 1308 with a version/status/approval area 1302. In one form, when a new lease deal is created, a version of that deal is created as well. Each lease deal version may contain an approval interface 2100 so that multiple versions of a deal may be reviewed and approved or rejected by approving users. As an example, in one form, a deal may have an initial version containing preliminary lease deal financial inputs based on early discussions with a tenant, and as discussions progress, and lease deal financial terms change, additional versions may be created and submitted for approvals.

In the illustrated form, the approval process for each lease deal version contains the following states (also known as approval status, which is unrelated to deal version status). These states can be modified or removed by a system administrator, and additional states may be added, and the following is provided only as a representative list:
Completed—Approved: Occurs when a lease deal version has completed the process approval routine 1900 (FIG. 19), and the lease deal version has been approved.
Completed—Superseded: Occurs when a lease deal version has completed the process approval routine 1900 (FIG. 19), and the lease deal version has been approved, but then another lease deal version is subsequently approved for the same lease deal. When this occurs, the previously approved lease deal version is superseded by the latest lease deal version to be approved. This approval process state is not available when the program is configured to allow only a single lease deal version since it is not possible for one version of a lease deal to supersede another version of the same lease deal.
Completed—Rejected: Occurs when a lease deal version has completed the process approval routine 1900 (FIG. 19), and the lease deal version has been rejected.
Completed—Closed: Occurs when a lease deal version has completed the process approval routine 1900 (FIG. 19), and a user subsequently closes the lease deal version. This may occur, for example, if a lease deal version is approved, but a tenant decides not to move forward with a deal.
Pending Approval Occurs when the process approval routine 1900 (FIG. 19) is activated for a lease deal version, and the routine is not yet complete. For example, it may be waiting for approvals or rejections from one or more approving users.
Cancelled: Occurs when the process approval routine 1900 (FIG. 19) is activated for a lease deal version, and a user cancels the approval routine before it is completed.
Not Yet Submitted: Occurs before the process approval routine 1900 (FIG. 19) is initiated by, for example, a user selecting the submit for approvals button 2110. This is also used to classify deal versions when approvals are not enabled for a property.

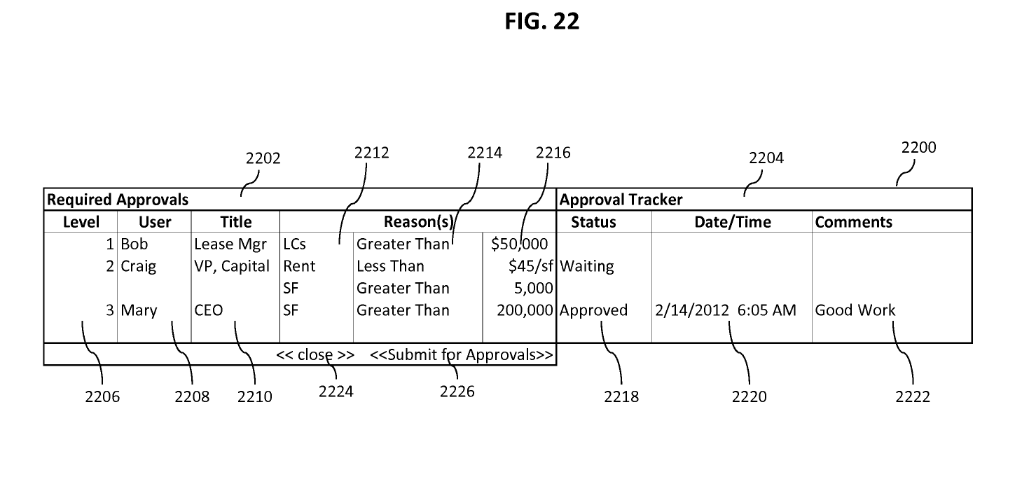

The interface 2100 changes states based on user selections and the progress of the process approval routine 1900 (FIG. 19). The state of the buttons when a lease deal version has not yet been submitted is illustrated in interface state 2102. In this state, the user can view and edit the version identifier through user control 2104, select a status for the version through a user input control 2106, select a button 2108 to open an approval overview interface 2200, which will display required approvals in a format such as one example illustrated in FIG. 22, and select a button 2110 to initiate the process approval routine 1900 (FIG. 19)

After a user initiates the process approval routine 1900 (FIG. 19) through, for example, the selection of button 2110, the interface 2100 changes to the pending approvals state 2112, where the user may view the version identifier 2114, view the version status 2116, select a button 2118 that launches the approval overview interface 2200 (FIG. 22) which now displays approvals required for the version and the current status of those approvals, a button 2120 to cancel approvals for the current version, which will stop the approval process, and if no deal versions are currently in the not yet submitted state and the feature allowing for multiple versions of the same lease deal is enabled, a button 2122 to duplicate the version. In one form, when a version is duplicated, the approval status is not duplicated (such that duplicating an approved, or partially approved, lease does not create another version that has been approved or partially approved).

Once the process approval routine 1900 (FIG. 19) is complete or the lease deal version has had approvals cancelled, the interface changes to a completed state 2124, where the user may view the version identifier 2126, view the version status 2128, view the approval status 2130 which also may double as a button that launches the approval overview interface 2200 (FIG. 22). Upon approval, overview interface 2200 now displays a history of the approval process and how approvals were completed. If no other deal versions are currently in the not yet submitted state and the feature allowing for multiple versions of the same lease deal is enabled, a button 2132 on approval state interface 2124 is provided to duplicate the version.

To simplify the user interface, this form of the approval user interface 2100 enforces the following rules if the program is configured to allow multiple versions of the same deal (if only a single version is permitted, these rules are not necessary):
Only one version of each lease deal may be in an editable, not yet submitted state (with the corresponding not yet submitted interface 2102). This prevents confusion caused by multiple editable versions. All changes must be made to the single version which remains editable until it is submitted for the process approval routine 1900 (FIG. 19) at which point it is locked 1906 (FIG. 19), and it then becomes pending approvals. This allows the version to be duplicated through the use of the duplicate button 2122. The duplicated version is then editable, and is in the not yet submitted state.
Only one version of each lease deal may be in the pending approvals state (with the corresponding pending approvals interface 2112). This prevents confusion that could be caused by multiple versions of the same lease deal executing the process approval routine 1900 (FIG. 19) at the same time. For example, an approving user may become confused if the user were presented with two versions of the same deal for approval. Versions with pending approvals must complete the approval process, or be cancelled before another version may be submitted for approval.
An unlimited number of completed versions may exist for a lease deal in the completed-superseded, completed-rejected, and completed-closed states. However, only one version may exist in the completed-approved state. This prevents confusion that may be caused if multiple approved versions exist for the same deal.

The rules above are intended to simplify the user interface, but they do not need to be enforced for the program to work properly. For example, the program may still function with multiple deal versions in an editable state, multiple deal versions in a pending approvals state, and multiple deal versions in a completed-approved state.

The rules above apply if approvals are enabled for a property. If approvals are not enabled, a lease deal may have multiple editable versions. Further, when approvals are not enabled, an additional lease status “closed” may be added to allow users to close-out, or complete a deal which does not get executed through the use of a process approval routine 1900 (FIG. 19).

### Approval Tracker Interface

Referring to FIG. 22, when a user selects the view required approvals button 2108, view pending approvals button 2118, or view history button/approvals button 2130 within the approval user interface 2100 (FIG. 21), the approval tracker interface 2200 is launched. The approval tracker interface 2200 has at least two areas, the required approvals area 2202 that displays which approvals are required and why, and the approval tracker area 2204 that displays the progress of approvals once a lease deal version has been submitted for approvals. The required approvals area 2202 has a display 2206 of each approving user's ranking, the name of each approving user from which approvals are required 2208, the title 2210 or other identifying information for the approving users, a display of the metric 2112, constraint 2214, value 2216 combinations that require approval, a close button 2224 to close the interface or pop-up, and if the deal version has not yet been submitted, a “submit for approvals” button 2226 as with button 2110 (FIG. 21). The approval tracker area 2204 is populated once a deal has been submitted for approvals, and has a display 2218 of the status of each approval, a date and time indicator 2220 for each action by an approving user, and a display 2222 of the comments provided by an approving user through, for example, the approval request interface 2300 (FIG. 23).

### Approval Request Interface

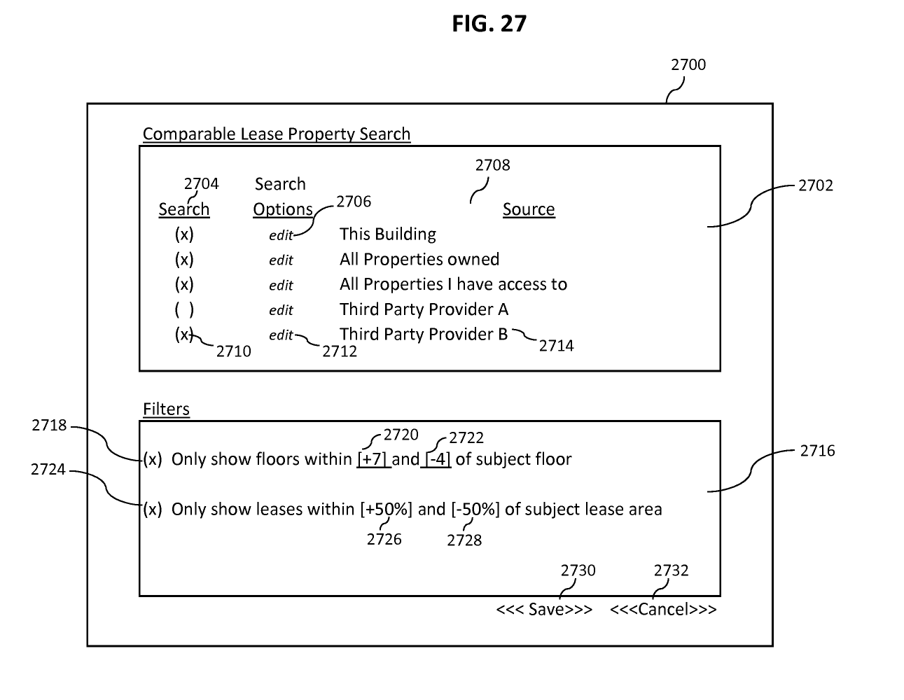

Referring to FIG. 23, as mentioned above when a requesting user submits a lease deal version for approval through, for example, selection of the submit for approvals button 2110 (FIG. 21) or button 2226 (FIG. 22), this initiates the process approval routine 1900 (FIG. 19). When it becomes necessary to prompt an approving user for approval 1920 (FIG. 19), a message is sent to the approving user through a message center, an e-mail, or a variety of other methods such as a text message. The approving user can then access an approval request interface 2300 (FIG. 23). The approval request interface 2300 contains an area 2302 that identifies the deal and version, and an area 2304 that displays the metric/constraint/value combinations that triggered the approval requirement. The approval interface 2300 also includes an area 2306 which displays financial and other lease data for the current lease deal version 2308, previously approved versions 2310 of the lease deal, and data from reference leases 2312 such as those linked to through the budget links area 1210 of the lease deal interface 1200, (FIG. 12). The area 2306 also displays data for market terms 2314 which may be associated with a lease deal through the space type selection 1206 (FIG. 12), and data on comparable leases 2316, which may be associated with a lease deal through the use of the comparable lease administration interface 2700 (FIG. 27) as described below. Data from multiple reference/budget, market, and comparable deals may be averaged to simplify the display of data, and variances between each of data 2308-2316 may also be displayed.

Buttons 2318, 2320, 2322 are provided to launch detailed displays of underlying data and calculations used to reach the averages. For example, selecting button 2322 launches a comparable lease interface 2800 (FIG. 28). An area 2324 is also provided to allow the approving user to enter comments which can be provided to the requesting user through, for example, the comments area 2222 of approval tracker interface 2204 (FIG. 22). An approving user can also provide suggested changes by selecting button 2326 which allows the approving user to suggest changes to lease terms. The suggestions are transmitted through the message center and allow the requesting user to accept or reject the changes, which are then used to create a new lease deal version if adopted, subject to the rules governing the creation of a new lease deal version. For example, if a new lease deal version is not permitted to be created because a version is already pending, the requesting user must cancel approvals on the current version proceeding through the approval process prior to creating the new, suggested, version. The approving user may approve 2328 or reject 2330 the lease deal version through the use of a corresponding button provided in the interface 2300.

### Change to Executed Status Routine

Referring to FIGS. 19, 21, and 24A, when approvals are enabled for a property, an extra lease status is added for “Approved for Execution” (which can be labeled in a variety of ways such as “Apr. for Exec.,” “Ready for Execution,” “Pending Exec.”). This additional lease status is provided when approvals are enabled to facilitate a business process where requesting users must first get approval before executing a lease. For example, a leasing manager may need to seek approval to execute a lease prior to the execution (signing) of the lease, and then once it is executed, information may need to be entered into the program, but there is no need to request any further approvals. The addition of the “Approved for Execution” status resolves this issue by allowing a requesting user to first request permission to execute a lease, for example, by selecting the “Approved for Execution” status in the status input 2106 (FIG. 21) and then submitting the lease deal version for approvals through the submit for approvals button 2110 (FIG. 21). This then operates the process approval routine 1900 (FIG. 19), and if a deal version is approved 1928 (FIG. 19) at the “Approved for Execution” lease status, then a user may enter additional information, and change the lease deal version status to executed through execution of the change to executed status routine 2400 (FIG. 24) without the need to request further approvals.

The change to executed status routine 2400 can be initiated in a variety of ways. One example is that once a lease deal reaches approval status “approved” at lease status “Approved for Execution” the status indicator 2128 (FIG. 21) may become enabled for editing, and allow the user to select the “executed” status. When the status is changed to “executed”, it initiates the change to executed status routine 2400 to determine if this is allowable.

After the change to executed status routine 2400 is initiated, the routine first checks 2402 if the requesting user is authorized to request the change by confirming a login, password and so forth. If the user is authorized 2404, then the routine proceeds to determine 2406 if the current lease deal version status may be changed to an “executed” status. As discussed above, a typical status that would allow this is an “approved for execution” status. However, through the control 2020 on the approval administration interface 2000, an approval administrator may authorize other statuses to be converted to “executed” without further approvals. For example, deals that have been approved at the “advanced” or equivalent level, could be enabled to advance to “Executed” without further approvals. This may be accomplished by setting desired thresholds on the approval interface 2000. If the routine determines 2408 that the current status can be changed to “executed” without further approvals, then the routine prompts 2410 the user to update links to space that will be claimed once the lease deal version is changed to executed status. For example, if another lease deal is linked to space that will be claimed by the current lease deal, then the other lease deal must have its links to space reconfigured since the space will no longer be claimable once it is claimed by the current lease deal. This may be done, for example, by prompting the user to update the links in the lease links area 1208 (FIG. 12) for the other lease deals that are linked to the same space, but not yet executed.

Next, the change to executed status routine 2400 accepts entry 2412 of additional lease data such as the lease execution date (such as the date the lease document is fully executed), which may be different than the approval date, the date the lease commences, or the date the status is changed to “executed.” Additional lease data 2412 may also include option and encumbrance data, lease document abstract data (a summary of key terms of the lease document such as when the landlord is permitted to relocate the tenant to another suite, security deposit information, and so forth), and other additional data as permitted by the program. The lease deal version is then updated 2414 to executed, which enables other leases to link to and claim space from the now executed lease deal. Other program features described elsewhere, that are based on lease status, such as data sharing, and the ability to enter the encumbrances and options included in the lease are also enabled or run based on the change in status. Certain users may also be permitted to reopen a lease deal after it is changed to executed status to add or edit information about the executed lease deal. After step 2414, or if the requesting user is not authorized 2404, or if the current lease status cannot be changed to executed status 2408, the routine ends 2416.

When approvals are not enabled, an “Approved for Execution” lease status may not be provided, and a user may simply change the lease status to executed and bypass steps 2406 and 2408 of the routine. Other features, such as steps 2410 and 2412 are still enabled since they are tied to the use of the executed lease status. For example, if approvals are not enabled, and a user changes a lease deal version's status to executed, he will still be prompted to update links, similar to step 2410, and the entry of additional lease data, similar to 2414 will also be allowed.

Referring to FIGS. 24A-24B, as mentioned, prior to a lease reaching executed status, either through the approval process or through a user selection when approvals are not enabled, program 44 provides the opportunity for users to enter 2412 additional lease data. The lease execution date as well as option and encumbrance data may be received through, for example, an option and encumbrance entry interface 2450. The interface 2450 may be displayed to a user when the user selects the executed lease status. Many lease agreements contain clauses that provide the lessor or lessee certain rights, such as the option to extend the lease beyond the initial expiration date, an option to occupy space elsewhere in the building, or rights (encumbrances) to other space in the building such as a right of first refusal (ROFR) before the space may be leased to other tenants. It is important for users involved in the leasing process to track these options and encumbrances so that they do not mistakenly lease, or attempt to lease space, to which another tenant has conflicting rights.

The option and encumbrance entry interface 2450 provides a convenient way for users to enter data for a lease deal that may include options or encumbrances. The system 10 then may warn users of the options and encumbrances when they enter other leases and attempt to link to the executed lease or other space with options and encumbrances. The system 10 may also use the option and encumbrance data in the processing of approvals 1900 (FIG. 19) when, for example, the approval administrator selects a metric 2014 (FIG. 20) such as “Space is encumbered” a constraint 2016 (FIG. 20) such as “during lease term”, and a value 2018 (FIG. 20) of “true.”

The interface 2450 includes a user control 2452 where a user may enter the date a lease was executed. This is used for some reports. The interface 2450 also includes an area 2454 for the entry of option and encumbrance data, which includes buttons 2456 to add or delete options or encumbrances. When the add 2456 button is selected, a row is added to the interface, which consists of a user control 2458 for the user to select from a list of suites and sections within the building. Selecting a suite or section then allows the user to add an option or encumbrance to the space. For example, if the option or encumbrance impacts space to be occupied by the to-be-executed lease, then a user can select “this suite,” if the option or encumbrance impacts other space within the building, then the user can select the impacted space.

User controls 2460-2462 are provided for the user to enter the dates that the option or encumbrance is in effect. For example, a lease may provide an option for additional space, but only during a certain time period. The dates entered through controls 2460-2462 may be used in the warning presented to the user of the option or encumbrance, or may be used by the system 10 to determine if the user should be warned of the option or encumbrance. For example, if a user has already entered a lease start date of “Jan. 1, 2018,” and the option or encumbrance ended on “Oct. 31, 2014,” then there may be no reason to warn the user of the encumbrance since it has already expired. A user input control 2464 is also provided where the user can select from a list of common options and encumbrances that have been previously defined by a system administrator, and a user input area 2466 is provided where a user may enter a message that further describes the option or encumbrance to appear in the warning.

### Vendor Administration Interface

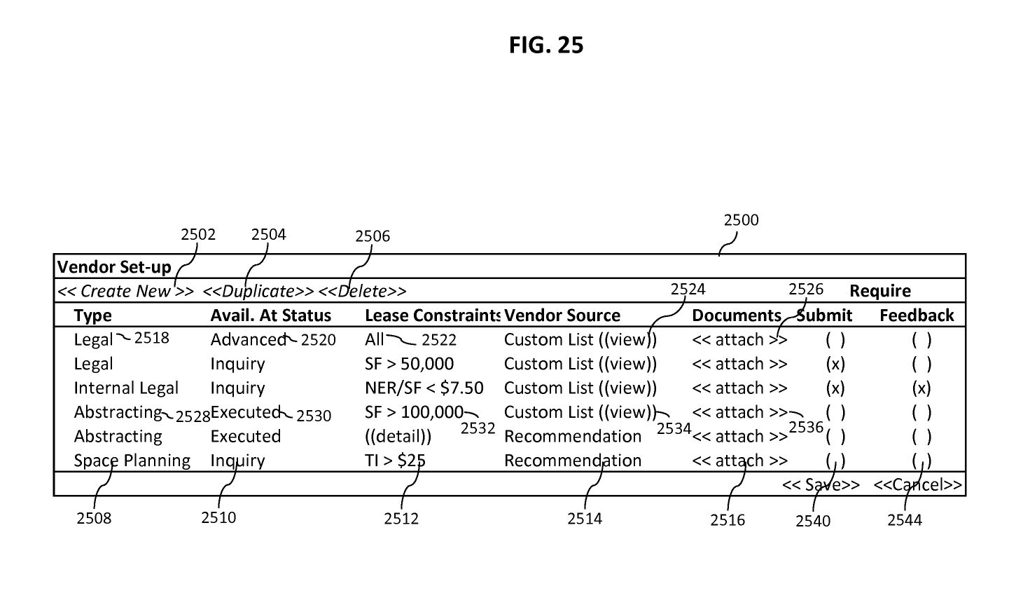

Referring to FIG. 7 and FIG. 25, the property file 700 may also include vendor data 716, which may be input, for example, through a vendor administration interface 2500 and approved by a vendor manager 421. This is useful since an owner may have all large lease deals reviewed by legal counsel early in the leasing process, but may be willing to wait until later for smaller deals. Another possible use would be to transmit executed lease data to a lease abstracting vendor, or directly into a lease abstracting software package. Other professional services such as space planning, may be initiated at different points, and based on different leasing metrics as a result of inputs through the vendor administration interface 2500.

The vendor administration interface 2500, consists of a button 2502 to add a new vendor type through the addition of a new row to the interface, a button 2504 to duplicate a vendor type row, and a button 2506 to delete a vendor type row. Common vendor types are preloaded into the software, and additional types may be added by the vendor administrator. Vendor types are selected through a user input control 2508. The input interface also accepts user selections 2510 for “Available at Status” which determines when the vendor will be made available to users for use. An input 2512 may provide for lease constraints which allows the vendor administrator to determine when, in conjunction with lease deal version status 2510, a vendor is presented to a user. A vendor source input 2514 allows the vendor administrator to define a list of vendors, or allow a program generated recommendation, that will be presented to users when status 2510 and constraint 2512 tests are met. A control 2516 may add attachments to be presented to the vendors.

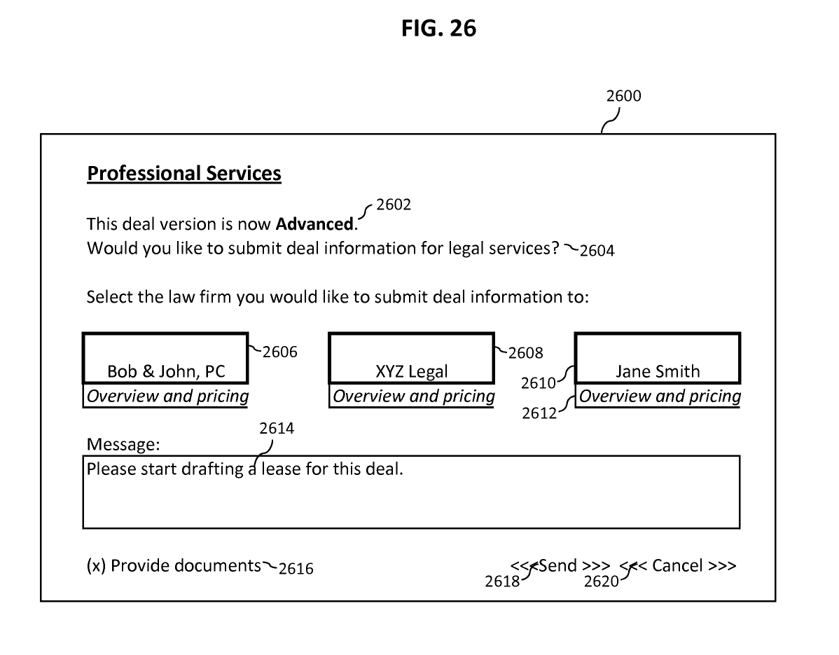

For example, when a lease deal version reaches advanced status 2520, and no constraints apply 2522, then the user is prompted to involve a legal type 2518 vendor, and is prompted with a list of legal vendors as defined in the list 2524 to provide legal services for the lease. When the user selects a vendor through, for example, a professional services interface 2600 (FIG. 26), the vendor 19 (FIG. 2) can be presented with documents attached through control 2526. In another example, once lease deal versions over 100,000 square feet 2532 reach executed status 2530, then the users are presented with the option to submit the deal version information to the abstracting vendors 2528 in the custom list 2534, and can also provide attachments 2536 along with the deal version information. In other forms, lease deal version data and any associated documents may be sent automatically to vendors 19 without the need to obtain user approval through the professional services interface 2600 (FIG. 26). Deal version data is submitted to vendors 19 either by providing them with a user name and login for the software, or by e-mail.

Submitting lease deal data to a vendor may also be a requirement for requesting additional approvals. If the “make submission required” input 2540 is selected for a specific vendor type, then a user may not request approvals until data has been submitted to the required vendor. A vendor administrator may require that deal data be submitted to a legal vendor prior to allowing a request for approval at a higher level. For example, if “make submission required” box 2540 is selected, then any 2522 lease deal versions at the advanced 2520 deal status level must submit lease deal version data to at least one of the legal vendors from the vendor source list 2524. A “make feedback required” checkbox 2544 is also provided which requires feedback from the vendor 19, through the software message center before a deal version can advance for further approvals. Approvals may also be required by a vendor to permit a lease deal version to proceed to a requested lease status. In order to accomplish this, the approval administrator may add the vendor to the approval administration interface 2000 (FIG. 20) and enter the required approvals for the vendor in the same manner as any other user.

Professional services vendor data may be entered and stored at the property, workgroup, or user level. When data is not stored at the property level, the property file can reference the data that are stored at the workgroup or user level and the property file may be pointed to the appropriate data as illustrated in the property administration interface 3100 (FIG. 31). By default, the property administrator is also the vendor administrator. The property administrator can also assign vendor administration rights to other users with access to the property.

It will be appreciated that communications and transmissions between the system and the vendor's computer may occur over the internet, WAN, LAN, or any other communications network that supports transmission of data, and in one form, transmission of documents.

### Professional Services Interface

Referring to FIGS. 25-26, professional services vendor data may be set up through a vendor administration interface 2500, and then presented to users at the appropriate time (as defined in the vendor interface 2500), through a professional services interface 2600. For example, after a lease deal version reaches “advanced” status either through a direct selection of the status, or after approvals are received for the status, the program uses professional services vendor data from vendor administration interface 2500 to prompt the user with the professional services user interface 2600. The interface 2600 displays the status 2602 of the deal version, and a brief question or explanation 2604 of the professional services suggested or required based on data in the vendor administration interface 2500 (FIG. 25). If multiple vendors are identified in the vendor list 2514 (FIG. 25), then each is listed as a button, such as buttons 2606, 2608, and 2610. Each button lists basic information, and provides a link 2612 for additional information on the vendor. A user may select a vendor by selecting a button 2606, 2608, 2610, can optionally provide a message in area 2614, select a button 2616 to provide documents attached through control 2516 of the vendor interface 2500, and then select a button 2618 to transmit the data to the vendor, or select a button 2620 to close the window and cancel any transmission. When lease version data is transmitted via e-mail or through the program to a vendor through the use of the send 2618 button, the vendor can have a standing order to start work associated with the deal, or may be instructed separately on how to proceed through a message 2614, or other communication such as a phone call or e-mail. Documents 2516 provided in the vendor administration interface 2500 also may be transmitted to the vendor through the selection of button 2616, and may contain items such as a standard lease form for use by a lawyer, or specifications for space planning. A user may also have the option of attaching additional documents (not shown).

### Comparable Lease Administration Interface

Referring to FIGS. 7 and 27, the illustrated property file 700 also has comparable lease features 718 which allow users to view comparable lease deals based on parameters established in a comparable lease administration interface 2700 managed by a comparable lease manager 419. This interface 2700 is used so that a comparable lease administrator may control, at a high level, the comparable lease data that is provided to users for lease analysis. It may be necessary to restrict comparable lease data in some instances due to data licensing requirements, a desire to exclude certain sources for certain properties or portfolios, reduce data clutter, or for a variety of other reasons. A comparable lease administrator may also choose settings that select data providers, but provide no additional restrictions on the data provided by each provider, in effect placing no restrictions at all on data availability. Individual users are also provided with filters within the comparable lease user interface 2800 (FIG. 28) to further refine results.

The comparable lease administration interface 2700 consists of an area 2702 for selecting sources for comparable lease data and applying search options to identify specific properties provided by the sources to obtain lease comparable data, and an area 2716 for applying filters to the comparable lease data. The area 2702 for selecting sources of comparable lease data consists of a user input control 2704 for selecting which sources or databases (internal or third party) to search, a button 2706 for each source which allows the comparable lease administrator to apply search options such as the radius from each building to search, the square footage range of the buildings to search, and any parameters for other searchable fields within the source or database. An area 2708 lists all available sources that interact with the program and to which the property, user, or workgroup have access to. For example, a comparable lease administrator may select the ability to search the database for Third Party Provider B 2714 by selecting button 2710, and then restrict comparable properties through the search options button 2712 to those within one mile of the property executing the search. Thus, when users access comparable lease data for the subject property to which this filter is applied to, they will be able to access data from Third Party Provider B for properties within one mile of the subject property.

The filter area 2716 allows the lease comparable administrator to further refine the search for lease comparable data. While area 2702 deals with identifying comparable properties for search, area 2716 filters the property data to find relevant leases data. The illustrated filter user interface 2716 contains user selections 2718 to restrict the search by location in a building, in this case the location is floors as input in controls 2720 and 2722, but it may also be defined in many other ways, such as a user input control 2724 to restrict the comparable lease search by the size of the lease space, which in this case is based on a range of square footage as input in controls 2726 and 2728. There can be many options searching and accessing comparable lease data, and the interface 2700 is not limited to the options illustrated above. For example, additional options may be added based on the use of space such as office, retail, or storage, or the views offered such as a lakefront view. The program can support any number of options.

Comparable lease administration data may be entered and stored at the property, workgroup, or user level. When data is not stored at the property level, the property file can reference the data that are stored at the workgroup or user level and the property file may be pointed to the appropriate data as illustrated in the property administration interface 3100 (FIG. 31).

By default, the property administrator is also the comparable lease administrator. The property administrator can also assign comparable lease administration rights to other users with access to the property.

### Comparable Lease User Interface

Referring to FIG. 28, when the comparable lease interface is launched or viewed within, for example, the comparable data tab 1152 (FIG. 11), the comparable data button 1316 (FIG. 13), or the view button 2322 for comparable lease data line item 2316 (FIG. 23), the comparable lease data interface 2800 is either launched as a freestanding window, or embedded within another component of the program's interface.

The comparable lease interface 2800 displays similar lease deals as determined by the selections input in the comparable lease administration interface 2700 (FIG. 27) and the financial and other data associated with a lease deal, lease deal version, or reference lease. For example, if the subject lease is on the tenth floor of a building, as input in the lease deal interface 1200 (FIG. 12), and the lease deal administration interface 2700 (FIG. 27) contains a filter specifying that only buildings in the same city should be included in the comparable set, and only leases within +7 or −4 floors of the subject lease should be shown as comparable leases, then the comparable lease interface 2800 would display only comparable leases on floors six through seventeen of buildings within the same city.

The comparable lease user interface 2800 consists of additional filters which can be launched through the use of button 2802 which an individual user may apply in addition to those established in the comparable lease administration interface (FIG. 27), a grouping control 2804 and a sorting control 2806 for determining the display of comparable lease data, and a user input control launched with button 2808 to establish an information hierarchy. The information hierarchy is used to establish how data is presented for a lease when more than one data source has information for the lease. For example, if both internal and external data sources have data for a comparable lease deal, then the user can establish how the data is presented, such as showing all data sources, displaying a preferred data source and hiding the others, or highlighting preferred data sources and fading secondary data sources.

The comparable lease user interface 2800 also contains a view details button 2810 for each comparable lease deal, which launches an overlay or pop-up with additional details about the comparable lease, and, in situations where data may be applied directly, such as when editing is enabled in a reference lease, buttons 2812 are provided to apply financial and other details of the comparable lease to the lease which is currently being edited. For example, selecting the apply these terms button 2812 while editing a reference lease through the reference lease interface 1100 (FIG. 11) would transfer the rent, tenant improvements, lease length, and other key data to the lease currently being edited through the interface 1100 (FIG. 11). The comparable lease user interface 2800 also includes an area 2814 which displays information about the comparable lease deals.

### Lease Data Sharing Administration Interface

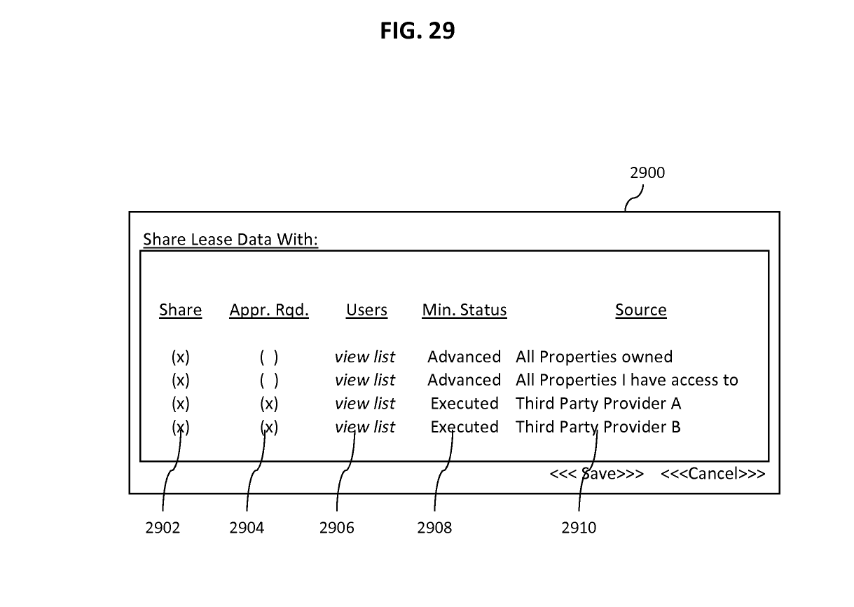

Referring to FIGS. 7 and 29, the illustrated property file 700 also has data sharing features 720 which allow authorized users to determine what lease data is shared both within the system, and with third-parties. This can be done to provide market data to third party vendors or to build-up internal lease information databases. Other typical uses could include transmitting information about executed lease deal versions to accounting systems, lease abstracting, and other software and systems.

The lease data sharing administration interface 2900 is used to administer how lease data is shared with internal and external databases and programs. The lease data sharing administration interface 2900 consists of an area 2910 which lists all available databases, both internal, and external, that the program communicates with, a user control 2902 that, when selected, allows data to be shared with the database, a user control 2904 that, when selected, will seek additional approval on a deal-by-deal basis before sharing data. If user control 2902 is selected, and user control 2904 is not selected, data sharing will take place automatically without the need for further approvals. A user control 2906 is also provided, which launches a list of users who may provide the approval identified by control 2904. These users may be notified through the software's message center or by some other means such as e-mail or a text message. If the required users from the list approve the release of data, the data is then shared with the source identified in area 2910. A user control 2908 is provided so that an authorized user may determine the threshold status of a deal needed to permit sharing of the deal data. For example, it may be determined that deal data should be shared with one database as soon as a deal version reaches “Advanced” status, while deal data should only be shared with another database when a deal reaches “Executed” status. Approvals for sharing lease data are distinct from approvals for lease deal versions.

Lease data sharing administration data may be entered and stored at the property, workgroup, or user level. When data is not stored at the property level, the property file can reference the data that are stored at the workgroup or user level and the property file may be pointed to the appropriate data as illustrated in the property administration interface 3100 (FIG. 31).

By default, the property administrator is also the lease sharing administrator. The property administrator can also assign lease sharing administration rights to other users with access to the property.

### Workgroup Administration Interface

Referring to FIGS. 5, 7 and 30, the program contains workgroups such as 507, 508, and 509 (FIG. 5) that may be managed by a work group manager 470 (FIG. 4). Workgroups are used to manage multiple users who have access to one or more properties. Workgroups can also be used as a centralized location to store data that is common across multiple properties within a workgroup. For example, library data 710, forecast data 712, approval data 714, vendor data 716, comparable features 718, data sharing features 720, and reference group data 704 (all FIG. 7) may all or partially be stored within a workgroup, and the individual properties may access the data through their association with the workgroup. Workgroups are an alternative and may not be required for the operation of the program. They are provided to reduce and simplify the management of data for multiple properties. If workgroups are not enabled, the same data may be stored at the property level.

Referring to FIG. 30, the workgroup administration interface 3000 is accessible by the workgroup administrator. By default, the workgroup administrator is the user who establishes the workgroup. Workgroup administration privileges may also be transferred to another user within the workgroup through the use of the transfer button 3004 which prompts the current administrator to select another workgroup member to transfer administrative privileges to the selected member. The workgroup administration interface 3000 also contains name input 3002 for an administrator to name the workgroup, a library selection input 3006 where a user may select from an existing library, a library edit button 3008, which when selected launches the library (including the market forecast) interface 1600 illustrated in FIGS. 16, 17, and 18, a new button 3010 to create a new library (which may include one or more market forecasts), and a delete button 3012 to delete the selected library. The workgroup administration interface also includes a comparable data scenario selection input 3014 where a workgroup administrator may select comparable lease data such as that input through the comparable lease administration interface 2700 (FIG. 27), a data sharing scenario selection input 3016 where a workgroup administrator may select a data sharing scenario such as the one entered through the data sharing administrator interface 2900 (FIG. 29), and a vendor scenario selection input 3018 where a workgroup administrator may select a vendor scenario such as the one entered through the vendor administration interface 2500 (FIG. 25).

Each of controls 3014, 3016, and 3018 also may have edit, new, and delete buttons 3008, 3010, and 3012. A user input 3020 is also provided for the workgroup administrator to provide a list of reference groups that may be utilized by properties within the workgroup. Naming reference groups at the workgroup level, rather than the property level enforces consistency so that, for example, a user can create a reference group name “2016 budget” which will be consistent for reporting and grouping purposes across all properties which reference the list.

The workgroup administration interface 3000 also includes a stand alone, or here, embedded approval interface 3022, similar to the approval interface 2000 (FIG. 20). As with the approval interface 2000, the embedded approval interface 3022 determines, through the workgroup, the users who will have access to the properties in the workgroup. For example, if a user is added to the approval interface 3022 within the workgroup administration interface 3000, the user will then have access to the properties that are added to the workgroup (properties are added to a workgroup through the property administration interface 3100 (FIG. 31).) Though it is not shown in the illustration, different permissions may also be included for each member of the workgroup so that, for example, features such as the ability to edit reference leases, view reference leases, create new leases, and many other controllable features may be enabled or disabled on a user-by-user basis for members of the workgroup.

As explained below, approving users must be part of the workgroup when the workgroup defines who has access to a property. A member of the workgroup not involved in the approval process still may be listed on the approval interface 3022 (now also simply a workgroup membership interface) except that the user is shown to have no approvals as with JG@Joe.com for example.

Referring to FIGS. 7 and 31, a property file 700 may contain information directly, or may contain a reference, link, or other connection to data stored elsewhere, such as a workgroup. In order to manage the location of the data, each property has a property administration interface 3100, accessible by the property administrator. The administration interface contains a button 3102, which when activated, allows the property administrator to transfer administrative privileges to another member of a workgroup which the property is a part of (as designated in workgroup selection control 3106). The property administration interface 3100 also contains a data sources area 3104, where a user may first select a workgroup through the workgroup selection control 3106. A property administrator may select any workgroup which the administrator is a member of, or can create a new workgroup through the use of button 3108, which launches workgroup administration interface 3000 (FIG. 30). A workgroup may also be edited through the selection of button 3110, also launching the workgroup administration interface 3000 (FIG. 30), and a workgroup may be deleted through the selection of button 3112. It is not always necessary for a workgroup to be selected. A property file and associated features may function without a workgroup in some forms.

The data sources area 3104 has a list of the property data components 3114-3124. For each data source, a user may utilize a control 3126 to designate the workgroup as the source of data for the data sources 3114-3124, or a control 3130 to directly enter the data in the property file through the use of the “details” button 3132 which is made visible upon the selection of “direct entry” for the data. When a workgroup is selected, in one form, it must be used for approval data 3114 since the workgroup establishes the users that have access to the property file. When a workgroup is selected, approvals 3114 cannot be entered directly, and area 3128 cannot be selected. If no workgroup is selected, then a user may choose “direct entry” for approval data. Similarly, if no workgroup is selected, the workgroup data source buttons 3126 are not active. Selecting direct entry 3130 for any of the data sources displays a “details” button 3132, which when selected, launches the corresponding interface. For example, selecting details 3132 for approvals 3114 launches the approval interface 2000 (FIG. 20), selecting details 3132 for library/forecast data 3116 launches library interface 1600 (FIG. 16), selecting details 3132 for vendor data 3118 launches the vendor interface 2500 (FIG. 25), selecting details 3132 for comparable lease data 3120 launches the comparable lease interface 2700 (FIG. 27), selecting details 3132 for data sharing 3122 launches the data sharing interface 2900 (FIG. 29), and selecting details 3132 for reference groups 3124 provides an interface (not illustrated) which may allow the user to create a list of reference groups. If the workgroup button 3126 is selected for these data sources, the program looks to the workgroup for the source of the data. For example, if the workgroup button is selected for library/forecast data 3116, the program looks to the workgroup designated through workgroup selection control 3106 to determine the library forecast data through, for example, the library selection control 3006 illustrated in the workgroup interface 3000 (FIG. 30).

Referring to FIGS. 7 and 32A-32C, in one form, the system 10 may provide reports 728 in the form of a visual or graphical depiction of one or more buildings. This may include for example, a schematic of a section of floor with floor space on one axis and time on another axis to show how the space is filled, the duration of leases, and how new or proposed leases would take over certain spaces. Each space, suite or lease shown may list information about that space or provide a link thereto.

The reports 728 may also include general textual reports that can display an individual lease or multiple leases (for example, all of the leases within a building or a portfolio of buildings). In one form, a lease detail report 3200 provides data from many parts of the system 10. The illustrated lease detail report 3200 may appear on-screen, may be exported, or may be printed as a hard copy (and this applies to any of the displays or interfaces herein this application). The lease detail report 3200 displays identifying data 3202 and financial data 3204 about the selected lease. Both the identifying data 3202 and financial data 3204 may be input through, for example, the lease deal input interface 1200 (FIG. 12) and the lease deal version detail interface 1300 (FIG. 13). The lease detail report 3200 also contains financial and other data 3206 about the previously executed deal version to which the selected lease deal version has linked through, or has claimed space through, for example, the space selection area 1208 (FIG. 12). The financial and other data 3206 about previously executed deal versions may contain totals and weighted averages 3208 from the one or more previously executed lease deal versions to which the selected lease deal version has been linked, and a display 3210 of the differences between the selected lease deal versions and the lease deal versions to which it is linked or has claimed space from. In the illustrated example, the comparison area 3210 may display the rate roll-up/down which compares the rents at the time of expiration of the previously executed lease deal versions to the starting rent of the selected lease. This allows building owners and other interested parties to view the anticipated change in revenues for the space that is part of the linking or claims.

The lease detail report 3200 may also include data about reference leases 3212, which, in this illustration, includes a reference group “underwriting” 3213 and a reference group “2014 budget” 3220. The displayed reference leases contain links established through a reference group linking interface such as, for example, the reference selection area 1210 (FIG. 12) where links to reference leases were established within at least an “underwriting” and a “2014 budget” reference group through the reference group selector 1218 (FIG. 12). The reference group data 3212 also contains total and weighted average data 3216 for the reference leases to which the lease deal version has been linked, and variance data 3218 that displays the difference between the financial and other data of the reference leases and the selected lease deal version. The display 3220 for reference group “2014 budget” displays data from the linked leases within the reference group in the same manner as described for the reference group “underwriting” 3213. Since a property file may contain or be associated with many reference groups, the reference lease data area 3212 of the lease detail report 3200 may include data from many reference groups. Alternatively, if no reference groups or reference leases have been added to the property file, or no reference leases have been linked to, then the area with data about reference leases 3212 may be omitted from the report.

The lease detail report 3200 also includes a forecast comparison area 3222 with forecast data that can be entered through the forecast interface 1700 (FIGS. 17-18) and be associated with a lease deal. In the illustrated lease detail report 3200, the forecast name 3224, corresponding to a name and lease space type 1714, may be established in the “baseline” forecast interface 1700 (FIG. 17) and selected through the space type selection control 1206 (FIG. 12). The forecast dates or forecast leases may be further refined based on a lease type selection 1204 (such as new, renewal, and so forth) of the lease deal input interface 1200 (FIG. 12).

The reference group 3226 is also displayed as created through, for example, the reference group input 3124 of the property administration interface 3100 (FIG. 31). The data from the corresponding forecast layer is displayed 3228, and the data from the selected lease 3230 is also displayed along with the variance 3232 between the two. Since a property file may contain many library forecast layers, the forecast data area 3222 may include data from many library forecast layers. Further, if no forecast data has been added to the property file, or no space types have been identified through the lease deal interface 1200 (FIG. 12), then the area with data about forecasts 3222 may be omitted from the report.

The lease detail report 3200 also contains a comparable lease data area 3234 that contains data from comparable leases as identified by the system 10 based on selections made through, for example, the comparable lease administration or property search interface 2700 (FIG. 27). The comparable lease data 3234 includes a display 3236 of comparable leases, a display 3238 of total and average values aggregated from the comparable leases, a display of selected lease data 3240, and a display 3242 of the variance between the aggregate comparable lease data 3238 and the selected lease data 3240. If comparable lease data is not included in the property file, then the comparable lease data area 3234 may be omitted from the report. Further, if the comparable lease data generates too many comparable leases to reasonably display in the comparable lease display area 3236, then the program may, or a user may, choose to display only the aggregated data 3238.

An approval tracking area 3244 is also provided within the lease detail report 3200. The approval tracking area displays a list of the approvals 3246 required for the selected lease deal version as entered through, for example, an approval administration interface 2000 (FIG. 20). If approvals have been requested through, for example the approval interface 2100 (FIG. 21), the status of the approvals also may be displayed. If approvals are not enabled, or if approval data has not been entered, for the property that the selected lease is part of, then the approval tracking area 3244 may be omitted from the lease detail report 3200.

A vendor area 3248 is also provided for the display of vendor data, which includes a display 3250 of the vendors to which data has been transmitted through, for example, the vendor selection interface 2600 (FIG. 26) or transmitted automatically based on inputs through the vendor administration interface 2500 (FIG. 25). If vendor selection is not enabled, or if vendor data has not been entered, for the property that the selected lease is part of, then the vendor data area 3248 may be omitted from the lease detail report 3200.

A data sharing area 3532 is also present, which displays 3254 where the lease data has been shared as a result of inputs through a data sharing interface 2900 (FIG. 29). If data sharing is not enabled or if data sharing data has not been entered for the property that the selected lease is part of, then the data sharing area 3252 may be omitted from the lease detail report 3200.

The reports 728 may be provided by a report manager 493. Many graphical or textual reports can be generated from the system 10, and it will be appreciated that the report presented here, and the combination of data from the system presented here is just one possible combination of many.

It will be appreciated by those skilled in the art that modifications to the foregoing embodiments may be made in various aspects. Other variations clearly would also work, and are within the scope and spirit of the invention. The present invention is set forth with particularity in the appended claims. It is deemed that the spirit and scope of that invention encompasses such modifications and alterations to the embodiments herein as would be apparent to one of ordinary skill in the art and familiar with the teachings of the present application.

What is claimed is:

1. A system for using real estate lease data comprising:
at least one property file stored on a data storage device and representing a property having at least one leasable space;
a lease deal component operated by at least one processor and receiving data for a plurality of lease deals, each lease deal having data for terms of a lease deal;
at least one previously established lease deal having data for a lease deal, being associated to at least one leasable space and being established previously to at least one subsequent lease deal of the plurality of lease deals,
wherein the lease deal component being configured to link at least one subsequent lease deal of the plurality of lease deals to at least one of the previously established lease deals to associate the at least one subsequent lease deal with an amount of leasable space associated to the previously established lease deal; and
a display displaying lease terms or results of financial calculations or both of at least one lease deal that is linked.

2. The system of claim 1 wherein the previously established lease deal is an executed lease deal.

3. The system of claim 1 comprising an interface control for permitting a user to selectively link a lease deal to other lease deals.

4. The system of claim 1 wherein the link to at least one previously established lease deal is a claim of an amount of leasable space of the previously established lease deal forming a claimed leasable space so that no other lease deal can claim the amount of area of the claimed leasable space.

5. The system of claim 4 comprising a lease deal linking interface with a space selection area that indicates an amount of leasable space available for claiming from the previously established lease deal.

6. The system of claim 5 wherein the space selection area comprises a control that only shows an amount of non-claimed leasable space available for claiming from the previously established lease deal and for other lease deals.

7. The system of claim 4 wherein a plurality of the lease deals each have a lease deal status, wherein available lease deal statuses comprising at least one of executed and in-progress, wherein in-progress includes lease deals in negotiations, and wherein only an executed lease deal is permitted to claim unclaimed leasable space.

8. The system of claim 7 comprising at least one non-executed lease deal having a link to at least one previously established executed lease deal so that the at least one non-executed and previously established executed lease deals are selectively displayed together on the display.

9. The system of claim 7 wherein the status of a non-executed lease deal is convertible to executed lease deal status.

10. The system of claim 1 wherein a plurality of the lease deals have a plurality of versions, each of which may have varying version statuses.

11. The system of claim 10 wherein a single lease deal has multiple versions of at least two different version statuses having different lease data, and wherein the display displays the terms of the multiple lease deal versions of the single lease deal.

12. The system of claim 1 wherein the lease deal component is configured to operate without deleting data from a lease deal and lease deal versions in order to link lease deals together and display financial data of multiple lease deals.

13. The system of claim 1 wherein the display shows together data of linked lease deals having different amounts of leasable space.

14. The system of claim 1 wherein the lease deal component is configured to provide the option for a lease deal to link to the at least one previously established lease deal or unclaimed leasable space or both.

15. The system of claim 1 wherein the at least one leasable space comprises a plurality of leasable spaces each representing a suite, and wherein at least one lease deal claims or links to an area that combines areas from a plurality of suites.

16. The system of claim 15 wherein the at least one lease deal claims or links to an area that is less than an entire suite and areas including at least part of one other suite.

17. The system of claim 15 wherein the at least one lease deal claims or links to an area that includes the entire area of at least one suite and at least part of at least one other suite.

18. The system of claim 1 wherein one leasable space comprises an entire section for one lease deal, wherein a section is defined as having a common space type or common location in a building.

19. The system of claim 1 wherein one leasable space comprises an amount of multiple sections for a single lease deal, wherein a section is defined as having a common space type or common location in a building.

20. The system of claim 1 wherein the at least one leasable space comprises a single leasable space having the area of an entire building, and wherein the single leasable space is the leasable space for a single lease deal.

21. The system of claim 1 wherein the at least one leasable space is a suite in a building, and wherein at least one lease deal has an area including less than the entire area of the suite.

22. The system of claim 1 wherein the at least one leasable space is divisible into multiple suites claimed by a plurality of the lease deals.

23. The system of claim 1 comprising an interface having a space selection area arranged for selectively adding at least portions of multiple previously defined leasable spaces to form a single new leasable space for a lease deal.

24. The system of claim 1 comprising an interface having a space selection area arranged for selecting less than all available area of at least one single previously defined leasable space to form a new leasable space for a lease deal.

25. The system of claim 1 comprising an option and encumbrance warning that is displayed to a user in response to an attempt to link to a lease deal with an option or encumbrance indicated on the system.

26. The system of claim 1 comprising at least one reference lease comprising data for a hypothetical lease, wherein the at least one reference lease is linkable to a lease deal, the system comprising a comparison display to show terms of a lease deal and terms of at least one reference lease linked to the lease deal.

27. The system of claim 26 wherein a single lease deal is linked to a plurality of reference leases at the same time, and wherein the comparison display displays terms of one or more of the plurality of reference leases together with the terms of the single lease deal.

28. The system of claim 26 wherein the display alternatively displays data for:
multiple lease deals,
multiple reference leases, and
lease deals and reference leases.

29. The system of claim 26 wherein the display displays lease deals or reference leases or both of multiple properties.

30. The system of claim 26 comprising at least one lease input interface for creating and linking multiple reference leases to at least one lease deal.

31. The system of claim 30 further comprising an interface displaying a physical representation of at least a portion of the property, and wherein an amount of space for the lease deal or a reference lease or both is selected for the lease input interface by selecting space on the representation.

32. The system of claim 26 comprising an interface displaying a physical representation of at least a portion of the property, and wherein an amount of space for the lease deal or a reference lease or both is selected for display on the physical representation.

33. The system of claim 26 wherein the interface comprises a graphical depiction of a section of a building.

34. The system of claim 26 wherein the reference leases may be arranged into reference groups.

35. The system of claim 26 comprising a sharing component to share data related to the links from at least one lease deal to other lease deals or reference leases external of the system.

36. A system using real estate lease data comprising:
a property file stored on a data storage device and representing a property having at least one leasable space;
at least one lease deal comprising data of an executed or in-progress lease deal in negotiations;
at least one reference lease having data of a hypothetical lease;
at least one component operated by at least one processor and linking the at least one reference lease to at least one lease deal; and
a display for simultaneously displaying data of at least one reference lease and at least one lease deal linked to the at least one reference lease.

37. The system of 36 wherein the component is configured to link a reference lease to any type of lease deal or reference lease.

38. The system of claim 36 wherein the component is configured to link the reference lease to an unclaimed leasable space.

39. The system of claim 36 comprising a single lease deal linked to a plurality of reference leases, and wherein the display shows data for the plurality of reference leases.

40. The system of claim 36 comprising an interface with a space selection area arranged for selectively adding at least a portion of multiple previously defined leasable spaces to form a single new leasable space for a reference lease.

41. The system of claim 36 comprising an interface with a space selection area arranged for selecting less than all available area of at least one previously defined leasable space to form a new leasable space for a reference lease.

42. The system of claim 36 comprising at least one reference group having a plurality of the reference leases, and wherein a lease deal is linkable to at least one reference lease within the at least one reference group.

43. The system of claim 42 wherein the property is divided into one or more sections each having one or more of the leasable spaces, and wherein a lease deal is linkable to reference leases based on a selection of one of the reference groups and those reference leases of the selected reference group having leasable spaces on the same section as the leasable space of the lease deal.

44. The system of claim 42 comprising a plurality of reference groups, each reference group having a different reference lease.

45. The system of claim 42 having at least one lease deal linked to multiple reference leases from multiple reference groups, and wherein the component compares the lease deal to the reference leases of the multiple reference groups.

46. The system of claim 42 wherein the display displays reference leases by reference group.

47. The system of claim 42 wherein a reference group is a budget, and wherein each reference lease within the reference group has a term based on at least one expectation of the budget.

48. The system of claim 36 comprising a warning related to options or encumbrances and provided to a user in relation to linking a reference lease to a lease deal having an option term or encumbrance.

49. The system of claim 36 comprising a graphical input interface for linking reference leases.

50. A system for using real estate lease data comprising:
a property file stored on a data storage device and representing a property having at least one leasable space;
a lease component operated by at least one processor and receiving lease data for the terms of a lease and being associated with the at least one leasable space; and
at least one lease detail interface that displays the lease data comprising data related to financial lease elements, and arranged to permit a user to optionally add or remove at least one lease element to the display.

51. The system of claim 50 wherein the lease element is at least one of:
rent,
rent steps,
rent adjustments,
expense recoveries,
free rent,
tenant improvements,
landlord work, and
leasing commissions.

52. The system of claim 50 wherein the interface displays, for multiple lease elements displayed, a start date, an element identifier, a unit of measure, and at least one value of the element.

53. The system of claim 52 wherein the start date is at least one of:
an actual date an element takes effect, and
a relative date an element takes effect.

54. The system of claim 53 wherein either an actual or relative input is automatically set as a start date by receiving the other of the actual or relative date input on the interface.

55. The system of claim 50 comprising a reference lease having the lease data and representing a hypothetical lease.

56. The system of claim 50 comprising an executed lease deal represented by the lease data.

57. The system of claim 50 comprising an in-progress lease deal being in negotiations and represented by the lease data.

58. The system of claim 50 wherein the interface has at least one control to receive data for an element and inputted by a user.

59. The system of claim 50 wherein the interface has at least one library control to permit a user to select an element and data from a library, and to automatically populate the interface with the data from the library for that selected element.

60. The system of claim 50 wherein the interface has at least one comparison control to simultaneously display data for at least one comparable lease deal or at least one reference lease of hypothetical data or both.

61. The system of claim 50 wherein the interface displays data of each like-element of the multiple lease deals in a distinct group.

62. The system of claim 50 wherein the interface comprises controls to permit selection and comparison of comparison data of at least one of:
executed lease deals,
lease deals related to current leases wherein a tenant is occupying space in the property,
in-progress lease deals in negotiations,
reference lease deals representing hypothetical lease deals,
at least one lease deal related to a different property other than the property,
a forecast lease deal, and
a combination of at least two of:
an executed lease deal,
an in-progress deal, and
a reference lease deal.

63. The system of claim 62 wherein the interface provides any of the lease deals.

64. The system of claim 50 wherein the interface is configured to compare at least two lease deals or reference leases of hypothetical data or both having different leasable space amounts.

65. The system of claim 50 wherein the interface displays input parameter data for each lease deal.

66. The system of claim 50 wherein the interface displays results of financial calculations for the lease deals.

67. The system of claim 50 wherein the interface comprises a calculation results area for displaying results of financial calculations performed on data for the lease deal.

68. The system of claim 67 wherein the results are displayed as a cash flow.

69. The system of claim 67 wherein the results are metrics displayed as at least one of net present value, net effective rent, total deal cost, and a value for a lease element.

70. The system of claim 67 wherein the results display values in total amounts or per unit of physical area.

71. A system of using real estate lease data comprising:
a property file stored on a data storage device and representing a property;
at least one lease deal associated with the property file and having data values of the terms of the lease deal and a version status indicating the status of negotiations of the lease deal, wherein the version statuses form a hierarchy as the lease deal proceeds through negotiations and advances toward an executed version status of the lease deal;
a plurality of approving users each having a ranking and a threshold version status; and
a system approval component operated by at least one processor and configured to:
receive a request for approval for changing a version status of a lease deal,
consider the approving users in an order based on the rank, and
compare a current version status of the lease deal to the threshold version status of the approving user,
request approval from the approving user when the current version status satisfies a certain criteria related to the threshold version status.

72. The system of claim 71 wherein at least one approving user has a threshold metric value, and wherein the system approval component requests approval from the at least one approving user depending on whether a corresponding metric value of the lease deal surpasses the threshold metric value.

73. The system of claim 72 comprising at least one comparable lease component for determining at least one comparable lease deal to the lease deal, and wherein the threshold metric value is related to a representative value from the at least one comparable lease deal.

74. The system of claim 71 comprising a lease deal version input interface having restrictions so that only one version of a lease deal can be edited at a time and only one version of a lease deal can have a status of pending approval at a time.

75. The system of claim 71 comprising a lease deal version input interface having restrictions so that only one version of a lease deal can be executed at a time.

76. The system of claim 71 having a display of an approval table listing approving users rank, threshold version status, and threshold metric values.

77. The system of claim 71 wherein the approval component is configured to optionally permit change of version status to executed version status without obtaining approvals from the approving users.

78. The system of claim 71 comprising at least one control for accepting additional lease data after the version status is changed to executed version status.

79. The system of claim 71 having an approval interface comprising at least one of:
data of previously approved versions of the lease deal,
data of at least one reference lease of a hypothetical lease deal linked to the lease deal,
data of market term values based on at least one assumption of a type of leasable space, and
data of comparable leases to the lease deal.

80. The system of claim 71 wherein the approval component requires approvals based on at least one of:
changes in lease deal data of the lease deal versus previously approved versions of the lease deal,
variances in lease deal data of the lease deal versus one or more reference leases to which the lease deal is linked,
variances in lease deal data of the lease deal versus a forecast,
variances in lease deal data versus comparable leases.

81. The system of claim 71 wherein the approval component requires approval when leasable space is encumbered by options or other encumbrances.

82. A system for using real estate lease data comprising:
at least one property file stored on a storage device;
at least one lease deal associated with the at least one property file and having lease data on terms of the lease;
a vendor component operated by at least one processor and configured for involving an outside vendor by submitting data to the outside vendor based on at least one of:
a status of the lease deal, and
the value of at least one term of the lease deal.

83. The system of claim 82 wherein the vendor component is configured to automatically submitting data to the outside vendor.

84. The system of claim 82 wherein the vendor component is configured to prompt a user for submitting data to the outside vendor.

85. The system of claim 82 wherein the vendor component is configured to suggest particular vendors.

86. The system of claim 82 wherein the vendor component is configured to receive a request to submit data to the outside vendor in order to provide approval to advance the status of the lease deal.

87. The system of claim 82 wherein the vendor component is configured to receive feedback from the outside vendor in order to provide approval to advance the status of the lease deal.

88. The system of claim 82 wherein data is shared with authorized external users based on a negotiating status of the lease deal.

89. The system of claim 82 comprising at least one workgroup linked to at least one property file and other property files, and having a membership of users authorized to have access to the at least one property file, the workgroup having stored lease data as a source of data for the at least one lease deal.

90. A system for forecasting of lease data comprising:
at least one property file stored on a data storage device and defining at least one leasable space;
at least one lease deal having data for terms of a lease deal and being associated with the leasable space;
a library having multiple layers of lease data related to the at least one property, each layer having at least one assumption based on a type of leasable space;
a comparison component operated by at least one processor and configured to compare at least one lease deal to lease data on at least one layer.

91. The system of claim 90 wherein each layer corresponds to a different budget, and wherein the comparison component compares a single lease deal to multiple budgets, and wherein the saved data of one budget does not replace the saved data of another budget.

92. The system of claim 90 wherein each layer corresponds to a different budget, and wherein the comparison component compares a single lease deal to a single budget, and wherein the saved data of one budget does not replace the saved data of another budget.

93. The system of claim 90 wherein each layer comprises lease data of assumptions of lease elements, and wherein the comparison component compares at least one assumption of a lease deal or a reference lease to at least one assumption of at least one layer.

94. The system of claim 90 comprising at least one reference lease based on hypothetical lease data, and wherein each layer comprises lease data of assumptions of lease elements, and wherein the comparison component compares at least one assumption of a reference lease to at least one assumption of at least one layer.

95. The system of claim 90 wherein each layer corresponds to a different time period the assumption applies.

96. The system of claim 90 wherein each layer corresponds to a different type of leasable space.

97. The system of claim 90 wherein each layer comprises multiple alternative time periods during which the assumption applies.

98. The system of claim 90 wherein each layer comprises multiple alternative assumptions of the type of leasable space.

99. The system of claim 90 comprising at least one forecast lease having data for terms of a lease considering the at least one assumption and corresponding to one of the multiple layers.

100. The system of claim 90 wherein the lease deal is linked to a plurality of layers, each layer corresponding to at least one forecast lease, and wherein the comparison component compares the lease deal to the forecast leases of multiple layers.

101. The system of claim 99 comprising reference leases each having data for a hypothetical lease deal, and wherein the comparison component compares forecast leases to at least one reference lease.

102. The system of claim 99 wherein the forecast lease is used to generate reference leases.

103. The system of claim 90 wherein one or more forecast leases are used for determining when approvals are required.

104. The system of claim 90 comprising a display to show one or more forecast leases next to lease deals for comparison.

105. The system of claim 90 wherein forecast leases are generated by external data sources.

106. The system of claim 90 wherein forecast leases are arranged to be shared with external databases.

107. A method of using lease data comprising:
storing on a data storage device, at least one property file representing a property having at least one leasable space;
receiving data for a plurality of lease deals, each lease deal having data for terms of a lease deal;
receiving data for at least one previously established lease deal comprising data for a lease deal, the previously established lease deal being established previously to at least one subsequent lease deal of the plurality of lease deals and being associated with at least one leasable space;
linking, by at least one lease deal component operated by at least one processor, the at least one previously established lease deal to at least one subsequent lease deal to associate the at least one subsequent lease deal with an amount of leasable space associated with the previously established lease deal; and
displaying lease terms or results of financial calculations or both of at least one linked lease deal.

108. The method of claim 107 wherein the previously established lease deal is an executed lease deal.

109. The method of claim 107 comprising permitting a user to selectively link a lease deal to other lease deals.

110. The method of claim 107 comprising:
claiming an amount of leasable space from a previously established lease deal to reserve the claimed leasable space for a subsequent lease deal; and
restricting the claiming of the amount of leasable space of the previously established lease deal only to space that is not claimed by any other lease deal.

111. The method of claim 110 comprising indicating an amount of leasable space for claiming from a previously established lease deal on a display.

112. The method of claim 111 wherein indicating includes only showing an amount of non-claimed leasable space available for claiming from the previously established lease deal for other lease deals.

113. The method of claim 110 comprising:
providing a plurality of the lease deals each with a lease deal version status, the statuses comprising at least one of executed and in-progress, wherein in-progress includes lease deals in negotiations among multiple parties; and
permitting only an executed lease deal to claim space of a previously established lease deal.

114. The method of claim 113 comprising
linking at least one non-executed lease deal to at least one previously established executed lease deal; and
selectively displaying the linked at least one non-executed and previously established executed lease deals together on a display.

115. The method of claim 113 comprising converting the status of a non-executed lease deal to executed lease deal status.

116. The method of claim 107 comprising providing a plurality of lease deals with a plurality of versions, each of which may have varying version statuses.

117. The method of claim 116 comprising providing a single lease deal with multiple versions comprising at least two different version statuses having different lease term data; and
displaying the terms of the multiple lease deal versions of the single lease deal together.

118. The method of claim 107 comprising linking lease deals together and displaying financial data of multiple lease deals without deleting and replacing data from a lease deal and lease deal versions being linked.

119. The method of claim 107 comprising displaying together data of linked lease deals having different amounts of leasable space.

120. The method of claim 107 comprising providing the option for a lease deal to link to the at least one previously established lease deal or unclaimed leasable space or both.

121. The method of claim 107 comprising claiming or linking an area that combines areas from a plurality of suites, each suite being a leasable space of the at least one leasable space, and claiming for a single lease deal.

122. The method of claim 107 comprising claiming or linking, for the at least one lease deal, an area that is less than an entire suite and areas including at least part of one other suite.

123. The method of claim 107 wherein the at least one leasable space forms multiple suites, and the method comprising claiming or linking, for a single lease deal, an area that includes the entire area of at least one suite and at least part of at least one other suite.

124. The method of claim 107 wherein one leasable space comprises an entire section, wherein a section is defined as having a common space type or a common location in a building.

125. The method of claim 107 wherein one leasable space comprises an amount of multiple sections, wherein a section is defined as having a common space type or a common location in a building.

126. The method of claim 107 wherein the at least one leasable space comprises a single leasable space having the area of an entire building, and wherein the one leasable space is the leasable space for a single lease deal.

127. The method of claim 84 wherein the at least one leasable space is a suite in a building, and wherein at least one lease deal has an area including less than the entire area of the suite.

128. The method of claim 107 claiming, by a plurality of the lease deals, multiple suites divided up from a single leasable space.

129. The method of claim 107 comprising selectively adding at least portions of multiple previously defined leasable spaces on a space selection area of a display to form a single new leasable space for a lease deal.

130. The method of claim 107 comprising selecting less than all available area of at least one single previously defined leasable space on a space selection area of a display to form a new leasable space for a lease deal.

131. The method of claim 107 comprising displaying an option and encumbrance warning to a user in response to an attempt to link to a lease deal with an option or encumbrance indicated on the system.

132. The method of claim 107 comprising linking at least one reference lease comprising data for a hypothetical lease to a lease deal; and displaying terms of a lease deal and terms of at least one reference lease linked to the lease deal.

133. The method of claim 132 comprising linking a single lease deal to a plurality of reference leases so that the links exist at the same time, and displaying terms of one or more of the plurality of reference leases together with the terms of the single lease deal.

134. The method of claim 132 comprising alternatively displaying data for:
multiple lease deals,
multiple reference leases, and
lease deals and reference leases.

135. The method of claim 132 comprising displaying lease deals or reference leases or both of multiple properties.

136. The method of claim 132 comprising providing at least one lease input interface for creating and linking multiple reference leases to at least one lease deal.

137. The method of claim 132 comprising displaying a physical representation of at least a portion of the property, and selecting an amount of space on the physical representation for linking to by a lease deal or a reference lease or both; and
populating the input interface to show the selected amount of space.

138. The method of claim 132 comprising displaying a physical representation of at least a portion of the property, and selecting an amount of space on the physical representation for linking to by a lease deal or a reference lease or both; and
displaying the amount on the physical representation.

139. The method of claim 138 wherein the interface comprises a graphical depiction of a section of a building.

140. The method of claim 132 comprising arranging the reference leases into reference groups.

141. The method of claim 132 comprising sharing data related to the links from at least one lease deal to other lease deals or reference leases external of the system.

142. A method using lease data comprising:
storing a property file on a data storage device, the property file representing a property having at least one leasable space;
providing at least one lease deal comprising data of an executed or in-progress lease deal in negotiations;
providing at least one reference lease having data of a hypothetical lease;
linking, by at least one component operated by at least one processor, the at least one reference lease to at least one lease deal; and
simultaneously displaying data of at least one reference lease and at least one lease deal linked to the at least one reference lease.

143. The method of 142 comprising linking a reference lease to any type of lease deal or reference lease.

144. The method of claim 142 comprising linking the reference lease to an unclaimed leasable space.

145. The method of claim 142 comprising linking a single lease deal to a plurality of reference leases, and displaying data for the plurality of reference leases.

146. The method of claim 142 comprising selectively adding at least a portion of multiple previously defined leasable spaces to a space selection area of an interface to form a single new leasable space for a reference lease.

147. The method of claim 142 comprising selecting less than all available area of at least one previously defined leasable space on a space selection area of an interface to form a new leasable space for a reference lease.

148. The method of claim 142 comprising forming at least one reference group having a plurality of the reference leases and at least one same assumption or parameter of all of the reference leases within the reference group, and
linking a lease deal to at least one reference lease within the at least one reference group.

149. The method of claim 148 comprising linking a lease deal to reference leases comprising:
selecting a reference group,
selecting a section of the property for the lease deal, the section providing one or more leasable spaces,
determining which reference leases of the selected reference group link to the same section as the lease deal, and
linking the lease deal to the reference leases having the same section.

150. The method of claim 148 comprising forming a plurality of reference groups, each reference group having a different reference lease.

151. The method of claim 148 comprising linking at least one lease deal to multiple reference leases from multiple reference groups, and
comparing the lease deal to the reference leases of the multiple reference groups.

152. The method of claim 148 comprising displaying references leases by reference group.

153. The method of claim 148 comprising forming a reference group as a budget, and providing each reference lease within the reference group with a term based on at least one expectation of the budget.

154. The method of claim 152 comprising warning a user in relation to linking a reference lease to a lease deal having an option term or encumbrance.

155. The system of claim 142 comprising placing inputs on a graphical input interface for linking reference leases.

156. A method for using lease data comprising:
storing a property file on a data storage device and representing a property having at least one leasable space;
receiving, by a lease component operated by at least one processor, lease data for the lease terms of a lease and being associated with the at least one leasable space; and
displaying, on a lease detail interface, the lease data comprising data related to financial lease elements, and permitting a user to optionally add or remove at least one lease element to the interface.

157. The method of claim 156 wherein the lease element is at least one of:
rent,
rent steps,
rent adjustments,
expense recoveries,
free rent,
tenant improvements,
landlord work, and
leasing commissions.

158. The method of claim 156 comprising displaying, for multiple lease element displayed, a start date, an element identifier, a unit of measure, and at least one value of the element.

159. The method of claim 158 wherein the start date is at least one of:
an actual date an element takes effect, and
a relative date an element takes effect.

160. The method of claim 159 comprising receiving one of the actual or relative date the element tales effect, and automatically setting the other of the actual or relative date as a start date.

161. The method of claim 156 comprising forming a reference lease having the lease deal data and representing a hypothetical lease.

162. The method of claim 156 comprising providing an executed lease deal represented by the lease data.

163. The method of claim 156 comprising providing an in-progress lease deal being in negotiations and represented by the lease data.

164. The method of claim 156 comprising inputting data related to an element through at least one control on the interface.

165. The method of claim 156 comprising permitting a user to select an element and data from a library, and automatically populating the interface with the data from the library for that selected element.

166. The method of claim 156 comprising simultaneously displaying data for at least one comparable lease deal or at least one reference lease of hypothetical data or both.

167. The method of claim 156 comprising displaying data of each like-element of the multiple lease deals in a distinct group and on the interface.

168. The method of claim 156 wherein comprising permitting selection and comparison of comparison data of at least one of:
executed lease deals,
lease deals related to current leases wherein a tenant is occupying space in the property,
in-progress lease deals in negotiations,
reference lease deals representing hypothetical lease deals,
at least one lease deal related to a different property other than the property,
a forecast lease deal, and
a combination of at least two of:
an executed lease deal,
an in-progress deal, and
a reference lease deal.

169. The method of claim 168 wherein the interface selectively provides comparison data for any of the lease deals.

170. The method of claim 156 comprising comparing at least two of lease deals or reference leases of hypothetical data or both having different leasable space amounts.

171. The method of claim 156 comprising displaying input parameter data for each lease deal displayed.

172. The method of claim 156 comprising displaying results of financial calculations for the lease deals.

173. The method of claim 172 comprising displaying a calculation results area for displaying results of financial calculations performed on data for the lease deal.

174. The method of claim 173 comprising displaying the results as a cash flow.

175. The method of claim 173 comprising displaying the results as metrics of at least one of net present value, net effective rent, total deal cost, and a value for a lease element.

176. The method of claim 173 comprising displaying the results as values in total amounts or per unit of physical area.

177. A method of using lease data comprising:
storing a property file on a data storage device, the property file representing a property;
forming at least one lease deal associated with the property file and having data values of the terms of the lease deal;
assigning a version status to the at least one lease deal and indicating the status of negotiations of the lease deal, wherein the version statuses form a hierarchy as the lease deal proceeds through negotiations and advances toward an executed version status of the lease deal;
ranking a plurality of approving users;
providing a threshold version status to the approving users; and
approving, by an approval component operated by at least one processor, advancement of the version status of a lease deal toward execution comprising:
receiving a request for approval for changing a version status of a lease deal toward executed,
considering the approving users in an order based on the rank,
comparing a current version status of the lease deal to the threshold version status of the approving user, and
requesting approval from the approving user when the current version status satisfies a certain criteria related to the threshold version status.

178. The method of claim 177 comprising requesting approval from at least one approving user depending on whether a corresponding metric value of the lease deal surpasses a threshold metric value assigned to the at least one approving user.

179. The method of claim 178 comprising determining, by a comparable lease component, at least one comparable lease deal to the lease deal, and relating the threshold metric value to a representative value from the comparable lease deals.

180. The method of claim 177 comprising permitting only one version of a lease deal to be edited at a time and only one version of a lease deal to have a status of pending approval at a time.

181. The method of claim 177 comprising permitting only one version of a lease deal can be executed at a time.

182. The method of claim 177 displaying an approval table listing approving users rank, threshold version status, and threshold metric values.

183. The method of claim 177 comprising optionally permitting a change of version status to executed version status without obtaining approvals from the approving users.

184. The method of claim 177 accepting additional lease data after the version status is changed to executed version status.

185. The method of claim 177 comprising displaying, on an approval interface, at least one of:
data of previously approved versions of the lease deal,
data of at least one reference lease of a hypothetical lease deal linked to the lease deal,
data of market term values based on at least one assumption of a type of leasable space, and
data of comparable leases to the lease deal.

186. The system of claim 177 comprising requiring approvals based on at least one of:
changes in lease deal data of the lease deal versus previously approved versions of the lease deal,
variances in lease deal data of the lease deal versus one or more reference leases to which the lease deal is linked,
variances in lease deal data of the lease deal versus a forecast,
variances in lease deal data versus comparable leases.

187. The system of claim 177 comprising requiring approval when leasable space is encumbered by options or other encumbrances.

188. A method for using lease data comprising:
storing at least one property file on a data storage device, the property file representing a property;
forming at least one lease deal associated with the at least one property file and having lease data on terms of the lease;
involving, by a vendor component operated by at least one processor, an outside vendor by submitting data to the outside vendor based on at least one of: a status of the lease deal, and the value of at least one term of the lease deal.

189. The system of claim 188 comprising automatically submitting data to the outside vendor.

190. The system of claim 188 comprising prompting a user for submitting data to the outside vendor.

191. The method of claim 188 comprising suggesting particular vendors to the user.

192. The method of claim 188 comprising receiving a request to submit data to the outside vendor in order to provide approval to advance the status of the lease deal.

193. The method of claim 188 comprising receiving feedback from the outside vendor in order to provide approval to advance the status of the lease deal.

194. The method of claim 188 comprising sharing data with authorized external users based on a negotiating status of the lease deal.

195. The method of claim 188 comprising
forming at least one workgroup linked to at least one property file and other property files,
authorizing a membership of users of the workgroup to have access to the at least one property file, and
storing lease data at the workgroup as a source of data for the at least one lease deal.

196. A method for forecasting of lease data comprising:
storing at least one property file on a data storage device, the property file representing at least one leasable space;
receiving at least one lease deal having data for terms of a lease deal and being associated with the leasable space;
forming multiple layers of lease data on a library and related to the at least one property, each layer having at least one assumption based on a type of leasable space; and
comparing at least one lease deal to lease data on at least one layer.

197. The method of claim 196 comprising corresponding each layer to a different budget, and comparing a single lease deal to multiple budgets so that the saved data of one budget does not replace the saved data of another budget.

198. The method of claim 196 comprising corresponding each layer to a different budget, and comparing a single lease deal to a single budget so that the saved data of one budget does not replace the saved data of another budget.

199. The method of claim 196 providing assumptions of lease elements for each layer, and comparing at least one assumption of a lease deal or a reference lease to at least one assumption of at least one layer.

200. The system of claim 196 comprising forming at least one reference lease based on hypothetical lease data; providing each layer with lease data of assumptions of lease elements; and comparing at least one assumption of a reference lease to at least one assumption of at least one layer.

201. The method of claim 196 wherein each layer corresponds to a different time period the assumption applies.

202. The method of claim 196 wherein each layer corresponds to a different type of leasable space.

203. The method of claim 196 wherein each layer comprises multiple alternative time periods during which the assumption applies.

204. The method of claim 196 wherein each layer comprises multiple alternative assumptions of the type of leasable space.

205. The method of claim 196 comprising forming, by a forecast component operated by at least one processor, at least one forecast lease having data for terms of a lease considering the at least one assumption and corresponding to one of the multiple layers

206. The method of claim 196 comprising linking the lease deal to a plurality of layers, each layer corresponding to a forecast lease, and comparing the lease deal to the forecast leases of multiple layers.

207. The method of claim 196 comprising comparing at least one forecast lease to at least one reference lease having data for a hypothetical lease deal.

208. The system of claim 196 comprising generating reference leases having hypothetical lease data by using at least one forecast lease.

209. The system of claim 196 comprising determining when approvals are required by using at least one forecast lease.

210. The system of claim 196 comprising displaying one or more forecast leases next to lease deals.

211. The system of claim 196 comprising generating forecast leases by using external data sources.

212. The system of claim 196 comprising sharing forecast leases with external databases.
